(19) United States
(12) Patent Application Publication
(10) Pub. No.: US 2011/0151372 A1
(43) Pub. Date: Jun. 23, 2011

(54) TONER, IMAGE FORMING METHOD USING THE TONER, AND IMAGE FORMING APPARATUS USING THE TONER

(76) Inventors: Masaki Watanabe, Shizuoka (JP); Hiroshi Yamashita, Shizuoka (JP); Naohiro Watanabe, Shizuoka (JP); Tsuneyasu Nagatomo, Shizuoka (JP)

(21) Appl. No.: 12/961,930

(22) Filed: Dec. 7, 2010

(30) Foreign Application Priority Data
Dec. 17, 2009 (JP) 2009-286340
Dec. 17, 2009 (JP) 2009-286347

(51) Int. Cl. G03G 21/00; G03G 9/08

(52) U.S. Cl. 430/119.86; 430/108.1; 430/137.1; 399/343

(57) ABSTRACT

A toner obtained by a toner production method which includes dissolving or dispersing in an organic solvent a toner material containing at least a calixarene derivative and a binder resin or a binder resin precursor, to thereby prepare a solution or dispersion liquid of the toner material, adding the solution or dispersion liquid to an aqueous medium for emulsification or dispersion, to thereby prepare an emulsion or dispersion liquid, and removing the organic solvent from the emulsion or dispersion liquid.

### BACKGROUND OF THE INVENTION

1. Field of the Invention

The present invention relates to a toner used for developing a latent electrostatic image, and an image forming method and a process cartridge which use the toner.

2. Description of the Related Art

In recent years, in the field of an image forming technology based on electrophotography, increased demand has arisen for full-color image formation capable of providing images with higher image quality, and thus, developers have been designed so as to provide high-quality images. In order to cope with the demand for the improved image quality, particularly in full-color images, there is an increasing tendency toward the production of toners having smaller particle diameters, and studies have been made on faithful reproduction of latent images. Regarding the reduction in particle diameter, a process for producing a toner by a polymerization process has been proposed as a method that can regulate the toner so as to have desired shape and surface structure (see, for example, Japanese Patent (JP-B) No. 3640918, and Japanese Patent Application Laid-Open (JP-A) Nos. 06-250439, 2002-287400 and 2003-58009).

In the toner produced by the polymerization process, in addition to the control of the diameter of toner particles, the shape of toner particles can also be controlled. A combination of this technique with a particle size reduction can improve the reproducibility of dots and thin lines, and can reduce pile height (image layer thickness), whereby an improvement in image quality can be expected. The toner generally contains a binder resin, a colorant, a charge-controlling agent and other additives.

Conventionally, various charge-controlling agents have been proposed to impart to toners excellent charging property, stability over time and environmental stability. In this case, since a colored material cannot be used in a charge-controlling agent for use in full-color toners, there must be used colorless, white or light-colored charge-controlling agents which do not affect the hue.

Examples of such charge-controlling agents proposed include metal complex salts of salicylic acid derivatives (see Japanese Patent Application Publication (JP-B) No. 55-42752, and JP-A Nos. 61-69073, 61-221756 and 09-124659), metal complex salts of aromatic dicarboxylic acids (see JP-A No. 57-111541), metal complex salts of anthranilic acid derivatives (see JP-A No. 62-94856) and organic boron compounds (JP-B Nos. 07-31421 and 07-104620).

However, these charge-controlling agents have disadvantages that they contain chromium which may be unstable to the environment, and have insufficient durability, charge-imparting effects and environmental stability. Thus, they do not have sufficient performance to be used successfully as a charge-controlling agent. Also, as a metal-free charge-controlling agent, condensates of phenol derivatives have been proposed (see JP-B No. 2568675). These condensates may satisfactorily meet the requirements of a charge-controlling agent.

As described above, in the polymerized toner, the charge-controlling agent derived from the toner material may be decomposed, or difficult to disperse in the toner. In many cases, the charge-controlling agent cannot sufficiently exhibit its functions, which is problematic. Therefore, there have been no toners excellent in chargeability, charge rising property, durability and environmental stability by using a charge controlling agent applicable to a polymerized toner, having smaller particle diameter and forming high-quality images. In addition, the relevant techniques to the formation of such toners have not yet been provided. Therefore, keen demand has arisen for such toners and techniques.

The polymerized toner is formed as follows. Specifically, liquid droplets are solidified using an O/W (oil in water) emulsion or dispersion liquid. Alternatively, particles are dispersed and aggregated in an aqueous medium, and then associated through melting or softening. In either case, the polymerized toner is formed via a liquid state, and the particles tend to become spherical by the action of the surface tension of the oil phase.

Spherical toner particles pose a problem in that they are more difficult to clean (remove) than in the case of pulverized toner particles with a cleaning blade (a mainly used cleaning unit). This is likely because spherical toner particles run through the blade since they have no irregularities. This problem is widely known as a critical problem among those skilled in the art in the production of the polymerized toner (see, for example, JP-A No. 2002-287400, 2003-58009, 2004-226663 and 2005-37923).

The more considerably the generally spherical toner particles are deformed (i.e., are made to have a non-spherical shape), the more easily cleaning can be performed. In this case, serious technical difficulty is encountered in uniformly producing toners. In addition, the image quality is degraded. Thus, it is an important issue among those skilled in the art to determine the minimum deformation degree in which the toner can be cleaned successfully (note that the deformation degree refers to the degree of deformation of the toner).

Meanwhile, incorporation of a calixarene compound has been proposed in order to improve charging property of the pulverized toners (see JP-B No. 2568675).

However, the pulverized toners are inferior to the polymerized toners in terms of image quality. Thus, at present, there is a need to provide a toner having improved charging property and attaining excellent image quality, in the field that toners providing high image quality have been required.

### BRIEF SUMMARY OF THE INVENTION

A first object of the present invention is to provide a toner excellent in chargeability, charge rising property, durability and environmental stability by using a charge controlling agent applicable to a polymerized toner, and an image forming method and an image forming apparatus using the toner.

A second object of the present invention is to provide a deformed toner that exhibits improved cleaning property and image quality as well as improved charging property, an image forming method using the toner and a process cartridge containing the toner.

Means for solving the existing problems are as follows.

<1> A toner obtained by a toner production method which includes:

dissolving or dispersing in an organic solvent a toner material containing at least a calixarene derivative and a binder resin or a binder resin precursor, to thereby prepare a solution or dispersion liquid of the toner material,

adding the solution or dispersion liquid to an aqueous medium for emulsification or dispersion, to thereby prepare an emulsion or dispersion liquid, and

removing the organic solvent from the emulsion or dispersion liquid, and

wherein the calixarene derivative is a compound represented by the following General Formula (I):

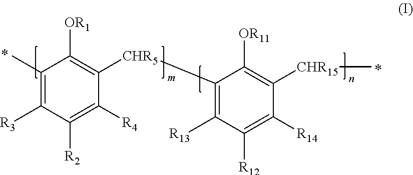

where each of n and m is an integer and the sum of n and m is 4 to 8, R₁ represents a hydrogen atom, a C1-C5 alkyl group or —(CH₂)_{q}COOR₁₀ (where R₁₀ represents a hydrogen atom or a lower alkyl group and q is an integer of 1 to 3), R₂ represents a hydrogen atom, a halogen atom, a C1-C12 alkyl group which may be branched, an aralkyl group, —NO₂, —NH₂, —N(R₇)₂ (where R₇ represents a lower alkyl group), —SO₃R₈ (where R₈ represents a hydrogen atom), a phenyl group, an alkoxy group or —Si(CH₃)₃, R₃ and R₄ each represent a hydrogen atom, a halogen atom, a C1-C3 alkyl group, —NH₂ or —N(R₉)₂ (where R₉ represents a lower alkyl group), R₅ represents a hydrogen atom or a C1-C3 alkyl group, R₁₁ represents a hydrogen atom, a C1-C5 alkyl group or —(CH₂)ₚCOOR₂₀ (where R₂₀ represents a hydrogen atom or a lower alkyl group, and p is an integer of 1 to 3), R₁₂ represents a hydrogen atom, a halogen atom, a C1-C12 alkyl group which may be branched, an aralkyl group, —NO₂, —NH₂, —N(R₁₇)₂ (where R₁₇ represents a lower alkyl group), —SO₃R₁₈ (where R₁₈ represents a hydrogen atom), a phenyl group, an alkoxy group or —Si(CH₃)₃, R₁₃ and R₁₄ each represent a hydrogen atom, a halogen atom, a C1-C3 alkyl group, —NH₂ or —N(R₁₉)₂ (where R₁₉ represents a lower alkyl group) and R₁₅ represents a hydrogen atom or a C1-C3 alkyl group.

<2> The toner according to <1>, wherein the calixarene derivative is internally added to the toner so that the calixarene derivative is localized in the vicinity of a surface of the toner, and wherein the toner has an average circularity X of 0.95 to 0.98 which is calculated from the following Equation 1:

X=(Circumferential length of a circle having the same area as projected particle area/Circumferential length of projected particle image)×100(%) Equation 1

<3> The toner according to <2>, wherein the calixarene derivative represented by General Formula (I) is localized in an internal region within 1 μm from the uppermost surface of the toner when the cross-sectional surface of the toner is observed through halogen mapping.

<4> The toner according to <1>, wherein the calixarene derivative is a calixarene derivative represented by General Formula (I) where n is 0 and m is 4 to 8.

<5> The toner according to <1>, wherein the aqueous medium includes anionic fine resin particles having an average particle diameter of 5 nm to 50 nm and an anionic surfactant.

<6> The toner according to <1>, wherein the calixarene derivative has chargeability.

<7> The toner according to <1>, wherein the calixarene derivative contained in the solution or dispersion liquid of the toner material has an average dispersion diameter of 10 nm to 500 nm.

<8> The toner according to <1>, wherein the binder resin includes a polyester resin.

<9> The toner according to <1>, wherein the toner contains the calixarene derivative in an amount of 0.01 parts by mass to 5 parts by mass relative to 100 parts by mass of the binder resin.

<10> The toner according to <1>, wherein the toner material further contains an active hydrogen group-containing compound and a modified polyester resin reactive with the active hydrogen group-containing compound.

<11> The toner according to <1>, wherein the charge amount of the toner is −80 μC/g to −10 μC/g.

<12> The toner according to <1>, wherein the common logarithmic value Log ρ of the volume specific resistance ρ (Ωcm) of the toner is 10.9 Log Ωcm to 11.4 Log Ωcm.

<13> The toner according to <1>, wherein the volume average particle diameter/the number average particle diameter (Dv/Dn) of the toner is 1.05 to 1.25.

<14> The toner according to <1>, wherein the toner has a BET specific surface area of 0.5 m²/g to 4 m²/g.

<15> An image forming method including:

charging an electrophotographic photoconductor by a charging unit,

exposing the electrophotographic photoconductor by an exposing unit, to thereby form a latent electrostatic image,

developing the latent electrostatic image with a toner, to thereby form a toner image,

primarily transferring the toner image onto an intermediate transfer member by a primary transfer unit,

secondarily transferring the toner image from the intermediate transfer member onto a recording medium by a secondary transfer unit,

fixing the toner image on the recording medium, and

cleaning the residual toner attached on a surface of the electrophotographic photoconductor from which the toner image has been transferred onto the intermediate transfer member by the primary transfer unit,

wherein the toner is obtained by a toner production method which includes:

dissolving or dispersing in an organic solvent a toner material containing at least a calixarene derivative and a binder resin or a binder resin precursor, to thereby prepare a solution or dispersion liquid of the toner material,

adding the solution or dispersion liquid to an aqueous medium for emulsification or dispersion, to thereby prepare an emulsion or dispersion liquid, and

removing the organic solvent from the emulsion or dispersion liquid, and

wherein the calixarene derivative is a compound represented by the following General Formula (I):

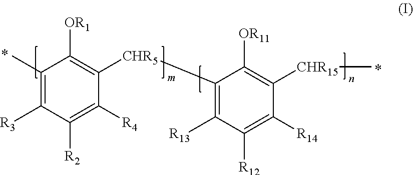

where each of n and m is an integer and the sum of n and m is 4 to 8, R₁ represents a hydrogen atom, a C1-C5 alkyl group or —(CH₂)_{q}COOR₁₀ (where R₁₀ represents a hydrogen atom or a lower alkyl group and q is an integer of 1 to 3), R₂ represents a hydrogen atom, a halogen atom, a C1-C12 alkyl group which may be branched, an aralkyl group, —NO₂, —NH₂, —N(R₇)₂ (where R₇ represents a lower alkyl group), —SO₃R₈ (where R₈ represents a hydrogen atom), a phenyl group, an alkoxy group or —Si(CH₃)₃, R₃ and R₄ each represent a hydrogen atom, a halogen atom, a C1-C3 alkyl group, —NH₂ or —N(R₉)₂ (where R₉ represents a lower alkyl group), R₅ represents a hydrogen atom or a C1-C3 alkyl group, R₁₁ represents a hydrogen atom, a C1-C5 alkyl group or —(CH₂)ₚCOOR₂₀ (where R₂₀ represents a hydrogen atom or a lower alkyl group, and p is an integer of 1 to 3), R₁₂ represents a hydrogen atom, a halogen atom, a C1-C12 alkyl group which may be branched, an aralkyl group, —NO₂, —NH₂, —N(R₁₇)₂ (where R₁₇ represents a lower alkyl group), —SO₃R₁₈ (where R₁₈ represents a hydrogen atom), a phenyl group, an alkoxy group or —Si(CH₃)₃, R₁₃ and R₁₄ each represent a hydrogen atom, a halogen atom, a C1-C3 alkyl group, —NH₂ or —N(R₁₉)₂ (where R₁₉ represents a lower alkyl group) and R₁₅ represents a hydrogen atom or a C1-C3 alkyl group.

<16> The image forming method according to <15>, wherein the toner image is transferred onto the recording medium at a linear velocity of 300 mm/sec to 1,000 mm/sec, and the transfer time at a nip part of the secondary transfer unit is 0.5 msec to 20 msec.

<17> The image forming method according to <15>, wherein the image forming method is a full-color image forming method employing a tandem-type electrophotographic image forming process.

<18> An image forming apparatus including:

an electrophotographic photoconductor,

a charging unit configured to charge the electrophotographic photoconductor,

an exposing unit configured to expose the electrophotographic photoconductor so as to form a latent electrostatic image on the electrophotographic photoconductor,

a developing unit configured to develop with a toner the latent electrostatic image formed on the electrophotographic photoconductor so as to form a toner image,

a transfer unit configured to transfer the toner image onto a recording medium directly or via an intermediate transfer member,

a fixing unit configured to fix the toner image on the recording medium by a heat and pressure-applying member, and

a cleaning unit configured to clean the residual toner attached on a surface of the electrophotographic photoconductor from which the toner image has been transferred onto the intermediate transfer member or the recording medium by the transfer unit,

wherein the toner is obtained by a toner production method which includes:

dissolving or dispersing in an organic solvent a toner material containing at least a calixarene derivative and a binder resin or a binder resin precursor, to thereby prepare a solution or dispersion liquid of the toner material,

adding the solution or dispersion liquid to an aqueous medium for emulsification or dispersion, to thereby prepare an emulsion or dispersion liquid, and

removing the organic solvent from the emulsion or dispersion liquid, and

wherein the calixarene derivative is a compound represented by the following General Formula (I):

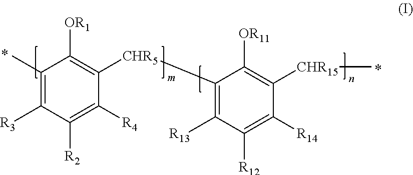

where each of n and m is an integer and the sum of n and m is 4 to 8, R₁ represents a hydrogen atom, a C1-C5 alkyl group or —(CH₂)_{q}COOR₁₀ (where R₁₀ represents a hydrogen atom or a lower alkyl group and q is an integer of 1 to 3), R₂ represents a hydrogen atom, a halogen atom, a C1-C12 alkyl group which may be branched, an aralkyl group, —NO₂, —NH₂, —N(R₇)₂ (where R₇ represents a lower alkyl group), —SO₃R₈ (where R₈ represents a hydrogen atom), a phenyl group, an alkoxy group or —Si(CH₃)₃, R₃ and R₄ each represent a hydrogen atom, a halogen atom, a C1-C3 alkyl group, —NH₂ or —N(R₉)₂ (where R₉ represents a lower alkyl group), R₅ represents a hydrogen atom or a C1-C3 alkyl group, R₁₁ represents a hydrogen atom, a C1-C5 alkyl group or —(CH₂)ₚCOOR₂₀ (where R₂₀ represents a hydrogen atom or a lower alkyl group, and p is an integer of 1 to 3), R₁₂ represents a hydrogen atom, a halogen atom, a C1-C12 alkyl group which may be branched, an aralkyl group, —NO₂, —NH₂, —N(R₁₇)₂ (where R₁₇ represents a lower alkyl group), —SO₃R₁₈ (where R₁₈ represents a hydrogen atom), a phenyl group, an alkoxy group or —Si(CH₃)₃, R₁₃ and R₁₄ each represent a hydrogen atom, a halogen atom, a C1-C3 alkyl group, —NH₂ or —N(R₁₉)₂ (where R₁₉ represents a lower alkyl group) and R₁₅ represents a hydrogen atom or a C1-C3 alkyl group.

The present invention can provide a toner excellent in chargeability, charge rising property, durability and environmental stability by using a charge controlling agent applicable to a polymerized toner, and an image forming method and an image forming apparatus using the toner, which can solve the existing problems and achieve the above object.

The present invention can also provide a deformed toner that exhibits improved cleaning property and image quality as well as improved charging property, an image forming method using the toner and a process cartridge containing the toner, which can solve the existing problems and achieve the above object.

### BRIEF DESCRIPTION OF THE DRAWINGS

FIG. 1 illustrates one exemplary structure of a toner of the present invention.

FIG. 2 is a schematic view of one exemplary contact-type roller charging device.

FIG. 3 is a schematic view of one exemplary contact-type brush charging device.

FIG. 4 is a schematic view of one exemplary magnetic brush charging device.

FIG. 5 is a schematic view of one exemplary developing device.

FIG. 6 is one exemplary schematic view of a fixing device.

FIG. 7 is one exemplary layer structure of a fixing belt.

FIG. 8 is a schematic view of one exemplary process cartridge of the present invention.

FIG. 9 is a schematic view of one exemplary image forming apparatus of the present invention.

FIG. 10 is a schematic view of another exemplary image forming apparatus of the present invention.

FIG. 11 is a TEM image of a toner according to one embodiment of the present invention.

FIG. 12A is an SEM image of the cross-section of a toner of the present invention.

FIG. 12B is an elemental mapping image obtained by EDS of a cross-sectional SEM image of a toner of the present invention.

### DETAILED DESCRIPTION OF THE INVENTION

### (Toner)

A toner of the present invention is produced by a toner production method including a solution or dispersion liquid-preparing step, an emulsion or dispersion liquid-preparing step and an organic solvent-removal step.

### <Solution or Dispersion Liquid-Preparing Step>

The solution or dispersion liquid-preparing step is a step of dissolving or dispersing in an organic solvent a toner material containing at least a calixarene derivative and a binder resin or a binder resin precursor, to thereby prepare a solution or dispersion liquid of the toner material.

The toner material is not particularly limited, so long as it contains a calixarene derivative and a binder resin or a binder resin precursor, and may be appropriately selected depending on the intended purpose. Examples of other toner materials include a colorant, a releasing agent and a charge controlling agent.

### —Calixarene Derivative—

The calixarene derivative is internally added to the toner so that it is localized in the vicinity of the toner surface without being decomposed to the toner material.

The calixarene derivative is added for the purpose of imparting charging property to the toner, and preferably has chargeability (charging property).

The calixarene derivative is not particularly limited and may be appropriately selected depending on the intended purpose. Compounds represented by the following General Formula (I) are exemplified.

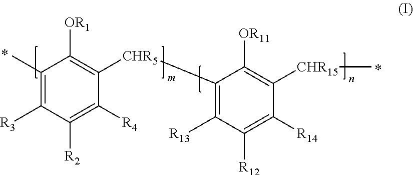

where each of n and m is an integer and the sum of n and m is 4 to 8, R₁ represents a hydrogen atom, a C1-C5 alkyl group or —(CH₂)_{q}COOR₁₀ (where R₁₀ represents a hydrogen atom or a lower alkyl group and q is an integer of 1 to 3), R₂ represents a hydrogen atom, a halogen atom, a C1-C12 alkyl group which may be branched, an aralkyl group, —NO₂, —NH₂, —N(R₇)₂ (where R₇ represents a lower alkyl group), —SO₃R₈ (where R₈ represents a hydrogen atom), a phenyl group, an alkoxy group or —Si(CH₃)₃, R₃ and R₄ each represent a hydrogen atom, a halogen atom, a C1-C3 alkyl group, —NH₂ or —N(R₉)₂ (where R₉ represents a lower alkyl group), R₅ represents a hydrogen atom or a C1-C3 alkyl group, R₁₁ represents a hydrogen atom, a C1-C5 alkyl group or —(CH₂)ₚCOOR₂₀ (where R₂₀ represents a hydrogen atom or a lower alkyl group, and p is an integer of 1 to 3), R₁₂ represents a hydrogen atom, a halogen atom, a C1-C12 alkyl group which may be branched, an aralkyl group, —NO₂, —NH₂, —N(R₁₇)₂ (where R₁₇ represents a lower alkyl group), —SO₃R₁₈ (where R₁₈ represents a hydrogen atom), a phenyl group, an alkoxy group or —Si(CH₃)₃, R₁₃ and R₁₄ each represent a hydrogen atom, a halogen atom, a C1-C3 alkyl group, —NH₂ or —N(R₁₉)₂ (where R₁₉ represents a lower alkyl group) and R₁₅ represents a hydrogen atom or a C1-C3 alkyl group.

The group represented by R₁ may be appropriately selected from the above substituents, with a tert-butyl group being preferred.

The group represented by R₂ may be appropriately selected from the above substituents, with a phenyl group being preferred.

The group represented by R₃ may be appropriately selected from the above substituents, with a methyl group being preferred. The group represented by R₄ may be appropriately selected from the above substituents, with a methoxy group being preferred.

The group represented by R₅ may be appropriately selected from the above substituents, with a p-bromophenyl group being preferred.

The group represented by R₁₁ may be appropriately selected from the above substituents, with a phenyl group being preferred. The group represented by R₁₂ may be appropriately selected from the above substituents, with a tert-butyl group being preferred.

The group represented by R₁₃ may be appropriately selected from the above substituents, with a hydrogen atom being preferred.

The group represented by R₁₄ may be appropriately selected from the above substituents, with a hydrogen atom being preferred.

The group represented by R₁₅ may be appropriately selected from the above substituents, with a hydrogen atom being preferred.

Among the above calixarene derivatives, preferred are those represented by the following General Formula (A), which is the above General Formula (I) where n is 0 and m is 4 to 8:

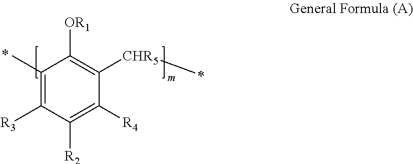

where m is an integer of 4 to 8, R₁ represents a hydrogen atom, a C1-C5 alkyl group or —(CH₂)ₙCOOR₁₀ (where R₁₀ represents a hydrogen atom or a lower alkyl group, and n is an integer of 1 to 3), R₂ represents a hydrogen atom, a halogen atom, a linear or branched C1-C12 alkyl group, an aralkyl group, —NO₂, —NH₂, —N(R₇)₂ (where R₇ represents a C1-C4 alkyl group), —SO₃R₈ (where R₈ represents a

₃)₃, R₃ and R₄ each represent a hydrogen atom, a halogen atom, a C1-C3 alkyl group, —NH₂ or —N(R₉)₂ (where R₉ represents a C1-C4 alkyl group) and R₅ represents a hydrogen atom, a hydroxyl group or a C1-C3 alkyl group.

The calixarene derivative can be incorporated as desired into a resin phase of the toner particles by utilizing the difference in affinity to the resins of the toner particles.

By incorporating the calixarene derivative into the resin phase in the vicinity of the toner particles, the spent of the charge controlling agent to other members such as the photoconductors and carriers can be suppressed.

The average dispersion diameter of the calixarene derivative contained in the solution or dispersion liquid prepared at the solution or dispersion liquid-preparing step is not particularly limited and may be appropriately selected depending on the intended purpose. The average dispersion diameter is preferably 10 nm to 500 nm, more preferably 100 nm to 500 nm, particularly preferably 150 nm or smaller.

When the average dispersion diameter is smaller than 10 nm, the calixarene derivative is localized in the toner surface in a large amount, and the formed toner is considerably deformed. The charge amount more than required may be obtained, and charge-imparting effects cannot be obtained satisfactorily in some cases. When the average dispersion diameter is larger than 500 nm, the calixarene derivative is transferred from the toner to the carrier upon stirring of them, potentially staining the carrier to decrease the charge amount.

The median diameter of the calixarene derivative contained in the solution or dispersion liquid prepared at the solution or dispersion liquid-preparing step is not particularly limited and may be appropriately selected depending on the intended purpose. The median diameter is preferably 0.03 μm to 0.70 μm, more preferably 0.05 μm to 0.60 μm, particularly preferably larger than 0.15 μm but 0.50 μm or smaller.

When the median diameter is smaller than 0.03 μm, the calixarene derivative aggregates inside toner particles and cannot satisfactorily deform the toner particles, which degrades cleaning property. Furthermore, charge-imparting effects cannot be obtained satisfactorily in some cases. When the median diameter exceeds 0.70 μm, the toner cannot be deformed satisfactorily and may be degraded in cleaning property.

The average dispersion diameter or median diameter of the calixarene derivative can be measured, for example, as follows.

Specifically, the toner (1 g) is immersed in chloroform (100 g) for 10 hours, and the calixarene derivative dispersion liquid is centrifuged at 5,500 rpm (9,545 g) with a centrifuge (H-9R, product of KOKUSAN CO., LTD., using an LN angle rotor). The supernatant obtained after centrifugation contains calixarene derivative particles, which are measured for particle diameter with “LA-920” (product of Horiba, Ltd.). In the measurement using LA-920, LA-920 specialized application (Ver 3.32) (product of Horiba, Ltd.) is used for analysis.

More specifically, the optical axis is adjusted with chloroform and then background is measured. Thereafter, circulation is initiated and the calixarene derivative dispersion liquid is dropped. After it has been confirmed that the transmittance is stable, ultrasonic wave is applied under the following conditions.

After application of ultrasonic wave, the diameter of particles dispersed is measured so that the transmittance falls within a range of 70% to 95%. In terms of reproducibility in measuring the particle diameter, it is important that the measurement with “LA-920” is performed under the conditions that the transmittance falls within a range of 70% to 95%. Also, when the transmittance deviates from the above range after the application of an ultrasonic wave, it is necessary to perform the measurement again. In order to render the transmittance to fall within the above range, the amount of the dispersion liquid dropped must be adjusted.

The measurement/analysis conditions are set as follows.

Number of inputs of data: 15 times
Relative refractive index: 1.20

### Circulation: 5

Intensity of ultrasonic wave: 7

Notably, although the above measurement method measures the dispersion diameter of the calixarene derivative contained in the produced toner, the calixarene derivative is internally added to the toner without being decomposed by the toner material and thus, the measurement can be used as a dispersion diameter of the calixarene derivative contained in the solution or dispersion liquid prepared at the solution or dispersion liquid-preparing step.

The calixarene derivative is internally added to the toner so that it is localized in the vicinity of the toner surface.

The state of the calixarene derivative present in the toner can be observed as follows.

Specifically, toner particles are stained for 3 min by being exposed to vapor of aqueous ruthenium oxide, and then left to stand in air for 30 min. Subsequently, the toner particles are wrapped with an epoxy resin curable within 30 min. Then, the obtained sample is cut with an ultramicrotome so as to have a thickness of 80 nm, and with a diamond knife (Ultra Sonic 35) at a cutting speed of 0.4 mm/sec. The thus-cut section is fixed on a collodion membrane mesh, and observed under JEM-2100F (product of JEOL Ltd., TEM) with the light-field method under the conditions: acceleration voltage: 200 kV, SpotSize3, CL AP1, OL AP3.

Also, the calixarene derivative represented by General Formula (I) is preferably localized in an internal region within 1 μm from the uppermost surface of the toner when the cross-sectional surface of the toner is observed through halogen mapping.

The detail conditions and observation method will next be described.

Specifically, the surface of the toner is stained with ruthenium tetroxide (or osmium tetroxide) and wrapped with an epoxy resin, followed by cutting into a section with a microtome.

The section is placed on a substrate and observed through a backscattered electron image using a scanning electron microscope (SEM, product of Carl ZEISS).

Also, EDS (product of Thermo Fisher Scientific) equipped with the SEM is used to measure fluorescent X rays for elemental mapping.

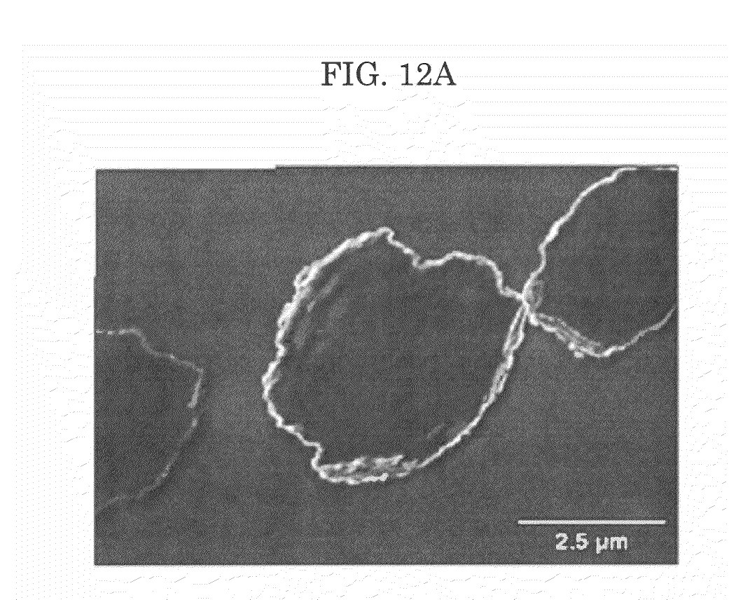

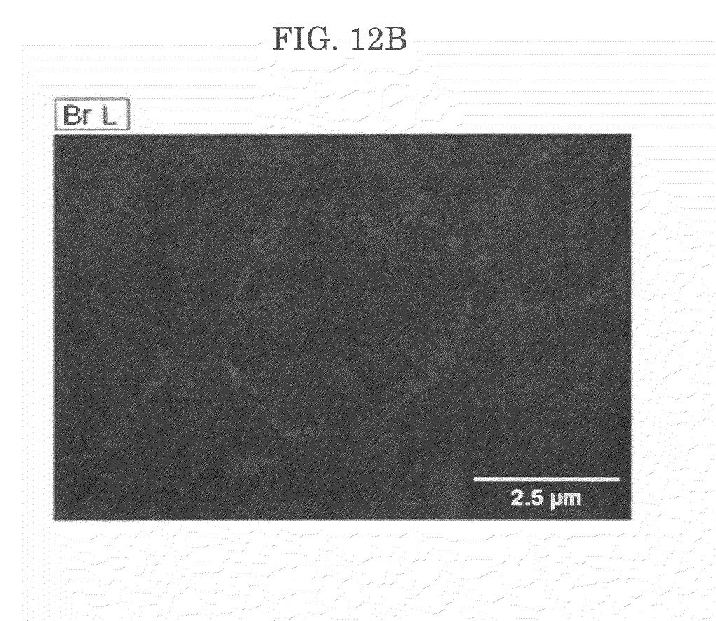

Each of FIGS. 12A and 12B illustrates an image obtained through observation of bromine-containing toner particles.

From FIG. 12A, since the toner surface is stained with ruthenium, the profile of the toner particles is indicated by the white line (contrast).

By performing EDS mapping in the same field, it is found that bromine atoms are localized in an internal region within 1 μm from the uppermost surfaces of the toner particles along the profile of the toner (FIG. 12B).

Notably, in the present invention, the description “compound A (calixarene derivative) is localized in the surface of the toner particle” means that “compound A exists mainly in an internal region in the vicinity of the surface of the toner particle and does not virtually exist in the vicinity of the core of the toner particle.” Also, the description “compound A is localized in an internal region within 1 μm from the uppermost surface” means that almost all compound A (e.g., 90% or higher) exists in an internal region within 1 μm from the uppermost surface.”

The rate of compound A existing in an internal region within 1 μm from the uppermost surface can be calculated by determining, through image processing, the areas occupied with the halogen atoms detected in the cross-sectional image of the toner (FIG. 12B). Specifically, it can be calculated by obtaining the ratio of the areas occupied with the halogen atoms present in an internal region within 1 μm from the uppermost surface to all the areas occupied with the halogen atoms detected.

The amount of the calixarene derivative added is not particularly limited and may be appropriately selected depending on the intended purpose. The amount of the calixarene derivative is preferably 0.01 parts by mass to 5 parts by mass per 100 parts by mass of the organic solvent.

When the amount of the calixarene derivative is less than 0.01 parts by mass, the toner may not be effectively deformed. When the amount of the calixarene derivative is more than 5 parts by mass, the chargeability of the toner becomes too large, which reduces the effect of a main charge controlling agent. As a result, the electrostatic attraction force to the developing roller used may be increased to cause a degradation in flowability of the developer and a degradation in image density. In addition, the surface characteristics of the toner are degraded and contaminate carriers, not maintaining sufficient chargeability for a long period of time. Furthermore, the environmental stability is degraded in some cases.

### (Organic Solvent)

The organic solvent is not particularly limited, so long as it allows the toner material to be dissolved or dispersed therein, and may be suitably selected depending on the intended purpose. It is preferable that the organic solvent be a solvent having a boiling point of lower than 150° C. in terms of easy removal during or after formation of toner particles. Specific examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. Among these solvents, ester solvents are preferable, with ethyl acetate being particularly preferable. These solvents may be used alone or in combination.

The amount of the organic solvent is not particularly limited and may be appropriately selected depending on the intended purpose. Preferably, the amount of the organic solvent is 40 parts by mass to 300 parts by mass, more preferably 60 parts by mass to 140 parts by mass, particularly preferably 80 parts by mass to 120 parts by mass, based on 100 parts by mass of the toner material.

The solution or dispersion liquid of the toner material can be prepared by dissolving or dispersing in the organic solvent the toner materials such as the binder resin, the active hydrogen group-containing compound, the polymer reactive with the active hydrogen group-containing compound, the releasing agent, the colorant and the charge controlling agent.

The toner materials used in the solution or dispersion liquid-preparing step may contain at least the binder resin or binder resin precursor. The other materials may be added to and mixed with the aqueous medium which is prepared in the emulsion or dispersion liquid-preparing step, or may be added to the aqueous medium together with the solution or dispersion liquid.

### —Binder Resin and Binder Resin Precursor—

The binder resin contained is not particularly limited and may be appropriately selected depending on the intended purpose. Specific examples thereof include polyester resins, silicone resins, styrene-acrylic resins, styrene resins, acrylic resins, epoxy resins, diene resins, phenol resins, terpene resins, coumarin resins, amide imide resins, butyral resins, urethane resins, and ethylene vinyl acetate resins.

Among these compounds, polyester resins are particularly preferable because of being sharply melted upon fixing, being capable of smoothing the image surface, having sufficient flexibility even if the molecular weight thereof is lowered. The polyester resins may be used in combination with another resin.

The polyester resins are preferably produced through reaction between one or more polyols represented by the following General Formula (2) and one or more polycarboxylic acids represented by the following General Formula (3),

A-(OH)r General Formula (2)

where A represents an alkyl group having 1 to 20 carbon atoms, an alkylene group having 1 to 20 carbon atoms, an aromatic group which may have a substituent, or a heterocyclic aromatic group which may have a substituent; and r is an integer of 2 to 4,

B—(COOH)s General Formula (3)

where B represents an alkyl group having 1 to 20 carbon atoms, an alkylene group having 1 to 20 carbon atoms, an aromatic group which may have a substituent, or a heterocyclic aromatic group which may have a substituent; and s is an integer of 2 to 4.

Examples of the polyol represented by General Formula (2) include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, 1,3,5-trihydroxymethylbenzene, bisphenol A, ethylene oxide adducts of bisphenol A, propylene oxide adducts of bisphenol A, hydrogenated bisphenol A, ethylene oxide adducts of hydrogenated bisphenol A, and propylene oxide adducts of hydrogenated bisphenol A.

Examples of polycarboxylic acids represented by General Formula (3) include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenylsuccinic acid, isooctylsuccinic acid, isododecenylsuccinic acid, n-dodecylsuccinic acid, isododecylsuccinic acid, n-octenylsuccinic acid, n-octylsuccinic acid, isooctenylsuccinic acid, isooctylsuccinic acid, 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, Enpol trimer acid, cyclohexanedicarboxylic acid, cyclohexenedicarboxylic acid, butanetetracarboxylic acid, diphenylsulfonetetracarboxylic acid, and ethylene glycolbis(trimellitic acid).

The amount of the binder resin added is not particularly limited and may be appropriately selected depending on the intended purpose. The amount of the binder resin is preferably 5 parts by mass to 25 parts by mass relative to 100 parts by mass of the organic solvent dispersion liquid.

When the amount of the binder resin is less than 5 parts by mass, the dispersion diameter of the calixarene derivative may not be small. When the amount of the binder resin is more than 25 parts by mass, the toner materials aggregate when added to the solution or dispersion liquid, resulting in that the deforming effects and charge-imparting effects may not be satisfactorily obtained.

The organic solvent dispersion liquid particularly preferably contains the calixarene derivative in an amount of 5 parts by mass and the binder resin in an amount of 5 parts by mass relative to 100 parts by mass of the organic solvent dispersion liquid.

### (Active Hydrogen Group-Containing Compound)

When the toner material contains an active hydrogen group-containing compound and a modified polyester resin reactive with the compound, the mechanical strength of the resultant toner is increased and embedding of external additives can be suppressed. Further, the fluidity during the heat fixation can be regulated, and, consequently, the fixing temperature range can be broadened.

Notably, the active hydrogen group-containing compound and the modified polyester resin reactive with the active hydrogen group-containing compound can be said to be a binder resin precursor.

In the emulsion or dispersion liquid-preparing step, the active hydrogen group-containing compound serves, in the aqueous medium, as an elongating agent, a crosslinking agent, etc. for reactions of elongation, crosslinking, etc. of a polymer reactive with the active hydrogen group-containing compound.

The active hydrogen group-containing compound is not particularly limited, so long as it contains an active hydrogen group, and may be appropriately selected depending on the intended purpose. For example, when the polymer reactive with the active hydrogen group-containing compound is an isocyanate group-containing polyester prepolymer (A), an amine (B) is preferably used as the active hydrogen group-containing compound, since it can provide a high-molecular-weight product through reactions of elongation, crosslinking, etc. with the isocyanate group-containing polyester prepolymer (A).

The active hydrogen group is not particularly limited, so long as it contains an active hydrogen atom, and may be appropriately selected depending on the intended purpose. Examples thereof include a hydroxyl group (alcoholic or phenolic hydroxyl group), an amino group, a carboxylic group and a mercapto group. These may be used alone or in combination.

The amine (B) is not particularly limited and may be appropriately selected depending on the intended purpose. Examples thereof include diamines (B1), tri- or more-valent polyamines (B2), amino alcohols (B3), aminomercaptans (B4), amino acids (B5), and amino-blocked products (B6) of the amines (B1) to (B5). These may be used alone or in combination. Among them, preferred are diamines (B1) and a mixture of the diamines (B1) and a small amount of the tri- or more-valent amine (B2).

Examples of the diamine (B1) include aromatic diamines, alicyclic diamines and aliphatic diamines.

Examples of the aromatic diamine include phenylenediamine, diethyltoluenediamine and 4,4′-diaminodiphenylmethane.

Examples of the alicyclic diamine include 4,4′-diamino-3,3′-dimethyldicyclohexylmethane, diaminecyclohexane and isophoronediamine.

Examples of the aliphatic diamines include ethylenediamine, tetramethylenediamine and hexamethylenediamine.

Examples of the tri- or more-valent amine (B2) include diethylenetriamine and triethylenetetramine.

Examples of the amino alcohol (B3) include ethanolamine and hydroxyethylaniline. Examples of the aminomercaptan (B4) include aminoethyl mercaptan and aminopropyl mercaptan. Examples of the amino acid (B5) include aminopropionic acid and aminocaproic acid.

Examples of the amino-blocked product (B6) include ketimine compounds and oxazolidine compounds derived from the amines (B1) to (B5) and ketones (e.g., acetone, methyl ethyl ketone and methyl isobutyl ketone).

Also, a reaction terminator can be used for terminating elongation/crosslinking reaction between the active hydrogen group-containing compound and the polymer reactive therewith.

Use of the reaction terminator can control the adhesive base material in its molecular weight, etc. to a desired level.

The reaction terminator is not particularly limited, and examples thereof include monoamines (e.g., diethyl amine, dibutyl amine, butyl amine and lauryl amine) and blocked products thereof (e.g., ketimine compounds).

The mixing ratio of the isocyanate group-containing polyester prepolymer (A) to the amine (B) is not particularly limited but preferably 1/3 to 3/1, more preferably 1/2 to 2/1, particularly preferably 1/1.5 to 1.5/1, in terms of the equivalent ratio ([NCO]/[NHx]) of isocyanate group [NCO] in the isocyanate group-containing prepolymer (A) to amino group [NHx] in the amine (B).

When the equivalent ratio ([NCO]/[NHx]) is less than 1/3, the formed toner may have degraded low-temperature fixing property. When the equivalent ratio ([NCO]/[NHx]) is more than 3/1, the molecular weight of the urea-modified polyester resin decreases, resulting in that the formed toner may have degraded hot offset resistance.

(Polymer Reactive with Active Hydrogen Group-Containing Compound)

The polymer reactive with the active hydrogen group-containing compound (hereinafter also referred to as a “prepolymer”) is not particularly limited, so long as it has at least a site reactive with the active hydrogen group-containing compound, and may be appropriately selected from known resins. Examples thereof include polyol resins, polyacrylic resins, polyester resins, epoxy resins, and derivative resins thereof. Among them, polyester resins are preferred since they have high fluidity upon melting and high transparency. These may be used alone or in combination.

In the prepolymer, the reaction site reactive with the active hydrogen group-containing group is not particularly limited. Appropriately selected known substituents (moieties) may be used as the reaction site. Examples thereof include an isocyanate group, an epoxy group, a carboxyl group and an acid chloride group. These may be used alone or in combination as the reaction site. Among them, an isocyanate group is preferred.

As the prepolymer, a urea bond-forming group-containing polyester resin (RMPE) containing a urea bond-forming group is preferred, since it is easily adjusted for the molecular weight of the polymeric component thereof and thus is preferably used for forming dry toner, in particular for assuring oil-less low temperature fixing property (e.g., releasing and fixing properties requiring no releasing oil-application mechanism for a heat-fixing medium).

Examples of the urea bond-forming group include an isocyanate group.

Preferred examples of the RMPE having an isocyanate group as the urea bond-forming group include the above isocyanate group-containing modified polyester prepolymer (A).

The isocyanate group-containing polyester prepolymer (A) is not particularly limited and may be appropriately selected depending on the intended purpose. Examples thereof include those produced as follows: a polyol (PO) is polycondensed with a polycarboxylic acid (PC) to form a resin having an active hydrogen-containing group; and the thus-formed polyester is reacted with a polyisocyanate (PIC).

The polyol (PO) is not particularly limited and can be appropriately selected depending on the intended purpose. Examples thereof include diols (DIOs), 3 or more hydroxyl group-containing polyols (TOs), and mixtures of diols (DIOs) and 3 or more hydroxyl group-containing polyols (TOs). These may be used alone or in combination. Among them, preferred are diols (DIOs) and mixtures of diols (DIOs) and a small amount of 3 or more hydroxyl group-containing polyols (TOs).

Examples of the diol (DIO) include alkylene glycols, alkylene ether glycols, alicyclic diols, alkylene oxide adducts of alicyclic diols, bisphenols, and alkylene oxide adducts of bisphenols.

The alkylene glycol preferably is those having 2 to 12 carbon atoms, and examples thereof include ethylene glycol, 1,2-propylene glycol, 1,3-propylene glycol, 1,4-butanediol and 1,6-hexanediol.

Examples of the alkylene ether glycol include diethylene glycol, triethylene glycol, dipropylene glycol, polyethylene glycol, polypropylene glycol and polytetramethylene ether glycol.

Examples of the alicyclic diol include 1,4-cyclohexane dimethanol and hydrogenated bisphenol A.

Examples of the alkylene oxide adducts of alicyclic diols include adducts of the above-listed alicyclic diols with alkylene oxides (e.g., ethylene oxide, propylene oxide and butylene oxide).

Examples of the bisphenol include bisphenol A, bisphenol F and bisphenol S.

Examples of the alkylene oxide adducts of bisphenols include adducts of the above-listed bisphenols with alkylene oxides (e.g., ethylene oxide, propylene oxide and butylene oxide).

Among them, preferred are alkylene glycols having 2 to 12 carbon atoms and alkylene oxide adducts of bisphenols, particularly preferred are alkylene oxide adducts of bisphenols, and mixtures of alkylene glycols having 2 to 12 carbon atoms and alkylene oxide adducts of bisphenols.

The 3 or more hydroxyl group-containing polyol (TO) preferably has 3 to 8 or more hydroxyl groups. Examples thereof include 3 or more hydroxyl group-containing aliphatic polyhydric alcohols; and 3 or more hydroxyl group-containing polyphenols and alkylene oxide adducts thereof.

Examples of the 3 or more hydroxyl group-containing aliphatic polyhydric alcohol include glycerin, trimethylolethane, trimethylolpropane, pentaerythritol and sorbitol.

Examples of the 3 or more hydroxyl group-containing polyphenol include trisphenol compounds (e.g., trisphenol PA, product of HONSHU CHEMICAL INDUSTRY CO., LTD.), phenol novolak and cresol novolak.

Examples of the alkylene oxide adducts include adducts of the above-listed 3 or more hydroxyl group-containing polyphenols with alkylene oxides (e.g., ethylene oxide, propylene oxide and butylene oxide).

In the mixture of the diol (DIO) and the 3 or more hydroxyl group-containing polyol (TO), the mixing ratio by mass (DIO:TO) is preferably 100:0.01 to 100:10, more preferably 100:0.01 to 100:1.

The polycarboxylic acid (PC) is not particularly limited and can be appropriately selected depending on the purpose. Examples thereof include dicarboxylic acids (DICs), polycarboxylic acids having 3 or more carboxyl groups (TCs), and mixtures of dicarboxylic acids (DICs) and polycarboxylic acids having 3 or more carboxyl groups. These may be used alone or in combination. Among them, preferred are carboxylic acids (DICs) and mixtures of DICs and a small amount of polycarboxylic acids having 3 or more carboxyl groups (TCs).

Examples of the dicarboxylic acid (DIC) include alkylene dicarboxylic acids, alkenylene dicarboxylic acids, and aromatic dicarboxylic acids.

Examples of the alkylene dicarboxylic acid include succinic acid, adipic acid and sebacic acid.

The alkenylene dicarboxylic acid is preferably those having 4 to 20 carbon atoms, and examples thereof include maleic acid and fumaric acid.

The aromatic dicarboxylic acid is preferably those having 8 to 20 carbon atoms, and examples thereof include phthalic acid, isophthalic acid, terephthalic acid, and naphthalenedicarboxylic acid.

Among them, preferred are alkenylene dicarboxylic acids having 4 to 20 carbon atoms and aromatic dicarboxylic acid having 8 to 20 carbon atoms.

The polycarboxylic acid having 3 or more carboxyl groups (TC) preferably has 3 to 8 or more carboxyl groups. Examples thereof include aromatic polycarboxylic acids.

The aromatic polycarboxylic acid is preferably those having 9 to 20 carbon atoms, and examples thereof include trimellitic acid and pyromellitic acid.

Alternatively, as the polycarboxylic acid (PC), there may be used acid anhydrides or lower alkyl esters of the above dicarboxylic acids (DICs), the above polycarboxylic acids having 3 or more carboxyl groups (TCs), and mixtures of the dicarboxylic acid (DICs) and the polycarboxylic acids having 3 or more carboxyl groups (TCs).

Examples of the lower alkyl ester thereof include methyl esters thereof, ethyl esters thereof and isopropyl esters thereof.

In the mixture of the dicarboxylic acid (DIC) and the polycarboxylic acid having 3 or more carboxyl groups (TC), the mixing ratio by mass (DIC:TC) is not particularly limited and can be appropriately selected depending on the purpose. Preferably, the mixing ratio (DIC:TC) is 100:0.01 to 100:10, more preferably 100:0.01 to 100:1.

In polycondensation reaction between the polyol (PO) and the polycarboxylic acid (PC), the mixing ratio of PO to PC is not particularly limited and can be appropriately selected depending on the purpose. The mixing ratio PO/PC is preferably 2/1 to 1/1, more preferably 1.5/1 to 1/1, particularly preferably 1.3/1 to 1.02/1, in terms of the equivalent ratio ([OH]/[COOH]) of hydroxyl group [OH] in the polyol (PO) to carboxyl group [COOH] in the polycarboxylic acid (PC).

The polyol (PO) content of the isocyanate group-containing polyester prepolymer (A) is not particularly limited and can be appropriately determined depending on the purpose. For example, it is preferably 0.5% by mass to 40% by mass, more preferably 1% by mass to 30% by mass, particularly preferably 2% by mass to 20% by mass. When the polyol (PO) content is less than 0.5% by mass, the formed toner has degraded hot offset resistance, making it difficult for the toner to attain both desired heat resistance/storage stability and desired low-temperature fixing property. When the polyol (PO) content is more than 40% by mass, the formed toner may have degraded low-temperature fixing property.

The polyisocyanate (PIC) is not particularly limited and can be appropriately selected depending on the purpose. Examples thereof include aliphatic polyisocyanates, alicyclic polyisocyanates, aromatic diisocyanates, aromatic/aliphatic diisocyanates, isocyanurates, phenol derivatives thereof, and blocked products thereof with oxime, caprolactam, etc.

Examples of the aliphatic polyisocyanate include tetramethylene diisocyanate, hexamethylene diisocyanate, 2,6-diisocyanatomethylcaproate, octamethylene diisocyanate, decamethylene diisocyanate, dodecamethylene diisocyanate, tetradecamethylene diisocyanate, trimethylhexane diisocyanate, and tetramethylhexane diisocyanate.

Examples of the alicyclic polyisocyanate include isophorone diisocyanate and cyclohexylmethane diisocyanate.

Examples of the aromatic diisocyanate include tolylene diisocyanate, diphenylmethane diisocyanate, 1,5-naphthylene diisocyanate, diphenylene-4,4′-diisocyanate, 4,4′-diisocyanato-3,3′-dimethyldiphenyl, 3-methyldiphenylmethane-4,4′-diisocyanate and diphenylether-4,4′-diisocyanate.

Examples of the aromatic/aliphatic diisocyanate include α,α,α′,α′-tetramethylxylylene diisocyanate.

Examples of the isocyanurate include tris-isocyanatoalkyl-isocyanurate and triisocyanatoalkyl-isocyanurate.

These may be used alone or in combination.

In reaction between the polyisocyanate (PIC) and the polyester resin having an active hydrogen-containing group (e.g., hydroxyl group-containing polyester resin), the ratio of the PIC to the polyester resin is preferably 5/1 to 1/1, more preferably 4/1 to 1.2/1, particularly preferably 3/1 to 1.5/1, in terms of the mixing equivalent ratio ([NCO]/[OH]) of isocyanate group [NCO] in the polyisocyanate (PIC) to hydroxyl group [OH] in the hydroxyl group-containing polyester resin. When the mixing equivalent ratio [NCO]/[OH] is more than 5, the formed toner may have degraded low-temperature fixing property; whereas when the mixing equivalent ratio [NCO]/[OH] is less than 1, the formed toner may have degraded offset resistance.

The polyisocyanate (PIC) content of the isocyanate group-containing polyester prepolymer (A) is not particularly limited and can be appropriately determined depending on the purpose. For example, it is preferably 0.5% by mass to 40% by mass, more preferably 1% by mass to 30% by mass, particularly preferably 2% by mass to 20% by mass.

When the polyisocyanate (PIC) content is less than 0.5% by mass, the formed toner has degraded hot offset resistance, making it difficult for the toner to attain both desired heat resistance/storage stability and desired low-temperature fixing property. When the polyisocyanate (PIC) content is more than 40% by mass, the formed toner may have degraded low-temperature fixing property.

The average number of isocyanate groups per molecule of the isocyanate group-containing polyester prepolymer (A) is not particularly limited but is preferably one or more, more preferably 1.2 to 5, still more preferably 1.5 to 4.

When the average number of the isocyanate groups is less than one per one molecule, the molecular weight of the polyester resin modified with a urea bond-forming group (RMPE) decreases, resulting in that the formed toner may have degraded hot offset resistance.

The weight average molecular weight (Mw) of the polymer (prepolymer) reactive with the active hydrogen group-containing compound is not particularly limited but preferably 3,000 to 40,000, more preferably 4,000 to 30,000 based on the molecular weight distribution obtained by analyzing tetrahydrofuran (THF) soluble matter of the polymer through gel permeation chromatography (GPC).

When the weight average molecular weight (Mw) is lower than 3,000, the formed toner may have degraded heat resistance/storage stability; whereas when the Mw is higher than 40,000, the formed toner may have degraded low-temperature fixing property.

The gel permeation chromatography (GPC) for determining the molecular weight can be performed, for example, as follows.

Specifically, a column is conditioned in a heat chamber at 40° C., and then tetrahydrofuran (THF) (solvent) is caused to pass through the column at a flow rate of 1 mL/min while the temperature is maintained. Subsequently, a separately prepared tetrahydrofuran solution of a resin sample (concentration: 0.05% by mass to 0.6% by mass) is applied to the column in an amount of 50 μL to 200 μl. In the measurement of the molecular weight of the sample, the molecular weight distribution is determined based on the relationship between the logarithmic value and the count number of a calibration curve given by using several monodisperse polystyrene-standard samples. The standard polystyrenes used for giving the calibration curve may be, for example, those available from Pressure Chemical Co. or Tosoh Co.; i.e., those each having a molecular weight of 6×10², 2.1×10², 4×10³, 1.75×10⁴, 1.1×10⁵, 3.9×10⁵, 8.6×10⁵, 2×10⁶ and 4.48×10⁶. Preferably, at least about 10 standard polystyrenes are used for giving the calibration curve. The detector which can be used is a refractive index (RI) detector.

The binder resin preferably exhibits adhesiveness to a recording medium such as paper, and contains an adhesive polymer obtained through reaction of the active hydrogen group-containing compound with the polymer reactive with the active hydrogen group-containing compound in an aqueous medium.

The weight average molecular weight of the binder resin is not particularly limited and may be appropriately selected depending on the intended purpose. It is preferably 3,000 or higher, more preferably 5,000 to 1,000,000, particularly preferably 7,000 to 500,000.

Since the weight average molecular weight is lower than 3,000, the formed toner may have degraded hot offset resistance.

The glass transition temperature (Tg) of the binder resin is not particularly limited and may be appropriately selected depending on the intended purpose. The glass transition temperature of the binder resin is preferably 30° C. to 70° C., more preferably 40° C. to 65° C.

When the glass transition temperature (Tg) is lower than 30° C., the formed toner may have degraded heat-resistant storage stability. When the glass transition temperature (Tg) is higher than 70° C., the formed toner may have insufficient low-temperature fixability.

In the above toner, there exists a polyester resin subjected to crosslinking reaction and elongation reaction. Accordingly, even when the glass transition temperature is lower than that of the conventional polyester toner, better storage stability can be realized as compared with the conventional polyester toner.

The glass transition temperature (Tg) as used herein is determined in the following manner using TA-60WS and DSC-60 (these products are of Shimadzu Co.) as a measuring device under the conditions given below.

### Measurement Conditions

Sample container: aluminum sample pan (with a lid)

Sample amount: 5 mg

Reference: aluminum sample pan (10 mg of alumina)

Atmosphere: nitrogen (flow rate: 50 mL/min)

Temperature condition:
Start temperature: 20° C.
Heating rate: 10° C./min
Finish temperature: 150° C.
Hold time: 0
Cooling rate: 10° C./min
Finish temperature: 20° C.
Hold time: 0
Heating rate: 10° C./min
Finish temperature: 150° C.

The measured results are analyzed using the above-mentioned data analysis software (TA-60, version 1.52) available from Shimadzu Co. The analysis is performed by appointing a range of ±5° C. around a point showing the maximum peak in the lowest temperature side of DrDSC curve, which was the differential curve of the DSC curve in the second heating, and determining the peak temperature using a peak analysis function of the analysis software. Then, the maximum endotherm temperature of the DSC curve was determined in the range of the above peak temperature +5° C. and −5° C. in the DSC curve using a peak analysis function of the analysis software. The temperature shown here corresponds to Tg of the toner.

Next, specific production examples of the binder resin or binder resin precursor will be described.

The binder resin is not particularly limited and may be appropriately selected depending on the intended purpose. Particularly preferred is a polyester resin.

The polyester resin is not particularly limited and may be appropriately selected depending on the intended purpose. Particularly preferably examples thereof include urea-modified polyester resins, and unmodified polyester resins.

The urea-modified polyester resin is obtained by reacting, in the aqueous medium, amines (B) serving as the active hydrogen group-containing compound and an isocyanate group-containing polyester prepolymer (A) serving as the polymer reactive with the active hydrogen group-containing compound.

The urea-modified polyester resin may contain a urethane bonding, as well as a urea bonding. In this case, a molar ratio (urea bonding/urethane bonding) of the urea bonding to the urethane bonding is not particularly limited and may be appropriately selected depending on the intended purpose. It is preferably 100/0 to 10/90, more preferably 80/20 to 20/80, particularly preferably 60/40 to 30/70.

In the case where the molar ratio of the urea bonding is less than 10, the formed toner may have degraded hot offset resistance.

Preferred examples of the urea-modified polyester resin and the unmodified polyester resin include the following.

(1) a mixture of; a polycondensation product of bisphenol A ethyleneoxide (2 mol) adduct and isophthalic acid; and a compound obtained by urea-modifying a polyester prepolymer with isophorone diamine, wherein the polyester prepolymer is obtained by reacting a polycondensation product of bisphenol A ethyleneoxide (2 mol) adduct and isophthalic acid with isophorone diisocyanate.

(2) a mixture of: a polycondensation product of bisphenol A ethyleneoxide (2 mol) adduct and terephthalic acid; and a compound obtained by urea-modifying a polyester prepolymer with isophorone diamine, wherein the polyester prepolymer is obtained by reacting a polycondensation product of bisphenol A ethyleneoxide (2 mol) adduct and isophthalic acid with isophorone diisocyanate.

(3) a mixture of: a polycondensation product of bisphenol A ethyleneoxide (2 mol) adduct/bisphenol A propyleneoxide (2 mol) adduct, and terephthalic acid; and a compound obtained by urea-modifying a polyester prepolymer with isophorone diamine, wherein the polyester prepolymer is obtained by reacting a polycondensation product of bisphenol A ethyleneoxide (2 mol) adduct/bisphenol A propyleneoxide (2 mol) adduct, and terephthalic acid with isophorone diisocyanate.

(4) a mixture of: a polycondensation product of bisphenol A propyleneoxide (2 mol) adduct, and terephthalic acid; and a compound obtained by urea-modifying a polyester prepolymer with isophorone diamine, wherein the polyester prepolymer is obtained by reacting a polycondensation product of bisphenol A ethyleneoxide (2 mol) adduct/bisphenol A propyleneoxide (2 mol) adduct, and terephthalic acid with isophorone diisocyanate.

(5) a mixture of: a polycondensation product of bisphenol A ethyleneoxide (2 mol) adduct, and terephthalic acid; and a compound obtained by urea-modifying a polyester prepolymer with hexamethylene diamine, wherein the polyester prepolymer is obtained by reacting a polycondensation product of bisphenol A ethyleneoxide (2 mol) adduct, and terephthalic acid with isophorone diisocyanate.

(6) a mixture of: a polycondensation product of bisphenol A ethyleneoxide (2 mol) adduct/bisphenol A propyleneoxide (2 mol) adduct, and terephthalic acid; and a compound obtained by urea-modifying a polyester prepolymer with hexamethylene diamine, wherein the polyester prepolymer is obtained by reacting a polycondensation product of bisphenol A ethyleneoxide (2 mol) adduct, and terephthalic acid with isophorone diisocyanate.

(7) a mixture of: a polycondensation product of bisphenol A ethyleneoxide (2 mol) adduct, and terephthalic acid; and a compound obtained by urea-modifying a polyester prepolymer with ethylene diamine, wherein the polyester prepolymer is obtained by reacting a polycondensation product of bisphenol A ethyleneoxide (2 mol) adduct, and terephthalic acid with isophorone diisocyanate.

(8) a mixture of: a polycondensation product of bisphenol A ethylene oxide (2 mol) adduct, and isophthalic acid; and a compound obtained by urea-modifying a polyester prepolymer with hexamethylene diamine, wherein the polyester prepolymer is obtained by reacting a polycondensation product of bisphenol A ethyleneoxide (2 mol) adduct, and isophthalic acid with diphenylmethane diisocyanate.

(9) a mixture of: a polycondensation product of bisphenol A ethyleneoxide (2 mol) adduct/bisphenol A propyleneoxide (2 mol) adduct, and terephthalic acid; and a compound obtained by urea-modifying a polyester prepolymer with hexamethylene diamine, wherein the polyester prepolymer is obtained by reacting a polycondensation product of bisphenol A ethyleneoxide (2 mol) adduct/bisphenol A propyleneoxide (2 mol) adduct, and terephthalic acid/dodecenylsuccinic anhydride with diphenylmethane diisocyanate.

(10) a mixture of: a polycondensation product of bisphenol A ethyleneoxide (2 mol) adduct, and isophthalic acid; and a compound obtained by urea-modifying a polyester prepolymer with hexamethylene diamine, wherein the polyester prepolymer is obtained by reacting a polycondensation product of bisphenol A ethyleneoxide (2 mol) adduct, and isophthalic acid with toluene diisocyanate.

The urea-modified polyester is formed by, for example, the following methods.

(1) The solution or dispersion liquid of the toner material containing the polymer reactive with the active hydrogen group-containing compound (e.g., the isocyanate group-containing polyester prepolymer (A)) is emulsified or dispersed in the aqueous medium phase together with the active hydrogen group-containing compound (e.g., the amine (B)) so as to form oil droplets, and these two compounds are allowed to proceed the elongation reaction and/or crosslinking reaction in the aqueous medium.

(2) The solution or dispersion liquid of the toner material is emulsified or dispersed in the aqueous medium, to which the active hydrogen group-containing compound has previously been added, so as to form oil droplets, and these two compounds are allowed to proceed the elongation reaction and/or crosslinking reaction in the aqueous medium phase.

(3) The solution or dispersion liquid of the toner material is added and mixed in the aqueous medium, the active hydrogen group-containing compound is added thereto so as to form oil droplets, and these two compounds are allowed to proceed the elongation reaction and/or crosslinking reaction from the surfaces of the particles in the aqueous medium.

In the case of (3), the modified polyester resin is preferentially formed at the surface of the toner to be formed, and thus the concentration gradation of the modified polyester can be provided within the toner particles.

The reaction conditions for forming the binder resin through emulsification or dispersion are not particularly limited and may be appropriately selected depending on the combination of the active hydrogen group-containing compound and the polymer reactive with the active hydrogen group-containing compound. The reaction time is preferably 10 minutes to 40 hours, more preferably 2 hours to 24 hours.

The method for stably forming the dispersion liquid containing the polymer reactive with the active hydrogen group-containing compound (e.g., the isocyanate group-containing polyester prepolymer (A)) in the aqueous medium is such that the toner solution or dispersion liquid, which is prepared by dissolving and/or dispersing the toner material containing the polymer reactive with the active hydrogen group-containing compound (e.g. the isocyanate group-containing polyester prepolymer (A)), the colorant, the releasing agent, the charge controlling agent, the unmodified polyester, and the like, is added to the aqueous medium, and then dispersed by shearing force.

In emulsification and/or dispersion, the amount of the aqueous medium used is preferably 50 parts by mass to 2,000 parts by mass, particularly preferably 100 parts by mass to 1,000 parts by mass, based on 100 parts by mass of the toner material.

When the amount of the aqueous medium used is less than 50 parts by mass, the toner material is poorly dispersed, resulting in that toner particles having a predetermined particle diameter are not obtained in some cases. When the amount of the aqueous medium used is more than 2,000 parts by mass, the production cost is elevated.

### —Other Components—

The other components are not particularly limited and may be appropriately selected depending on the intended purpose. Examples thereof include colorants, releasing agents, charge controlling agents, fine inorganic particles, flowability improvers, cleaning improvers, magnetic materials and metal soaps.

### —Colorant—

The colorant is not particularly limited and may be appropriately selected depending on the purpose from known dyes and pigments. Examples thereof include carbon black, nigrosine dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro anilin red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red F5R, brilliant carmin 6B, pigment scarlet 3B, bordeaux 5B, toluidine Maroon, permanent bordeaux F2K, Helio bordeaux BL, bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, victoria blue lake, metal-free phthalocyanin blue, phthalocyanin blue, fast sky blue, indanthrene blue (RS and BC), indigo, ultramarine, iron blue, anthraquinon blue, fast violet B, methylviolet lake, cobalt purple, manganese violet, dioxane violet, anthraquinon violet, chrome green, zinc green, chromium oxide, viridian, emerald green, pigment green B, naphthol green B, green gold, acid green lake, malachite green lake, phthalocyanine green, anthraquinon green, titanium oxide, zinc flower and lithopone. These colorants may be used alone or in combination.

The amount of the colorant contained in the toner is not particularly limited and may be appropriately determined depending on the purpose. It is preferably 1% by mass to 15% by mass, more preferably 3% by mass to 10% by mass.

When the amount of the colorant is less than 1% by mass, the formed toner may degrade in coloring performance. Whereas when the amount is more than 15% by mass, the pigment is not sufficiently dispersed in the toner, potentially leading to a drop in coloring performance and degradation in electrical characteristics of the formed toner.

The colorant may be mixed with a resin to form a masterbatch.

The resin is not particularly limited and may be appropriately selected from those known in the art. Examples thereof include polyesters, polymers of a substituted or unsubstituted styrene, styrene copolymers, polymethyl methacrylates, polybutyl methacrylates, polyvinyl chlorides, polyvinyl acetates, polyethylenes, polypropylenes, epoxy resins, epoxy polyol resins, polyurethanes, polyamides, polyvinyl butyrals, polyacrylic acid resins, rosin, modified rosins, terpene resins, aliphatic or alicyclic hydrocarbon resins, aromatic petroleum resins, chlorinated paraffins and paraffin waxes. These resins may be used alone or in combination.

Examples of the polymers of a substituted or unsubstituted styrene include polyesters, polystyrenes, poly(p-chlorostyrenes) and polyvinyltoluenes. Examples of the styrene copolymers include styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers.

The masterbatch can be prepared by mixing or kneading a colorant with the resin for use in the masterbatch through application of high shearing force. Preferably, an organic solvent may be used for improving the interactions between these materials.

Further, a so-called flashing method is preferably used, since a wet cake of the colorant can be directly used (i.e., no drying is required).

Here, the flashing method is a method in which an aqueous paste containing a colorant is mixed or kneaded with a resin and an organic solvent, and then the colorant is transferred to the resin to remove the water and the organic solvent.

In this mixing/kneading, for example, a high-shearing disperser (e.g., a three-roll mill) is preferably used.

The colorant can be incorporated as desired into any of a first resin phase (inner layer) and a second resin phase by utilizing the difference in affinity to the two resins.

As has been known well, when exists in the surface of the toner, the colorant degrades charging performance of the toner. Thus, by selectively incorporating the colorant into the first resin phase which is the inner layer, the formed toner can be improved in charging performances (e.g., environmental stability, charge retainability and charging amount).

### —Releasing Agent—

The releasing agent is not particularly limited and may be appropriately selected depending on the intended purpose. The melting point thereof is preferably low; i.e., 50° C. to 120° C.

When dispersed together with the above resins, such a low-melting-point releasing agent effectively exhibits its releasing effects on the interface between a fixing roller and each toner particle. Thus, even when an oil-less mechanism is employed (in which a releasing agent such as oil is not applied onto a fixing roller), good hot offset resistance is attained.

Preferred examples of the releasing agent include waxes.

Examples of the waxes include natural waxes such as vegetable waxes (e.g., carnauba wax, cotton wax, Japan wax and rice wax), animal waxes (e.g., bees wax and lanolin), mineral waxes (e.g., ozokelite and ceresine) and petroleum waxes (e.g., paraffin waxes, microcrystalline waxes and petrolatum); synthetic hydrocarbon waxes (e.g., Fischer-Tropsch waxes and polyethylene waxes); and synthetic waxes (e.g., ester waxes, ketone waxes and ether waxes). Further examples include fatty acid amides such as 12-hydroxystearic acid amide, stearic amide, phthalic anhydride imide and chlorinated hydrocarbons; low-molecular-weight crystalline polymer resins such as acrylic homopolymers (e.g., poly-n-stearyl methacrylate and poly-n-lauryl methacrylate) and acrylic copolymers (e.g., n-stearyl acrylate-ethyl methacrylate copolymers); and crystalline polymers having a long alkyl group as a side chain. These releasing agents may be used alone or in combination.

The melting point of the releasing agent is not particularly limited and may be appropriately selected depending on the intended purpose. The melting point is preferably 50° C. to 120° C., more preferably 60° C. to 90° C. When the melting point is lower than 50° C., the wax may adversely affect the heat-resistant storage stability of the toner. When the melting point is higher than 120° C., cold offset is easily caused upon fixing at lower temperatures.

The melt viscosity of the releasing agent is, measured at the temperature 20° C. higher than the melting point of the wax, preferably 5 cps to 1,000 cps, more preferably 10 cps to 100 cps. When the melt viscosity is lower than 5 cps, the formed toner may degrade in releasing ability. When the melt viscosity is higher than 1,000 cps, the hot offset resistance and the low-temperature fixability may not be improved.

The amount of the releasing agent contained in the toner is not particularly limited and may be appropriately selected depending on the intended purpose. The amount of the releasing agent is preferably 0% by mass to 40% by mass, more preferably 3% by mass to 30% by mass. When the amount is higher than 40% by mass, the formed toner may be degraded in flowability.

The releasing agent can be incorporated as desired into any of a first resin phase and a second resin phase (outer layer) by utilizing the difference in affinity to the two resins. By selectively incorporating the releasing agent into the second resin phase which is the outer layer of the toner, the releasing agent oozes out satisfactorily in a short heating time in the fixation and, consequently, satisfactory releasability can be realized.

On the other hand, by selectively incorporating the releasing agent into the first resin phase which is the inner layer, the spent of the releasing agent to other members such as the photoconductors and carriers can be suppressed.

### —Charge Controlling Agent—

The charge controlling agent is not particularly limited and may be appropriately selected from those known in the art. Examples thereof include nigrosine dyes, triphenylmethane dyes, chrome-containing metal complex dyes, molybdenum acid chelate pigments, rhodamine dyes, alkoxy amines, quaternary ammonium salts (including fluorine-modified quaternary ammonium salts), alkylamides, phosphorus, phosphorus compounds, tungsten, tungsten compounds, fluorine-based active agents, metal salts of salicylic acid, and metal salts of salicylic acid derivatives. These may be used alone or in combination.

Also, the charge controlling agent may be a commercially available product. The commercially available product may be, for example, resins or compounds each having an electron-donating property, azo dyes and metal complexes of organic acids. Specific examples thereof include BONTRON 03 (nigrosine dye), BONTRON P-51 (quaternary ammonium salt), BONTRON S-34 (metal azo-containing dye), E-82 (oxynaphthoic acid-based metal complex), E-84 (salicylic acid-based metal complex) and E-89 (phenol condensate) (these products are of ORIENT CHEMICAL INDUSTRIES CO., LTD); TN-105 (metal complex of salicylic acid) and TP-302 and TP-415 (quaternary ammonium salt molybdenum complex (these products are of Hodogaya Chemical Co.)); COPY CHARGE PSY VP 2038 (quaternary ammonium salt), COPY BLUE PR (triphenylmethane derivative), COPY CHARGE NEG VP2036 (quaternary ammonium salt) and COPY CHARGE NX VP434 (these products are of Hoechst AG); LRA-901 and LR-147 (boron complex) (these products are of Japan Carlit Co., Ltd.); copper phthalocyanine; perylene; quinacridone; azo pigments; and polymeric compounds having, as a functional group, a sulfonic acid group, carboxyl group, quaternary ammonium salt, etc.

The charge controlling agent can be incorporated into a resin phase inside the toner particles by utilizing the difference in affinity for the resin inside the toner particles. By selectively incorporating the charge controlling agent into the resin phase (inner layer) inside the toner particles, the spent of the charge controlling agent to other members such as the photoconductors and carriers can be suppressed.

### —Fine Inorganic Particles—

The fine inorganic particles are used as an external additive for imparting, for example, fluidity, developability and chargeability to the toner particles.

The fine inorganic particles are not particularly limited and may be appropriately selected depending on the intended purpose. Examples thereof include silica, alumina, titanium oxide, barium titanate, magnesium titanate, calcium titanate, strontium titanate, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide and silicon nitride. These inorganic microparticles may be used alone or in combination.

In addition to fine inorganic particles having a large particle diameter of 80 nm to 500 nm in terms of primary average particle diameter, fine inorganic particles having a small particle diameter can be preferably used as inorganic fine particles for assisting the fluidity, developability, and charging properties of the toner.

In particular, hydrophobic silica and hydrophobic titanium oxide are preferably used as the fine inorganic particles having a small particle diameter.

The primary average particle diameter of the fine inorganic particles is preferably 5 nm to 50 nm, more preferably 10 nm to 30 nm.

The BET specific surface area of the fine inorganic particles is preferably 20 m²/g to 500 m²/g.

The amount of the fine inorganic particles contained is preferably 0.01% by mass to 5% by mass, more preferably 0.01% by mass to 2.0% by mass.

### —Flowability Improver—

The flowability improver is an agent applying surface treatment to improve hydrophobic properties, and is capable of inhibiting the degradation of flowability or charging ability under high humidity environment. Specific examples of the flowability improver include silane coupling agents, silylation agents, silane coupling agents having a fluorinated alkyl group, organotitanate coupling agents, aluminum coupling agents, silicone oils, and modified silicone oils.

It is preferable that the silica and titanium oxide (fine inorganic particles) be subjected to surface treatment with such a flowability improver and used as hydrophobic silica and hydrophobic titanium oxide.

### —Cleanability Improver—

The cleanability improver is added to the toner to remove the developer remaining after transfer on a photoconductor or a primary transfer member.

Specific examples of the cleanability improver include metal salts of fatty acids such as stearic acid (e.g., zinc stearate and calcium stearate), fine polymer particles formed by soap-free emulsion polymerization, such as fine polymethylmethacrylate particles and fine polyethylene particles.

The fine polymer particles have preferably a relatively narrow particle size distribution. It is preferable that the volume average particle diameter thereof is 0.01 μm to 1 μm.

### —Magnetic Material—

The magnetic material is not particularly limited and may be appropriately selected from those known in the art depending on the intended purpose. Examples thereof include iron powder, magnetite and ferrite. Among them, one having a white color is preferable in terms of color tone.

### <Emulsion or Dispersion Liquid-Preparing Step>

The emulsion or dispersion liquid-preparing step is a step of adding the solution or dispersion liquid to an aqueous medium for emulsification or dispersion, to thereby prepare an emulsion or dispersion liquid.

The method for emulsifying or dispersing the solution or dispersion liquid of the toner material in an aqueous medium is not particularly limited and may be appropriately selected depending on the intended purpose. The solution or dispersion liquid is preferably dispersed in the aqueous medium with stirring.

The method for dispersing the solution or dispersion liquid is not particularly limited and may be appropriately selected depending on the intended purpose. For example, known dispersers may be used for dispersion.

The dispersers are not particularly limited, and examples thereof include low-speed shear dispersers and high-speed shear dispersers.

During the emulsification or dispersion, the active hydrogen group-containing compound and the polymer (prepolymer) reactive with the active hydrogen group-containing compound are subjected to elongation reaction or crosslinking reaction, to thereby form an adhesive base material (binder resin).

### —Aqueous Medium—

The aqueous medium is not particularly limited and may be appropriately selected from those known in the art. Examples thereof include water, water-miscible solvents and mixtures thereof. Among them, water is preferred.

The water-miscible solvent is not particularly limited, so long as it is miscible with water. Examples thereof include alcohols, dimethylformamide, tetrahydrofuran, cellsolves and lower ketones.

Examples of the alcohol include methanol, isopropanol and ethylene glycol.

Examples of the lower ketone include acetone and methyl ethyl ketone.

These may be used alone or in combination.

The aqueous medium used in the emulsion or dispersion liquid-preparing step B is not particularly limited and may be appropriately selected depending on the intended purpose. The aqueous medium preferably contains anionic fine resin particles and an anionic surfactant.

In this case, the aqueous medium is preferably prepared by, for example, dispersing the anionic fine resin particles in the aqueous medium in the presence of the anionic surfactant.

The amount of the anionic surfactant or the anionic fine resin particles in the aqueous medium is not particularly limited and may be appropriately selected depending on the intended purpose. The amount of each of the anionic surfactant and the anionic fine resin particles is preferably 0.5% by mass to 10% by mass.

### —Anionic Fine Resin Particles—

The anionic fine resin particles are attached onto the surface of the toner, and fused to and integrated with the surface of the toner to form a relatively hard surface. Since the anionic fine resin particles have anionic properties, the anionic fine resin particles can adsorb on the liquid droplets containing the toner material to suppress coalescence between the liquid droplets. This is important for regulating the particle size distribution of the toner. Further, the anionic fine resin particles can impart negative chargeability to the toner. In order to attain these effects, the anionic fine resin particles preferably have an average particle diameter 5 nm to 50 nm, more preferably 10 nm to 25 nm.

The average particle diameter is that of primary particles of anionic fine resin particles. The average particle diameter of the primary particles can be measured by, for example, SEM, TEM or a light scattering method. Specifically, LA-920 (product of HORIBA, Ltd.) based on a laser scattering method can be used for measurement so that the primary particles are diluted to a proper concentration at which the measured value falls within the measurement range.

The average particle diameter of the primary particles is determined in terms of volume average diameter.

The resin of the anionic fine resin particles is not particularly limited, as long as it can be dispersed in the aqueous medium to form an aqueous dispersion, and may be appropriately selected from those known in the art depending on the intended purpose.

The resin is not particularly limited and may be a thermoplastic or thermosetting resin. Examples thereof include vinyl resins, polyurethane resins, epoxy resins, polyester resins, polyamide resins, polyimide resins, silicon resins, phenol resins, melamine resins, urea resins, aniline resins, ionomer resins and polycarbonate resins. These may be used alone or in combination. Preferably, at least one selected from vinyl resins, polyurethane resins, epoxy resins and polyester resins is dispersed in the aqueous medium, from the viewpoint of easily preparing an aqueous dispersion containing spherical resin microparticles.

Notably, the vinyl resin is a homopolymer or copolymer of a vinyl monomer. Examples thereof include styrene-(meth)acrylate ester resins, styrene-butadiene copolymers, (meth)acrylic acid-acrylate ester polymers, styrene-acrylonitrile copolymers, styrene-maleic anhydride and styrene-(meth)acrylic acid copolymers.

The anionic fine resin particles must be anionic to avoid aggregation when used in combination with the above-described anionic surfactant.

The anionic fine resin particles can be prepared by using an anionic active agent in the below-described methods or by introducing into a resin an anionic group such as a carboxylic acid group and/or a sulfonic acid group.

The method for preparing the anionic fine resin particles is not particularly limited and may be appropriately selected depending on the intended purpose. Examples thereof include a method of polymerizing using a known polymerization method and a method of preparing an aqueous dispersion liquid of fine resin particles. Of these, the latter method is preferred.

The method of preparing the aqueous dispersion liquid of fine resin particles is preferably as follows, for example:

(1) a method in which an aqueous dispersion of resin microparticles (e.g., vinyl resin microparticles) is directly produced by subjecting a monomer (e.g., vinyl monomer) serving as a starting material to polymerization reaction with any one of the suspension polymerization method, the emulsification polymerization method, the seed polymerization method and the dispersion polymerization method;

(2) a method in which an aqueous dispersion of microparticles of poly added or condensed resins (e.g., polyester resins, polyurethane resins and epoxy resins) is produced by dispersing their precursor (e.g., monomer or oligomer) or a solution thereof in an aqueous medium in the presence of an appropriate dispersant and then curing the resultant dispersion with heating or through addition of a curing agent;

(3) a method in which an aqueous dispersion of microparticles of poly added or condensed resins (e.g., polyester resins, polyurethane resins and epoxy resins) is produced by dissolving an appropriate emulsifier in their precursor (e.g., monomer or oligomer) or a solution thereof (which is preferably a liquid or may be liquefied with heating) and then adding water the resultant mixture for phase inversion emulsification;

(4) a method in which a resin is prepared through polymerization reaction (e.g., addition polymerization, ring-opening polymerization, polyaddition, addition condensation or condensation polymerization); the thus-prepared resin is pulverized using a mechanically rotary pulverizer, a jet pulverizer, etc., and then classified; and the thus-formed resin microparticles are dispersed in water in the presence of an appropriate dispersant;

(5) a method in which a resin is prepared through polymerization reaction (e.g., addition polymerization, ring-opening polymerization, polyaddition, addition condensation or condensation polymerization); the thus-prepared resin is dissolved in a solvent to prepare a resin solution; the thus-prepared resin solution is sprayed to produce resin microparticles; and the thus-produced resin microparticles are dispersed in water in the presence of an appropriate dispersant;

(6) a method in which a resin is prepared through polymerization reaction (e.g., addition polymerization, ring-opening polymerization, polyaddition, addition condensation or condensation polymerization); the thus-prepared resin is dissolved in a solvent to prepare a resin solution, followed by addition of a bad solvent for precipitation, or the thus-prepared resin is dissolved with heating in a solvent to prepare a resin solution, followed by cooling for precipitation; the solvent is removed to produce resin microparticles; and the thus-produced resin microparticles are dispersed in water in the presence of an appropriate dispersant;

(7) a method in which a resin is prepared through polymerization reaction (e.g., addition polymerization, ring-opening polymerization, polyaddition, addition condensation or condensation polymerization); the thus-prepared resin is dissolved in a solvent to prepare a resin solution; the thus-prepared resin solution is dispersed in an aqueous medium in the presence of an appropriate dispersant; and the solvent is removed with heating or under reduced pressure; and

(8) a method in which a resin is prepared through polymerization reaction (e.g., addition polymerization, ring-opening polymerization, polyaddition, addition condensation or condensation polymerization); the thus-prepared resin is dissolved in a solvent to prepare a resin solution; an appropriate emulsifier is dissolved in the thus-prepared resin solution; and water is added to the resultant solution for phase inversion emulsification.

### —Anionic Surfactant—

The anionic surfactant is not particularly limited and may be appropriately selected depending on the intended purpose. Examples thereof include alkylbenzenesulfonic acid salts, α-olefin sulfonic acid salts and phosphoric acid esters, with anionic surfactants having a fluoroalkyl group being preferred. Examples thereof include fluoroalkyl carboxylic acids having 2 to 10 carbon atoms and metal salts thereof, disodium perfluorooctanesulfonylglutamate, sodium 3-[ω-fluoroalkyl(C6 to C11)oxy)-1-alkyl(C3 or C4) sulfonates, sodium 3-[ω-fluoroalkanoyl(C6 to C8)-N-ethylamino]-1-propanesulfonates, fluoroalkyl(C11 to C20) carboxylic acids and metal salts thereof, perfluoroalkylcarboxylic acids (C7 to C13) and metal salts thereof, perfluoroalkyl(C4 to C12)sulfonates and metal salts thereof, perfluorooctanesulfonic acid diethanol amide, N-propyl-N-(2-hydroxyethyl)perfluorooctanesulfone amide, perfluoroalkyl(C6 to C10)sulfoneamidepropyltrimethylammonium salts, salts of perfluoroalkyl(C6 to C10)-N-ethylsulfonylglycin, monoperfluoroalkyl(C6 to C16) ethylphosphates and sodium dodecyldiphenyl ether disulfonate.

Examples of commercially available products of the above-listed fluoroalkyl group-containing anionic surfactants include SURFLON S-111, S-112 and S-113 (these products are of Asahi Glass Co., Ltd.); FRORARD FC-93, FC-95, FC-98 and FC-129 (these products are of Sumitomo 3M Ltd.); UNIDYNE DS-101 and DS-102 (these products are of Daikin Industries, Ltd.); MEGAFACE F-110, F-120, F-113, F-191, F-812 and F-833 (these products are of Dainippon Ink and Chemicals, Inc.); ECTOP EF-102, 103, 104, 105, 112, 123A, 123B, 306A, 501, 201 and 204 (these products are of Tohchem Products Co., Ltd.); and FUTARGENT F-100 and F150 (these products are of NEOS COMPANY LIMITED).

In the toner obtained using the aqueous medium containing the anionic surfactant and the anionic fine resin particles having an average particle diameter of 5 nm to 50 nm, the anionic fine resin particles are attached onto the surfaces of the toner particles each containing as a nucleus the toner material including the colorant and the binder resin.

Notably, the average particle diameter of the toner is regulated by selecting proper emulsification or dispersion conditions such as stirring of the aqueous medium in the emulsion or dispersion liquid-preparing step.

The volume average particle diameter of the toner is not particularly limited but preferably 1 μm to 6 μm, more preferably 2 μm to 5 μm.

When the volume average particle diameter of the toner is less than 1 μm, toner dust is likely to be generated in the primary transfer and the secondary transfer. On the other hand, when the volume average particle diameter of the toner is more than 6 μm, the dot reproducibility is unsatisfactory and the granularity of a halftone part is also deteriorated, potentially making it impossible to form a high-definition image.

For the aqueous medium, the following inorganic dispersants and polymer protective colloid may be used in combination with the surfactant and the fine resin particles. Examples of the inorganic dispersants having poor water solubility include tricalcium phosphate, calcium carbonate, titanium oxide, colloidal silica, and hydroxyapatite.

The polymer protective colloid is not particularly limited. Examples thereof include acids, (meth)acrylic monomers having a hydroxyl group, vinyl alcohols or ethers of vinyl alcohols, esters of vinyl alcohol and compounds having a carboxyl group, amide compounds or methylol compounds thereof, chlorides, homopolymers or copolymers of a compound containing a nitrogen atom or a nitrogen-containing heterocyclic ring, polyoxyethylene, and celluloses.

Examples of the acids include acrylic acid, methacrylic acid, α-cyanoacrylic acid, α-cyanomethacrylic acid, itaconic acid, crotonic acid, fumaric acid, maleic acid, and maleic anhydride.

Examples of the (meth)acrylic monomers having a hydroxyl group include β-hydroxyethyl acrylate, β-hydroxylethyl methacrylate, β-hydroxylpropyl acrylate, β-hydroxylpropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin monoacrylate, glycerin monomethacrylate, N-methylolacrylamide, and N-methylolmethacrylamide.

Examples of the vinyl alcohols or ethers of vinyl alcohols include vinyl methyl ether, vinyl ethyl ether, and vinyl propyl ether.

Examples of the esters of vinyl alcohols and compounds having a carboxyl group include vinyl acetate, vinyl propionate, and vinyl butyrate.

Examples of the amide compounds or methylol compounds thereof include acryl amide, methacryl amide, diacetone acryl amide acid, and methylol compounds thereof.

Examples of the chlorides include acrylic acid chloride, methacrylic acid.

Examples of the homopolymers or copolymers of a compound containing a nitrogen atom or a nitrogen-containing heterocyclic ring include vinyl pyridine, vinyl pyrrolidone, vinyl imidazole, and ethylene imine.

Examples of the polyoxy ethylene include polyoxyethylene, polyoxypropylene, polyoxyethylene alkylamine, polyoxypropylene alkylamine, polyoxyethylene alkylamide, polyoxypropylene alkylamide, polyoxyethylene nonylphenylether, polyoxyethylene laurylphenylether, polyoxyethylene stearylphenylester, and polyoxyethylene nonylphenylester.

Examples of the cellulose include methyl cellulose, hydroxyethyl cellulose, and hydroxypropyl cellulose.

When a dispersion stabilizer soluble in an acid or alkali (e.g., calcium phosphate) is used, the calcium phosphate can be removed from the particles by dissolving it with an acid such as hydrochloric acid, followed by washing with water; or by enzymatically decomposing it.

### <Organic Solvent-Removing Step>

The organic solvent-removing step is a step of removing the organic solvent from the emulsion or dispersion liquid (emulsified slurry).

The method for removing the organic solvent is not particularly limited and may be appropriately selected depending on the intended purpose. For example, the removal of the organic solvent is performed as follows: (1) the entire reaction system is gradually increased in temperature to completely evaporate the organic solvent contained in oil droplets; or (2) the emulsified dispersion is sprayed in a dry atmosphere to completely remove/evaporate the water insoluble organic solvent contained in oil droplets together with the aqueous dispersant, whereby fine toner particles are formed.

The thus-formed toner particles are subjected to washing, drying, etc., and then, if necessary, to classification, etc. Classification is performed by removing very fine particles using a cyclone, a decanter, a centrifugal separator, etc. in the liquid.

Alternatively, after drying, the formed powdery toner particles may be classified.

The toner particles produced through the above-described steps may be mixed with, for example, a colorant, a releasing agent and a charge controlling agent, or a mechanical impact may be applied to the resultant mixture (toner particles) for preventing the releasing agent, etc. from dropping off the surface of the toner particles.

Examples of the method for applying a mechanical impact include a method in which an impact is applied to a mixture using a high-speed rotating blade; and a method in which a mixture is caused to pass through a high-speed airflow to form aggregated particles, followed by crushing against an appropriate collision plate.

Examples of apparatuses used in these methods include Ongmill (product of Hosokawa Micron K.K.), an apparatus produced by modifying an I-type mill (product of Nippon Neumatic Co., Ltd.) so that the pulverizing air pressure thereof is decreased, Hybridization System (product of Nara Machinery Co., Ltd.), Cryptron System (production of Kawasaki Heavy Industries, Ltd.) and an automatic mortar.

### <Characteristics of Toner>

The toner produced through the above steps has the following characteristics.

The average circularity of the toner is not particularly limited, so long as it is 0.950 to 0.990, and may be appropriately selected depending on the intended purpose.

When the average circularity of the toner is less than 0.950, evenness of an image in the development is deteriorated, or the efficiency of transfer of the toner from the electrophotographic photoconductor to the intermediate transfer member or from the intermediate transfer member to the recording medium may be lowered. Consequently, even transfer cannot be realized. When the average circularity of the toner is more than 0.990, the toner particles run through the cleaning blade, potentially causing cleaning failures.

According to the production process of the present invention, the toner is produced by emulsification treatment in the aqueous medium. This process is effective in reducing the particle diameter of the color toner and in realizing a toner shape having an average circularity in the above-defined range.

The average circularity of the toner is defined by the following equation.

Average circularity X=(Circumferential length of a circle having the same area as projected particle area/Circumferential length of projected particle image)×100(%)

The average circularity of the toner is measured using a flow-type particle image analyzer (“FPIA-2100,” product of Sysmex Co.), and analyzed using an analysis software (FPIA-2100 Data Processing Program For FPIA Version00-10). Specifically, into a 100 mL glass beaker, 0.1 mL to 0.5 mL of a 10% by mass surfactant (NEOGEN SC-A, which is an alkylbenzene sulfonate, product of Dai-ichi Kogyo Seiyaku Co., Ltd.) is added, 0.1 g to 0.5 g of the toner is added, the ingredients are stirred using a microspatula, then 80 mL of ion-exchanged water is added. The obtained dispersion liquid is subjected to dispersion treatment for 3 min using an ultrasonic wave dispersing device (manufactured by Honda Electronics Co.). Using FPIA-2100 mentioned above, the shape and distribution of toner particles are measured until the dispersion liquid has a concentration of 5,000 (number per μL) to 15,000 (number per μL).

In this measuring method, it is important in terms of reproducibility in measuring the average circularity that the above-mentioned dispersion liquid concentration is kept in the range of 5,000 number per μL to 15,000 number per μL.

To obtain the above-mentioned dispersion liquid concentration, it is necessary to change the conditions of the dispersion liquid, namely the amount of the surfactant added and the amount of the toner. The required amount of the surfactant varies depending on the hydrophobicity of the toner. When the surfactant is added in large amounts, noise is caused by foaming. When the surfactant is added in small amounts, the toner cannot be sufficiently wetted, leading to insufficient dispersion.

Also, the amount of the toner added varies depending on its particle diameter. When the toner has a small particle diameter, it needs to be added in small amounts. When the toner has a large particle diameter, it needs to be added in large amounts. In the case where the toner particle diameter is 3 μm to 7 μm, the dispersion liquid concentration can be adjusted to the range of 5,000 (number per μL) to 15,000 (number per μL) by adding 0.1 g to 0.5 g of the toner.

The charge amount of the toner is preferably 10 μC/g to 80 μC/g as charge amount Q (absolute value) obtained when the toner particles (7% by mass) and carrier particles are mixed together for 15 sec and 600 sec.

When the charge amount Q (absolute value) is less than 10 μC/g, the attractive force becomes low between the toner particles and carrier particles. In this case, a larger amount of the toner is used for development even in a low developing field. As a result, high-quality images with gradation may not be obtained. In addition, the amount of the toner having the opposite polarity increases, which may degrade image quality due to, for example, fogging since a larger amount of the toner is used for development of the white background. When the charge amount Q (absolute value) is higher than 80 μC/g, the attractive force becomes high between the toner particles and magnetic carrier particles. In this case, a smaller amount of the toner is used for development, which may lead to degradation in image quality.

The charge amount of the toner is measured with a V blow-off device (product of RICOH SOZO KAIHATU K.K.). The toner and the carrier are allowed to stand as a developer having a toner concentration of 7% by mass at 40° C. and 70% RH for 2 hr. The developer is then placed in a metallic gauge, followed by mixing with stirring in a stirring device at 285 rpm for 60 sec or 600 sec. One gram of the developer was weighed from 6 g of the initial developer, and the charge amount distribution of the toner is measured by a single mode method with a V blow-off device (product of RICOH SOZO KAIHATU K.K.). At the time of blow, an opening of 635 mesh is used. In the single mode method of the V blow-off device (product of RICOH SOZO KAIHATU K.K.), a single mode is selected according to the instruction manual, and measurement is performed under conditions of height 5 mm, suction 100, and blow twice.

The ratio of the volume average particle diameter (Dv) to the number average particle diameter (Dn), i.e., Dv/Dn, in the toner is not particularly limited and may be appropriately selected depending on the intended purpose. The ratio Dv/Dn is preferably 1.25 or less, more preferably 1.05 to 1.25. When the ratio Dv/Dn is less than 1.05, the following problems occur. Specifically, for a two-component developer, in stirring for a long period of time in a developing device, the toner is fused to the surface of the carrier, possibly leading to lowered charging ability of the carrier and deteriorated cleanability. For a one-component developer, filming of the toner on the developing roller and the fusion of the toner on a member such as a blade, which is used for forming a thin layer of the toner, are likely to occur. On the other hand, when the ratio Dv/Dn exceeds 1.25, high-quality images with a high resolution cannot be formed without difficulties. In this case, when the toner is introduced and consumed in a developer, a fluctuation in particle diameter of the toner may be increased. Also, the distribution of the charge amount of the toner is broadened, making it difficult to obtain a high-quality image.

When the ratio Dv/Dn is 1.25 or lower, the distribution of the charge amount becomes uniform, which reduces fogging on the background.

When the ratio Dv/Dn is 1.05 to 1.25, the resultant toner is excellent in all of storage stability, low-temperature fixability, and hot offset resistance. In particular, when the toner is used in a full color copier, the gloss of images is excellent. In the two-component developer, even when the toner is introduced and consumed for a long period of time, no significant fluctuation in toner particle diameter within the developer occurs and, consequently, good, stable developing properties can be obtained even after long-term stirring in the developing device. For the one-component developer, even when the toner is introduced and consumed, a fluctuation in particle diameter of the toner can be reduced. Further, filming of the toner on the developing roller and the fusion of the toner on a member such as a blade, which is used for forming a thin layer of the toner, do not occur. Accordingly, when the developing device is used (stirred) for a long period of time, good, stable developing properties can be obtained and, consequently, high-quality images can be formed.

The volume average particle diameter (Dv) and the number average particle diameter (Dn) of the toner can be measured as follows.

Specifically, using a particle size analyzer (“Multisizer III,” product of Beckman Coulter Co.) with the aperture diameter being set to 100 μm, and the obtained measurements are analyzed with an analysis software (Beckman Coulter Multisizer 3 Version 3.51). More specifically, a 10% by mass surfactant (alkylbenzene sulfonate, Neogen SC-A, product of Daiichi Kogyo Seiyaku Co.) (0.5 mL) is added to a 100 mL-glass beaker, and a toner sample (0.5 g) is added thereto, followed by stirring with a microspartel. Subsequently, ion-exchange water (80 mL) is added to the beaker, and the obtained dispersion liquid is dispersed with an ultrasonic wave disperser (W-113MK-II product of Honda Electronics Co.) for 10 min. The resultant dispersion liquid is measured using the above Multisizer III and Isoton III (product of Beckman Coulter Co.) serving as a solution for measurement.

The dispersion liquid containing the toner sample is dropped so that the concentration indicated by the meter falls within a range of 8%±2%. Notably, in this method, it is important that the concentration is adjusted to 8%±2%, considering attaining measurement reproducibility with respect to the particle diameter of the toner. No measurement error is observed, as long as the concentration falls within the above range.

The BET specific surface area of the toner is preferably 0.5 m²/g to 4.0 m²/g, more preferably 0.5 m²/g to 2.0 m²/g.

When the BET specific surface area is smaller than 0.5 m²/g, the toner particles are covered densely with the fine resin particles, which impair the adhesion between a recording paper and the binder resin inside the toner particles. As a result, the minimum fixing temperature is elevated. In addition, the fine resin particles prevent wax from oozing out, resulting in that the releasing effect of the wax cannot be obtained to cause offset. When the BET specific surface area of the toner exceeds 4.0 m²/g, fine organic particles remaining on the toner surface considerably project as protrusions. The fine resin particles remain as coarse multilayers and impair the adhesion between a recording paper and the binder resin inside the toner particles. As a result, the minimum fixing temperature is elevated. In addition, the fine resin particles prevent wax from oozing out, resulting in that the releasing effect of the wax cannot be obtained to cause offset. Furthermore, the additives protrude to form irregularities in the toner surface, which easily affects the image quality.

The common logarithmic value Log ρ of the volume specific resistance ρ (Ωcm) of the toner is preferably 10.9 Log Ωcm to 11.4 Log Ωcm. When the common logarithmic value Log ρ of the volume specific resistance ρ (Ωcm) of the toner is smaller than 10.9 Log Ωcm, the conductivity becomes higher to cause charging failures. As a result, background smear, toner scattering, etc. tend to increasingly occur. When it is greater than 11.4 Log Ωcm, the resistance becomes higher to increase the charge amount, resulting in that the image density may be decreased.

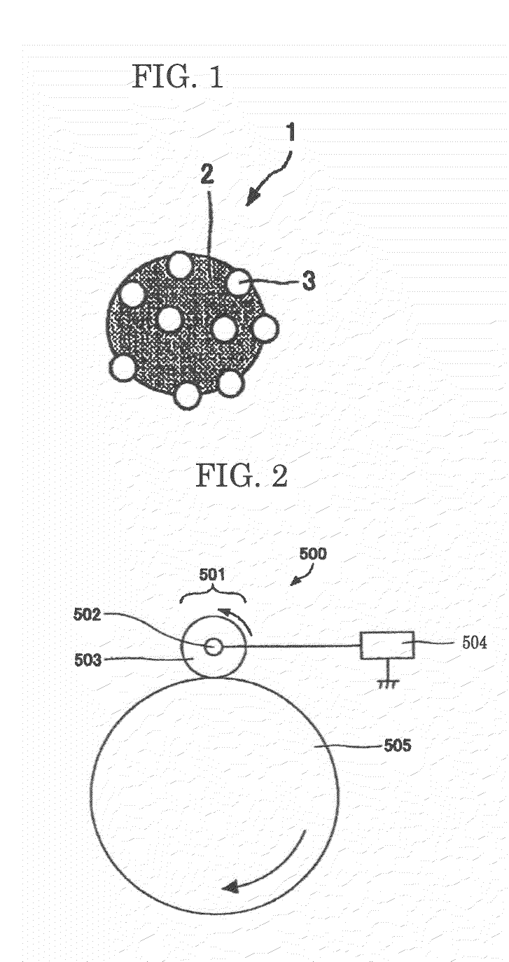

FIG. 1 schematically illustrates the structure of a toner of the present invention. As illustrated in FIG. 1, a toner particle 1 contains a base particle 2 and external additives 3. Here, the base particle is made of the toner material and the external additives which promote flowability, developability and chargeability of the (colored) toner particle. The external additives 3 are attached onto the uppermost surface of the base particle 2. Notably, the structure of the toner particle is not limited to that illustrated in FIG. 1. For example, a deforming agent may be used to deform the structure of the toner particle.

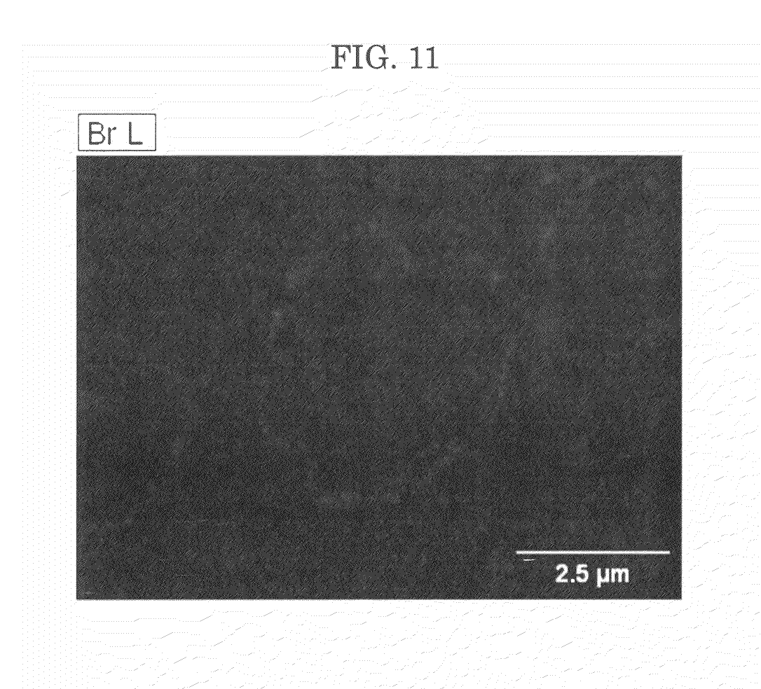

Also, FIG. 11 is a TEM image of the structure of the toner. The ring-shaped, discolored line in the vicinity of the toner surface indicates the presence of the calixarene derivative. The calixarene derivative is internally added to the toner so that it is localized in the vicinity of the toner surface.

### <Developer>

The toner can be used together with a carrier to form a two-component developer.

The weight average particle diameter of the carrier is not particularly limited but is preferably 15 μm to 40 μm.

When the weight average particle diameter is smaller than 15 μm, carrier adhesion, which is a phenomenon that the carrier is also disadvantageously transferred in the step of transfer, is likely to occur. When the weight average particle diameter is larger than 40 μm, the carrier adherence is less likely to occur. In this case, however, when the toner density is increased to provide a high image density, there is a possibility that background smear is likely to occur. Further, when the dot diameter of the latent image is small, variation in dot reproducibility is so large that the granularity in highlight parts is likely to be deteriorated.

The developer is not particularly limited, so long as it contains the toner, and may be appropriately selected depending on the intended purpose. The developer may contain further carrier components. Examples of the developer include a one-component developer consisting of the toner and a two-component developer containing the toner and the carrier.

For high-speed printers responding to the recent increase in information processing speed, the two-component developer is preferably used from the viewpoint of, for example, elongating the service life. Such developer can be used in, for example, various known electrophotographic methods such as magnetic one-component developing methods, non-magnetic one-component methods and two-component developing methods. For the one-component developer, even when the toner is introduced and consumed, a fluctuation in particle diameter of the toner can be reduced. Further, filming of the toner on the developing roller and the fusion of the toner on a member such as a blade, which is used for forming a thin layer of the toner, do not occur. Accordingly, when the developing device is used (stirred) for a long period of time, good, stable developing properties can be obtained and, consequently, high-quality images can be formed. In the two-component developer, even when the toner is introduced and consumed for a long period of time, no significant fluctuation in toner particle diameter within the developer occurs and, consequently, good, stable developing properties can be obtained even after long-term stirring in the developing device.

The amount of the carrier contained in the two-component developer is not particularly limited and may be appropriately selected depending on the intended purpose. The amount of the carrier is preferably 90% by mass to 98% by mass, more preferably 93% by mass to 97% by mass. When the amount of the carrier falls within the above more preferable range, it is advantageous that development can be stably performed.

The carrier is not particularly limited and may be appropriately selected depending on the intended purpose. The carrier preferably has a core material and a resin layer coating the core material.

The material of the core material is not particularly limited and may be appropriately selected depending on the intended purpose. For example, it is preferable to employ manganese-strontium (Mn—Sr) materials or manganese-magnesium (Mn—Mg) materials (50 emu/g to 90 emu/g). These materials may be used alone or in combination. Further, it is preferably to employ high magnetization materials such as iron powder (100 emu/g or more) or magnetite (75 emu/g to 120 emu/g) for the purpose of securing image density. Moreover, it is preferably to employ low magnetization materials such as copper-zinc (Cu—Zn) with 30 emu/g to 80 emu/g because the impact toward the photoconductor having a toner in the form of magnetic brush can be relieved and because it is advantageous for higher image quality.

The volume-average particle diameter of the core material is not particularly limited and may be appropriately selected depending on the intended purpose. It is preferably 10 μm to 150 μm, more preferably 20 μm to 80 μm.

When the volume average particle diameter is less than 10 μm, the amount of fine powder increases in the particle size distribution of the carrier, whereas magnetization per particle decreases and carrier scattering may occur. When the volume average particle diameter is greater than 150 μm, the specific surface area of the carrier decreases and thus toner scattering may occur. As a result, in the case of printing a full-color image having many solid portions, especially the reproduction of the solid portions may decrease.

When the amount of the carrier falls within the above more preferable range, it is advantageous that development can be stably performed.

The material of the resin layer is not particularly limited and may be appropriately selected depending on the intended purpose. Examples thereof include amino resins, polyvinyl resins, polystyrene resins, halogenated polyolefin resins, polyester resins, polycarbonate resins, polyethylene resins, polyvinyl fluoride resins, polyvinylidene fluoride resins, polytrifluoroethylene resins, polyhexafluoropropylene resins, copolymers of vinylidene fluoride and acrylic monomer, copolymers of vinylidene fluoride and vinyl fluoride, fluoroterpolymers such as terpolymers of tetrafluoroethylene, vinylidene fluoride and monomer having no fluorine-containing group, and silicone resins. These may be used alone or in combination.

The amino resins are not particularly limited and may be appropriately selected depending on the intended purpose. Examples thereof include urea-formaldehyde resins, melamine resins, benzoguanamine resins, urea resins, polyamide resins and epoxy resins.

The polyvinyl resins are not particularly limited and may be appropriately selected depending on the intended purpose. Examples thereof include acrylic resins, polymethyl methacrylate, polyacrylonitrile, polyvinyl acetate, polyvinyl alcohol and polyvinyl butyral.

The polystyrene resins are not particularly limited and may be appropriately selected depending on the intended purpose. Examples thereof include polystyrene and styrene-acrylic copolymers.

The halogenated polyolefins are not particularly limited and may be appropriately selected depending on the intended purpose. Examples thereof include polyvinyl chloride.

The polyester resins are not particularly limited and may be appropriately selected depending on the intended purpose. Examples thereof include polyethylene terephtalate and polybutylene terephtalate.

The resin layer may contain, for example, conductive powder as necessary.

The conductive powder is not particularly limited and may be appropriately selected depending on the intended purpose. Examples thereof include metal powder, carbon black, titanium oxide, tin oxide, and zinc oxide.

The average particle diameter of the conductive powder is not particularly limited and may be appropriately selected depending on the intended purpose. It is preferably 1 μm or less. When the average particle diameter is greater than 1 μm, it may be difficult to control the electrical resistance.

The resin layer may be formed by uniformly coating a surface of the core material with a coating solution obtained by dissolving a silicone resin or the like in a solvent, by a known coating method, followed by drying and baking.

The coating method is not particularly limited and may be appropriately selected depending on the intended purpose. Examples thereof include dipping, spraying, and brushing.

The solvent is not particularly limited and may be appropriately selected depending on the intended purpose. Examples thereof include toluene, xylene, methyl ethyl ketone, methyl isobutyl ketone, cellosolve, and butyl acetate.

The baking method is not particularly limited and may be appropriately selected depending on the intended purpose. It may be external heating or internal heating. Examples of the baking method include methods using fixed electric furnace, fluid electric furnace, rotary electric furnace, or burner furnace, and methods using microwaves.

The amount of the resin layer in the carrier is not particularly limited and may be appropriately selected depending on the intended purpose. It is preferably 0.01% by mass to 5.0% by mass.

When the amount is less than 0.01% by mass, the resin layer may not be uniformly formed over the surface of the core material. When the amount is more than 5.0% by mass, the resin layer becomes so thick that fusing of carrier particles occurs and thus equally-sized carrier particles may not be obtained.

The characteristics of the carrier can be measured with the following methods.

### <Weight Average Particle Diameter>

The weight average particle diameter Dw of the carrier is calculated on the basis of the particle size distribution of the particles measured on a number basis; i.e., the relation between the number based frequency and the particle diameter. In this case, the weight average particle diameter Dw is expressed by Equation (1);

Dw={1/Σ(nD³)}×{Σ(nD⁴)} Equation (1)

where D represents a typical particle diameter (μm) of particles present in each channel, and “n” represents the total number of particles present in each channel. It should be noted that each channel is a length for equally dividing the range of particle diameters in the particle size distribution chart, and 2 μm can be employed for each channel in the present invention. For the typical particle diameter of particles present in each channel, the lower limit value of particle diameters of the respective channels can be employed.

In addition, the number average particle diameter Dp of the carrier or the core material particles are calculated on the basis of the particle diameter distribution measured on a number basis. The number average particle diameter Dp is expressed by Equation (2):

Dp=(1/ΣN)×{ΣnD} Equation (2)

where N represents the total number of particles measured, “n” represents the total number of particles present in each channel and D represents the minimum particle diameter of the particles present in each channel (2 μm).

For a particle size analyzer used for measuring the particle size distribution, a micro track particle size analyzer (Model HRA9320-X100, product of Honewell Co.) may be used. The evaluation conditions are as follows.

(1) Scope of particle diameters: 8 μm to 100 μm
(2) Channel length (width): 2 μm
(3) Number of channels: 46
(4) Refraction index: 2.42

### (Image Forming Method)

The image forming method of the present invention includes a charging step of charging an electrophotographic photoconductor, an exposing step of forming a latent electrostatic image on the charged electrophotographic photoconductor, a developing step of developing the latent electrostatic image with the toner of the present invention so as to form a toner image, a primary transfer step of primarily transferring the toner image formed on the electrophotographic photoconductor onto an intermediate transfer member, a secondary transfer step of secondarily transferring the toner image, which has been transferred onto the intermediate transfer member, onto a recording medium, a fixing step of fixing the toner image on the recording medium by a fixing unit including a heat and pressure-applying member, and a cleaning step of removing toner remaining after transfer and adhered onto the surface of the electrophotographic photoconductor, from which the toner image has been transferred onto the intermediate transfer member by the primary transfer unit.

The image forming method is not particularly limited and may be appropriately selected depending on the intended purpose. Preferably, it is suitably used for forming a full-color image.

In the secondary transfer step, the linear velocity of transfer of the toner image onto the recording medium (so-called printing speed) is not particularly limited and may be appropriately selected depending on the intended purpose. It is preferably 300 mm/sec to 1,000 mm/sec. Also, the transfer time in the secondary transfer step is preferably 0.5 msec to 20 msec. Notably, the transfer time is a transfer time required for the transfer in the nip part between transfer rollers.

As described above, the image forming method is not particularly limited and may be appropriately selected depending on the intended purpose. It is preferably of a tandem type where an image forming process including the charging step, the exposing step, the developing step, the primary transfer step, the secondary transfer step and the cleaning step is simultaneously performed in parallel per image formation.

In the tandem type, a plurality of electrophotographic photoconductors are provided, and development is performed one color by one color upon each rotation.

According to the tandem-type image forming process, the charging step, the exposing step, the developing step and the transfer step are performed for each color to form each color toner image. Accordingly, the difference in speed between single color image formation and full color image formation is so small that the tandem type can advantageously cope with high-speed printing.

In general, in the tandem-type image forming process, the color toner images are formed on respective separate electrophotographic photoconductors, and the color toner layers are stacked (color superimposition) to form a full color image. Accordingly, when a variation in properties such as a difference in charging characteristics between color toner particles exists, a difference in amount of the developing toner occurs between the respective color toner particles. As a result, a change in hue of secondary color by color superimposition is increased, and the color reproducibility may be lowered. The toner used in the image forming method of the tandem type should satisfy the requirements that the amount of the developing toner for regulating the balance of the colors is stabilized (no variation in developing toner amount between respective color toner particles), and the adherence to the electrophotographic photoconductor and to the recording medium is uniform between the respective color toner particles.

In this respect, use of the toner of the present invention in the developing step allows the tandem-type image forming method to exhibit its advantages, since the toner has uniform charging properties, no variation in respective toner particles, and uniform adherence to the electrophotographic photoconductor and to the recording medium between the respective color toner particles.

The charging step is not particularly limited but the charging unit preferably applies at least a direct current voltage obtained by superimposing alternating voltages. The application of the direct current voltage obtained by superimposing the alternating voltages can stabilize the surface voltage of the electrophotographic photoconductor to a desired value as compared with the application of only a direct current voltage. Accordingly, further even charging can be realized.

The charging step is not particularly limited but the charging unit preferably performs charging by bringing a charging member into contact with the electrophotographic photoconductor and applying the voltage to the charging member. When charging is carried out by bringing the charging member into contact with the electrophotographic photoconductor and applying the voltage to the charging member, the effect of even charging properties attained by applying the direct current voltage obtained by superimposing alternating voltages can be particularly improved.

The fixing step is not particularly limited but is preferably performed a fixing unit including a heating roller that is formed of a magnetic metal and is heated by electromagnetic induction; a fixation roller disposed parallel to the heating roller; an endless belt-like toner heating medium (a heating belt) that is taken across the heating roller and the fixation roller, is heated by a heating roller, and is rotated by these rollers; and a pressure roller that is brought into pressure contact with the fixation roller through the heating belt and is rotated in a forward direction relative to the heating belt to form a fixation nip part. The fixing step can realize a temperature rise in the fixation belt in a short time and can realize stable temperature control. Further, even when a recording medium having a rough surface is used, during the fixation, the fixation belt acts in conformity to the surface of the transfer paper to some extent and, consequently, satisfactory fixability can be realized.

The fixing unit is not particularly limited but is preferably of an oil-less type or a minimal oil-coated fixing type. To this end, preferably, the toner particles to be fixed contain a releasing agent (wax) in a finely dispersed state in the toner particles. In the toner in which a releasing agent is finely dispersed in the toner particle, the releasing agent is likely to ooze out during fixation. Accordingly, in the oil-less fixing device or even when an oil coating effect has becomes unsatisfactory in the minimal oil-coated fixing device, the transfer of the toner to the belt can be suppressed.

In order that the releasing agent is present in a dispersed state in the toner particle, preferably, the releasing agent and the binder resin are not compatible with each other. The releasing agent can be finely dispersed in the toner particle, for example, by taking advantage of the shear force of kneading in the production of the toner. Whether the releasing agent is in a dispersed state can be determined by observing a thin film section of the toner particle under a TEM. The dispersion diameter of the releasing agent is not particularly limited but is preferably small. However, when the dispersion diameter is excessively small, oozing during the fixation is sometimes unsatisfactory. Accordingly, when the releasing agent can be observed at a magnification of 10,000 times, it can be determined that the releasing agent is present in a dispersed state. When the releasing agent is so small that the releasing agent cannot be observed at a magnification of 10,000 times, oozing of the releasing agent during the fixation is sometimes unsatisfactory even when the releasing agent is finely dispersed in the toner particle.

Referring now to the drawings, each of the steps of the image forming method will be described in detail together with the unit used for the step.

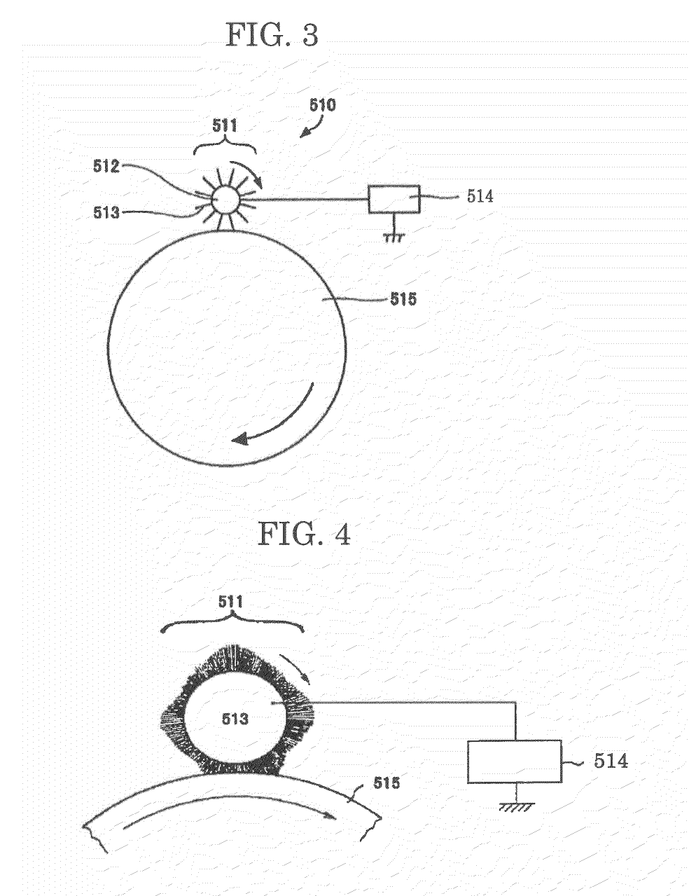

The charging device usable in the charging step may be, for example, a roller-type charging device illustrated in FIG. 2 and a fur brush-type charging device illustrated in FIG. 3.

FIG. 2 is a schematic configuration of an example of a roller-type charging device 500 which is one type of contact charging devices. A photoconductor 505 to be charged as an image bearing member is rotated at a predetermined speed (process speed) in the direction indicated by the arrow. A charging roller 501 serving as a charging unit, which is brought into contact with the photoconductor 505, contains a metal core 502 and a conductive rubber layer 503 formed on the outer surface of the metal core in a shape of a concentric circle. The both terminals of the metal core 502 are supported with bearings (not illustrated) so that the charging roller enables to rotate freely, and the charging roller is pressed against the photoconductor drum at a predetermined pressure by a pressurizing unit (not illustrated). The charging roller 501 in FIG. 2 therefore rotates along with the rotation of the photoconductor 505. The charging roller 501 is generally formed with a diameter of 16 mm in which a metal core having a diameter of 9 mm is coated with a rubber layer 503 having a moderate resistance of approximately 100,000 Ω·cm. The power supply 504 illustrated in the figure is electrically connected to the metal core 502 of the charging roller 501, and a predetermined bias is applied to the charging roller 501 by the power supply 504. Thus, the surface of the photoconductor 505 is uniformly charged at a predetermined polarity and potential.

In addition to the roller-type charging device, the charging device may be, for example, a magnetic brush charging device or a fur brush charging device. It may be suitably selected according to a specification or configuration of an electrophotographic apparatus. When a magnetic brush is used as the charging device, the magnetic brush includes a charging member formed of various ferrite particles such as Zn—Cu ferrite, a non-magnetic conductive sleeve to support the ferrite particles, and a magnetic roller included in the non-magnetic conductive sleeve. Moreover, a material of the fur brush is, for example, a fur treated to be conductive with, for example, carbon, copper sulfide, a metal or a metal oxide, and the fur is coiled or mounted to a metal or another metal core which is treated to be conductive, thereby obtaining the charging device.

FIG. 3 is a schematic configuration of one example of a contact brush charging device 510. A photoconductor 515 to be charged (image bearing member) is rotated at a predetermined speed (process speed) in the direction indicated by the arrow. The fur brush roller 511 having a fur brush is brought in contact with the photoconductor 515, with a predetermined nip width and a predetermined pressure with respect to elasticity of a brush part 513.

The fur brush roller 511 as the contact charging device has an outer diameter of 14 mm and a longitudinal length of 250 mm. In this fur brush, a tape with a pile of conductive rayon fiber REC-B (available from Unitika Ltd.), as a brush part 513, is spirally coiled around a metal core 512 having a diameter of 6 mm, which serves also as an electrode. A brush of the brush part 513 is of 300 denier/50 filament, and a density of 155 fibers per 1 square millimeter. This role brush is once inserted into a pipe having an internal diameter of 12 mm with rotating in a certain direction, and is set so as to be a concentric circle relative to the pipe. Thereafter, the role brush in the pipe is left in an atmosphere of high humidity and high temperature so as to twist the fibers of the fur.

The resistance of the fur brush roller 511 is 1×10⁵Ω at an applied voltage of 100 V. This resistance is calculated from the current obtained when the fur brush roller is contacted with a metal drum having a diameter of 30 mm with a nip width of 3 mm, and a voltage of 100 V is applied thereon. The resistance of the brush charging device 510 should be 10⁴Ω or more in order to prevent image defect caused by an insufficient charge at the charging nip part when the photoconductor 515 to be charged happens to have low electric strength defects such as pin holes thereon and an excessive leak current therefore runs into the defects. Moreover, it should be 10⁷Ω or less in order to sufficiently charge the surface of the photoconductor 515.

Examples of the material of the fur include, in addition to REC-B (available from Unitika Ltd.), REC-C, REC-M1, REC-M10 (available from Unitika Ltd.), SA-7 (available from Toray Industries, Inc.), THUNDERON (available from Nihon Sanmo Dyeing Co., Ltd.), BELTRON (available from Kanebo Gohsen, Ltd.), KURACARBO in which carbon is dispersed in rayon (available from Kuraray Co., Ltd.), and ROVAL (available from Mitsubishi Rayon Co., Ltd.). The brush is of preferably 3 denier to 10 denier per fiber, 10 filaments to 100 filaments per bundle, and 80 fibers to 600 fibers per square millimeter. The length of the fur is preferably 1 mm to 10 mm.

The fur brush roller 511 is rotated in the opposite (counter) direction to the rotation direction of the photoconductor 515 at a predetermined peripheral velocity, and comes into contact with a surface of the photoconductor with a velocity deference. The power supply 514 applies a predetermined charging voltage to the fur brush roller 511 so that the surface of the photoconductor is uniformly charged at a predetermined polarity and potential.

In contact charge of the photoconductor 515 by the fur brush roller 511, charges are mainly directly injected and the surface of the photoconductor is charged at the substantially equal voltage to the applying charging voltage to the fur brush roller 511.

The charging member is not specifically limited in its shape and may be in any shape such as a charging roller or a fur blush, as well as the fur blush roller 511. The shape can be selected according to the specification and configuration of the image forming apparatus. When a charging roller is used, it generally includes a metal core and a rubber layer having a moderate resistance of about 100,000 Ω·cm coated on the metal core. When a magnetic fur blush is used, it generally includes a charging member formed of various ferrite particles such as Zn—Cu ferrite, a non-magnetic conductive sleeve to support the ferrite particles, and a magnet roll included in the non-magnetic conductive sleeve.

FIG. 4 illustrates a schematic configuration of one example of a magnetic brush charging device. The photoconductor 515 to be charged (image bearing member) is rotated at a predetermined speed (process speed) in the direction indicated by the arrow. The brush roller 511 having a magnetic brush is brought in contact with the photoconductor 515, with a predetermined nip width and a predetermined pressure with respect to elasticity of the brush part 513.

The magnetic brush as the contact charging member is formed of magnetic particles. For the magnetic particles, Zn—Cu ferrite particles having an average particle diameter of 25 μm and Zn—Cu ferrite particles having an average particle diameter of 10 μm are mixed together in a ratio by mass of 1:0.05, to thereby form magnetic particles having peaks at each average particle diameter and being obtained by coating the ferrite particles having an average particle diameter of 25 μm with a resin layer having a moderate resistance.

The contact charging member is formed of the aforementioned coated magnetic particles, a non-magnetic conductive sleeve which supports the coated magnetic particles, and a magnet roller which is included in the non-magnetic conductive sleeve. The coated magnetic particles are disposed on the sleeve with a thickness of 1 mm so as to form a charging nip of about 5 mm-wide with the photoconductor. The width between the non-magnetic conductive sleeve and the photoconductor is adjusted to approximately 500 μm. The magnetic roller is rotated so as to subject the non-magnetic conductive sleeve to rotate at twice in speed relative to the peripheral speed of the surface of the photoconductor, and in the opposite direction with the photoconductor. Therefore, the magnetic brush is uniformly in contact with the photoconductor.

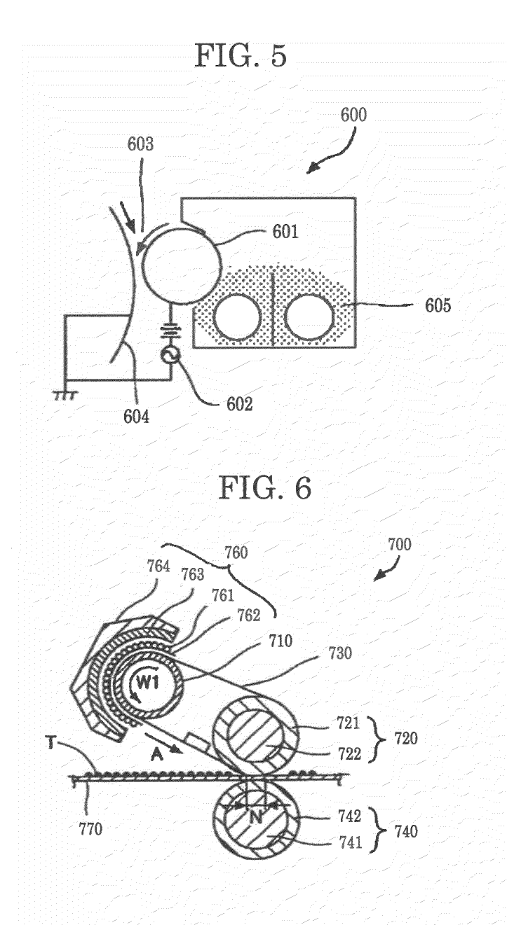

In the developing step, an alternating electrical field is preferably applied. FIG. 5 illustrates an exemplary developing device which applies an alternating electrical field. In a developing device 600 illustrated shown in FIG. 5, a power supply 602 applies a vibration bias voltage as developing bias, in which a direct-current voltage and an alternating voltage are superimposed, to a developing sleeve 601 during development. The potential of background part and the potential of image part are positioned between the maximum and the minimum of the vibration bias potential. This forms an alternating electrical field, whose direction alternately changes, at a developing region 603. A toner and a carrier in the developer are intensively vibrated in this alternating electrical field, so that the toner 605 overshoots the electrostatic force of constraint from the developing sleeve 601 and the carrier, and is attached to a latent image on the photoconductor 604. The toner 605 is a toner of the present invention.

The difference between the maximum and the minimum of the vibration bias voltage (peak-to-peak voltage) is preferably from 0.5 kV to 5 kV, and the frequency is preferably from 1 kHz to 10 kHz. The waveform of the vibration bias voltage may be a rectangular wave, a sine wave or a triangular wave. The direct-current voltage of the vibration bias voltage is in a range between the potential at the background and the potential at the image as mentioned above, and is preferably set closer to the potential at the background from the viewpoint of inhibiting a toner deposition (fogging) on the background.

When the vibration bias voltage is a rectangular wave, it is preferred that a duty ratio is 50% or less. The duty ratio is a ratio of time when the toner leaps to the photoconductor during a cycle of the vibration bias. In this way, the difference between the peak time value when the toner leaps to the photoconductor and the time average value of bias can become very large. Consequently, the movement of the toner becomes further activated hence the toner is accurately attached to the potential distribution of the latent electrostatic image and rough deposits and an image resolution can be improved. Moreover, the difference between the time peak value when the carrier having an opposite polarity of current to the toner leaps to the photoconductor and the time average value of bias can be decreased. Consequently the movement of the carrier can be restrained and the possibility of the carrier deposition on the background is largely reduced.

The fixing device used in the fixing step may be, for example, a fixing device illustrated in FIG. 6. The fixing device 700 illustrated in FIG. 6 preferably includes a heating roller 710 which is heated by electromagnetic induction by means of an induction heating unit 760, a fixing roller 720 (facing rotator) disposed in parallel to the heating roller 710, a fixing belt (heat resistant belt, toner heating medium) 730, which is formed of an endless strip stretched between the heating roller 710 and the fixing roller 720 and which is heated by the heating roller 710 and rotated by any of these rollers in the direction indicated by arrow A, and a pressure roller 740 (pressing rotator) which is pressed against the fixing roller 720 through the fixing belt 730 and which is rotated in forward direction with respect to the fixing belt 730.

The heating roller 710 is a hollow cylindrical magnetic metal member made of, for example, iron, cobalt, nickel or an alloy of these metals. The heating roller 710 is 20 mm to 40 mm in an outer diameter, and 0.3 mm to 1.0 mm in thickness, to be in construction of low heat capacity and a rapid rise of temperature.

The fixing roller 720 (facing rotator) is formed of a metal core 722 made of metal such as stainless steel, and an elastic member 721 made of a solid or foam-like silicone rubber having heat resistance to be coated on the metal core 722. Further, to form a contact section of a predetermined width between the pressure roller 740 and the fixing roller 720 by a compressive force provided by the pressure roller 740, the fixing roller 720 is constructed to be about 20 mm to about 40 mm in an outer diameter to be larger than the heating roller 710. The elastic member 721 is about 4 mm to about 6 mm in thickness. Owing to this construction, the heat capacity of the heating roller 710 is smaller than that of the fixing roller 720, so that the heating roller 710 is rapidly heated to make warm-up time period shorter.

The fixing belt 730 that is stretched between the heating roller 710 and the fixing roller 720 is heated at a contact section W1 with the heating roller 710 to be heated by the induction heating unit 760. Then, an inner surface of the fixing belt 730 is continuously heated by the rotation of the heating roller 710 and the fixing roller 720, and as a result, the whole belt will be heated.

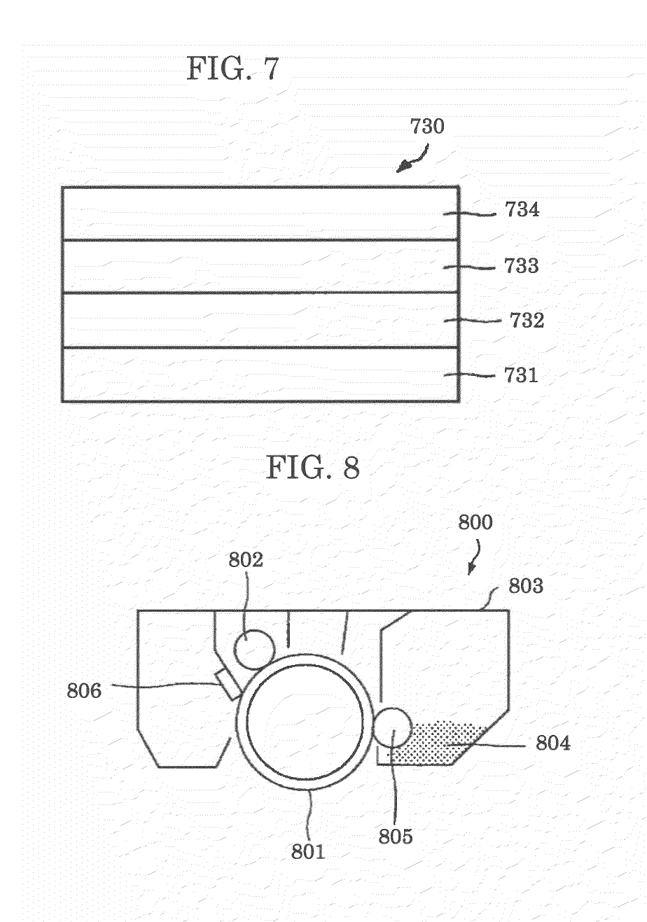

FIG. 7 illustrates a layer structure of the fixing belt 730. The fixing belt 730 consists of the following four layers in the order from an inner layer to a surface layer.

Substrate 731: a resin layer, for example, formed of a polyimide (PI) resin

Heat generating layer 732: a conductive material layer, for example, formed of Ni, Ag, SUS

Intermediate layer 733: an elastic layer for uniform fixation

Release layer 734: a resin layer, for example, formed of a fluorine-containing resin material for obtaining releasing effect and making oilless.

The release layer 734 is preferably 10 μm to 300 μm in thickness, particularly preferably about 200 μm in thickness. In this manner, in the fixing device 700 as illustrated in FIG. 6, since the surface layer of the fixing belt 730 sufficiently covers a toner image T formed on a recording medium 770, it becomes possible to uniformly heat and melt the toner image T. The release layer 734; i.e., a surface release layer needs to have a thickness of 10 μm at minimum in order to secure abrasion resistance over time. In addition, when the release layer 734 exceeds 300 μm in thickness, the heat capacity of the fixing belt 730 comes to be larger, resulting in a longer warm-up time period. Further, additionally, a surface temperature of the fixing belt 730 is unlikely to decrease in the toner-fixing step, a cohesion effect of melted toner at an outlet of the fixing portion cannot be obtained, and thus the so-called hot offset occurs in which a releasing property of the fixing belt 730 is lowered, and toner particles of the toner image T is attached onto the fixing belt 730. Moreover, as a substrate of the fixing belt 730, the heat generating layer 732 formed of a metal may be used, or the resin layer having heat resistance, such as a fluorine-containing resin, a polyimide resin, a polyamide resin, a polyamide-imide resin, a PEEK resin, a PES resin, and a PPS resin, may be used.

The pressure roller 740 is constructed of a cylindrical metal core 741 made of a metal having a high thermal conductivity, for example, copper or aluminum, and an elastic member 742 having a high heat resistance and toner releasing property that is located on the surface of the metal core 741. The metal core 741 may be made of SUS other than the above-described metals. The pressure roller 740 presses the fixing roller 720 through the fixing belt 730 to form a nip portion N. According to this embodiment, the pressure roller 740 is arranged to engage into the fixing roller 720 (and the fixing belt 730) by causing the hardness of the pressure roller 740 to be higher than that of the fixing roller 720, whereby the recording medium 770 is in conformity with the circumferential shape of the pressure roller 740, thus to provide the effect that the recording medium 770 is likely to come off from the surface of the fixing belt 730. This pressure roller 740 is about 20 mm to about 40 mm in an external diameter as is the fixing roller 720. This pressure roller 740, however, is about 0.5 mm to about 2.0 mm in thickness, to be thinner than the fixing roller 720.

The induction heating unit 760 for heating the heating roller 710 by electromagnetic induction, as shown in FIG. 6, includes an exciting coil 761 serving as a field generation unit, and a coil guide plate 762 around which this exciting coil 761 is wound. The coil guide plate 762 has a semi-cylindrical shape that is located close to the perimeter surface of the heating roller 710. The exciting coil 761 is the one in which one long exciting coil wire is wound alternately in an axial direction of the heating roller 710 along this coil guide plate 762. Further, in the exciting coil 761, an oscillation circuit is connected to a driving power source (not shown) of variable frequencies. Outside of the exciting coil 761, an exciting coil core 763 of a semi-cylindrical shape that is made of a ferromagnetic material such as ferrites is fixed to an exciting coil core support 764 to be located in the proximity of the exciting coil 761.

### (Process Cartridge)

A process cartridge of the present invention includes an electrophotographic photoconductor, a charging unit configured to charge the electrophotographic photoconductor, an exposing unit configured to form a latent electrostatic image on the charged electrophotographic photoconductor, a developing unit configured to form a toner image with the above-described toner from the latent electrostatic image formed on the electrophotographic photoconductor, a primary transfer unit configured to primarily transfer the toner image formed on the electrophotographic photoconductor onto an intermediate transfer member, a secondary transfer member configured to secondarily transfer onto a recording medium the toner image primarily transferred on the intermediate transfer member, a fixing unit configured to fix the secondarily transferred toner image on the recording medium through application of heat and pressure, and a cleaning unit configured to remove the toner remaining after the primary or secondary transfer and attached on the surface of the electrophotographic photoconductor, wherein the electrophotographic photoconductor and the developing unit are integrally supported and the process cartridge is detachably mounted to the main body of the image forming apparatus.

The developing device and the charging device described above are suitable for use as the developing unit and the charging unit, respectively.

An example of the process cartridge is illustrated in FIG. 8. A process cartridge 800 illustrated in FIG. 8 includes a photoconductor 801, a charging unit 802, a developing unit 803, and a cleaning unit 806. In the operation of this process cartridge 800, the photoconductor 801 is rotated at a specific peripheral speed. In the course of rotating, the photoconductor 801 receives from the charging unit 802 a uniform, positive or negative electrical charge of a specific potential around its periphery, and then receives image exposure light from an unillustrated image exposing unit, such as slit exposure or laser beam scanning exposure, and in this way a latent electrostatic image is formed on the periphery of the photoconductor 801. The latent electrostatic image thus formed is then developed by a developing unit 805 with a developer 804 containing the above-described toner, and the developed toner image is transferred by an unillustrated transfer unit onto a recording medium that is fed from a paper supplier to in between the photoconductor 801 and the transfer unit, in synchronization with the rotation of the photoconductor 801. The recording medium on which the image has been transferred is separated from the surface of the photoconductor 801, introduced into an unillustrated image fixing unit so as to fix the image thereon, and this product is printed out from the device as a copy or a print. The surface of the photoconductor 801 after the image transfer is cleaned by the cleaning unit 806 so as to remove the residual toner after the transfer, and is electrically neutralized and repeatedly used for image formation.

### (Image Forming Apparatus)

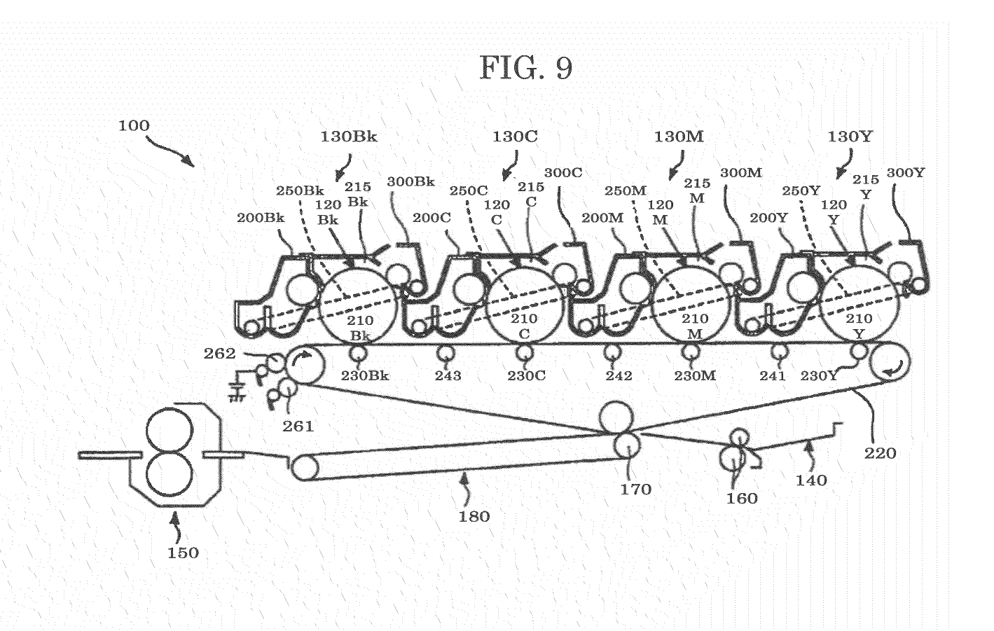

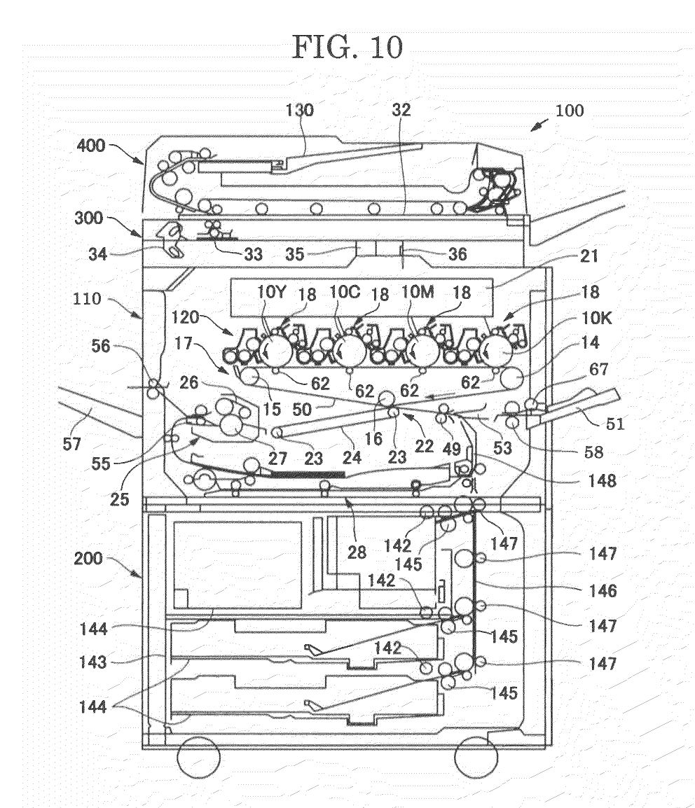

For example, a tandem-type image forming apparatus 100 illustrated in FIGS. 9 and 10 may be used as the full-color image forming apparatus used in the full-color image forming method. In FIG. 9, the image forming apparatus 100 mainly includes image writing units (120Bk, 120C, 120M and 120Y) for color image formation by an electrophotographic method, image forming units (130Bk, 130C, 130M and 130Y), and a paper feeder 140. According to image signals, image processing is performed in an unillustrated image processing unit for conversion to respective color signals of black (Bk), cyan (C), magenta (M), and yellow (Y) for image formation,

[symbol]

The image forming units (130Bk, 130C, 130M and 130Y) include photoconductors (210Bk, 210C, 210M and 210Y) respectively for black, cyan, magenta, and yellow. An OPC photoconductor is generally used in the photoconductors (210Bk, 210C, 210M and 210Y) for the respective colors. For example, chargers (215Bk, 215C, 215M and 215Y), an exposing unit for laser beams emitted from the image writing units (120Bk, 120C, 120M and 120Y), developing devices (200Bk, 200C, 200M and 200Y) for respective colors, primary transfer devices (230Bk, 230C, 230M and 230Y), cleaning devices (300Bk, 300C, 300M and 300Y), and charge-eliminating devices (not illustrated) are provided around the respective photoconductors (210Bk, 210C, 210M and 210Y). The developing devices (200Bk, 200C, 200M and 200Y) use a two-component magnetic brush development system. Further, an intermediate transfer belt 220 is

[symbol]

In some cases, a pre-transfer charger 262 is preferably provided as a pre-transfer charging unit at a position that is outside the intermediate transfer belt 220 and after the passage of the final color through a primary transfer position and before a secondary transfer position. Before the toner images on the intermediate transfer belt 220, which have been transferred onto the photoconductors 210 in the primary transfer unit, are transferred onto a transfer paper as a recording medium, the pre-transfer charger 262 charges toner images evenly to the same polarity.

The toner images on the intermediate transfer belt 220 transferred from the photoconductors (210Bk, 210C, 210M and 210Y) include a halftone portion and a solid image portion or a portion in which the level of superimposition of toners is different. Accordingly, in some cases, the charge amount varies from toner image to toner image. Further, due to separation discharge generated in spaces on an adjacent downstream side of the primary transfer unit in the

[symbol]

Thus, according to the image forming method wherein the toner images located on the intermediate transfer belt 220 and transferred from the photoconductors (210Bk, 210C, 210M and 210Y) are evenly charged by the pre-transfer charger 502, even when a variation in charge amount of the toner images located on the intermediate transfer belt 220 exists, the transfer properties in the secondary transfer unit can be rendered almost constant over each portion of the toner images located on the intermediate transfer belt 220. Accordingly, a lowering in the transfer latitude in the transfer of the toner images onto the transfer paper can be suppressed, and the toner images can be stably transferred.

In the image forming method, the amount of charge by the pre-transfer charger varies depending upon the moving speed of the intermediate transfer belt 220 as the charging object. For example, when the moving speed of the intermediate transfer belt 220 is low, the period of time, for which the same part in the toner images on the intermediate transfer belt 220 passes through a region of charging by the pre-transfer charger, increased. Therefore, in this case, the charge amount is increased. On the other hand, when the moving speed of the intermediate transfer belt 220 is high, the charge amount of the toner images on the intermediate transfer belt 220 is decreased. Accordingly, when the moving speed of the intermediate transfer belt 220 changes during the passage of the toner images on the intermediate transfer belt 220 through the position of charging by the pre-transfer charger, preferably, the pre-transfer charger is regulated according to the moving speed of the intermediate transfer belt 220 so that the charge amount of the toner images does not change during the passage of the toner images on the intermediate transfer belt 220 through the position of charging by the pre-transfer charger.

Conductive rollers 241, 242 and 243 are provided between the primary transfer devices (230Bk, 230C, 230M and 230Y). The transfer paper is fed from a paper feeder 140 and then is supported on an intermediate transfer belt 220 through a pair of registration

[symbol]

The transfer paper after image formation is transferred by a secondary transfer belt 180 to a fixing device 150 where the color image is fixed to provide a fixed color image. The toner remaining after transfer on the intermediate transfer belt 220 is removed form the belt by an intermediate transfer belt cleaning device 260.

The polarity of the toner on the intermediate transfer belt 220 before transfer onto the transfer paper has the same negative polarity as the polarity in the development. Accordingly, a positive transfer bias voltage is applied to a secondary transfer roller 170, and the toner is transferred onto the transfer paper. The nip pressure in this portion affects the transferability and significantly affects the fixability. The toner remaining after transfer and located on the intermediate transfer belt 220 is subjected to discharge electrification to positive polarity side; i.e., 0 to positive polarity, in a moment of the separation of the transfer paper from the intermediate transfer belt 220. Toner images formed on the transfer paper in jam or toner images in a non-image region of the transfer paper are not influenced by the secondary transfer and thus, of course, maintain negative

[symbol]

The thickness of the photoconductor layer, the beam spot diameter of the optical system, and the quantity of light are 30 μm, 50 μm×60 μm, and 0.47 mW, respectively. The developing step is performed under such conditions that the charge (exposure side) potential V0 of the photoconductor (black) (210Bk) is −700 V, potential VL after exposure is −120 V, and the development bias voltage is −470 V, that is, the development potential is 350 V. The visual image of the toner (black) formed on the photoconductor (black) (210Bk) is then subjected to transfer (intermediate transfer belt and transfer paper) and the fixing step and consequently is completed as an image. Regarding the transfer, all the colors are first transferred from the primary transfer devices (230Bk, 230C, 230M and 230Y) to the intermediate transfer belt 220 followed by transfer to the transfer paper by applying bias to a separate secondary transfer roller 170.

Next, the photoconductor cleaning device will be described in detail. In FIG. 9, the developing devices (200Bk, 200C, 200M and 200Y) are connected to respective cleaning devices (300Bk, 300C, 300M and 300Y) through toner transfer tubes (250Bk, 250C, 250M and 250Y) (dashed lines in FIG. 9). A screw (not illustrated) is provided within the toner transfer tubes (250Bk, 250C, 250M and 250Y), and the toners recovered in the cleaning devices (300Bk, 300C,

[symbol]

A direct transfer system including a combination of four photoconductor drums with belt transfer has the following drawback. Specifically, upon abutting of the photoconductor against the transfer paper, paper dust is adhered onto the photoconductor. Therefore, the toner recovered from the photoconductor contains paper dust and thus cannot be used because, in the image formation, an image deterioration such as toner dropouts occurs. Further, in a system including a combination of one photoconductor drum with intermediate transfer, the adoption of the intermediate transfer has eliminated a problem of the adherence of paper dust onto the photoconductor in the transfer onto the transfer paper. In this system, however, when recycling of the residual toner on the photoconductor is contemplated, the separation of the mixed color toners is practically impossible. The use of the mixed color toners as a black toner has been proposed. However, even when all the colors are mixed, a black color is not produced. Further, colors vary depending upon printing modes. Accordingly, in the one-photoconductor construction, recycling of the toner is impossible.

By contrast, in the full-color image forming apparatus, since the intermediate transfer belt 220 is used, the contamination with

[symbol]

The positively charged toner remaining after transfer on the intermediate transfer belt 220 is removed by cleaning with a conductive fur brush 262 to which a negative voltage has been applied. A voltage can be applied to the conductive fur brush 262 in the same manner as in the application of the voltage to a conductive fur brush 261, except that the polarity is different. The toner remaining after transfer can be almost completely removed by cleaning with the two conductive fur brushes 261 and 262. The toner, paper dust, talc and the like, remaining unremoved by cleaning with the conductive fur brush 262 are negatively charged by a negative voltage of the conductive fur brush 262. The subsequent primary transfer of black is transfer by a positive voltage. Accordingly, the negatively charged toner and the like are attracted toward the intermediate transfer belt 220, and, thus, the transfer to the photoconductor (black) (210Bk) side can be prevented.

Next, the intermediate transfer belt 220 used in the image forming apparatus will be described. As described above, the intermediate transfer belt is preferably a resin layer having a single layer structure. If necessary, the intermediate transfer belt may have an elastic layer and a surface layer.

Examples the resin materials constituting the resin layer include, but not limited to, polycarbonate resins, fluorine resins (such as ETFE and PVDF); polystyrenes, chloropolystyrenes, poly-α-methylstyrenes; styrene resins (homopolymers or copolymers containing styrene or styrene substituents) such as styrene-butadiene copolymers, styrene-vinyl chloride copolymers, styrene-vinyl acetate copolymers, styrene-maleic acid copolymers, styrene-acrylate copolymers (such as styrene-methyl acrylate copolymers, styrene-ethyl acrylate copolymers, styrene-butyl acrylate copolymers, styrene-octyl acrylate copolymers, and styrene-phenyl acrylate copolymers), styrene-methacrylate copolymers (such as styrene-methyl methacrylate copolymers, styrene-ethyl methacrylate copolymers and styrene-phenyl methacrylate copolymers); styrene-α-chloromethyl acrylate copolymers, styrene-acrylonitrile acrylate copolymers, methyl methacrylate resins, and butyl methacrylate resins; ethyl acrylate resins, butyl acrylate resins, modified acrylic resins (such as silicone-modified acrylic resins, vinyl chloride resin-modified acrylic resins and acrylic urethane resins); vinyl chloride resins, styrene-vinyl acetate copolymers, vinyl chloride-vinyl acetate copolymers, rosin-modified maleic acid resins, phenol resins, epoxy resins, polyester resins, polyester polyurethane resins, polyethylene resins, polypropylene resins, polybutadiene resins, polyvinylidene chloride resins, ionomer resins, polyurethane resins, silicone resins, ketone resins, ethylene-ethylacrylate copolymers, xylene resins, polyvinylbutylal resins, polyamide resins and modified polyphenylene oxide resins. These resins may be used alone or in combination.

Examples of elastic materials (elastic rubbers, elastomers) constituting the elastic layer include, but not limited to, butyl rubber, fluorine-based rubber, acryl rubber, EPDM rubber, NBR rubber, acrylonitrile-butadiene-styrene natural rubber, isoprene rubber, styrene-butadiene rubber, butadiene rubber, ethylene-propylene rubber, ethylene-propylene terpolymers, chloroprene rubber, chlorosulfonated polyethylene, chlorinated polyethylene, urethane rubber, syndiotactic 1,2-polybutadiene, epichlorohydrin-based rubber, silicone rubber, fluorine rubber, polysulfide rubber, polynorbornene rubber, hydrogenated nitrile rubber, and thermoplastic elastomers (for example, polystyrene, polyolefin, polyvinyl chloride, polyurethane, polyamide, polyurea, polyester and fluorine resins). These rubbers may be used alone or in combination.

The material used for the surface layer is not particularly limited but is required to reduce toner adhesion force to the surface of the intermediate transfer belt so as to improve the secondary transfer property. The surface layer preferably contains one or two or more of polyurethane resin, polyester resin, and epoxy resin, and one or two or more of materials that reduce surface energy and enhance lubrication, for example, powders or particles such as fluorine resin, fluorine compound, carbon fluoride, titanium dioxide, and silicon carbide, or a dispersion of the materials having different particle diameters. In addition, it is possible to use a material such as fluorine rubber that is treated with heat so that a fluorine-rich layer is formed on the surface and the surface energy is reduced.

The resin layer and elastic layer preferably contain a conductive agent for adjusting resistance.

The conductive agent for adjusting resistance is not particularly limited and may be appropriately selected depending on the intended purpose. Examples thereof include, but not limited to, carbon black, graphite, metal powders such as aluminum and nickel; conductive metal oxides such as tin oxide, titanium oxide, antimony oxide, indium oxide, potassium titanate, antimony tin oxide (ATO), and indium tin oxide (ITO).

The conductive metal oxides may be coated with insulating fine particles such as barium sulfate, magnesium silicate, and calcium carbonate.

FIG. 10 shows another example of the image forming apparatus used in the full-color image forming method of the present invention and is a copier 100 equipped with an electrophotographic image forming apparatus of a tandem indirect transfer system. In FIG. 10, the copier 100 includes a copier main body 110, a paper feed table 200 for mounting the copier main body 110, a scanner 300, which is arranged over the copier main body 110, and an automatic document feeder (ADF) 400, which is arranged over the scanner 300. The copier main body 110 has an endless belt intermediate transfer member 50 in the center.

The intermediate transfer member is stretched around support rollers 14, 15, and 16 and rotates clockwise as shown in FIG. 10. An intermediate transfer member cleaning device 17 for removing residual toner on the intermediate transfer member 50 is provided near the second support roller 15 of the three support rollers. A tandem image forming device 120 has four image forming units 18 for yellow, cyan, magenta, and black, which face the intermediate transfer member 50 stretched around the first support roller 14 and the second support roller 15, and are arranged side by side in the transfer rotation direction thereof.

An exposing device 21 is provided over the tandem image forming device 120 as shown in FIG. 10. A second transfer device 22 is provided across the intermediate transfer member 50 from the tandem image forming unit 120. The secondary transfer unit 22 has an endless second transfer belt 24 stretched around a pair of rollers 23, and is arranged so as to press against the third support roller 16 via the intermediate transfer member 50, thereby transferring an image carried on the intermediate transfer member 50 onto a sheet. A fixing device 25 configured to fix the transferred image on the sheet is provided near the second transfer device 22. The fixing device 25 has an endless fixing belt 26 and a pressure roller 27 pressed against the fixing belt 26. The second transfer device 22 includes a sheet conveyance function in which the sheet on which the image has been transferred is conveyed to the fixing device 25. As the second transfer device 22, a transfer roller or a non-contact charge may be provided, however, these are difficult to provide in conjunction with the sheet conveyance function. A sheet inversion device 28 for forming images on both sides of a sheet is provided parallel to the tandem image forming device 120 and under the second transfer device 22 and fixing device 25.

At first, a document is placed on a document table 130 of the automatic document feeder 400, when a copy is made using the color electrophotographic apparatus. Alternatively, the automatic document feeder 400 is opened, the document is placed onto a contact glass 32 of the scanner 300, and the automatic document feeder 400 is closed.

When an unillustrated start switch is pressed, a document placed on the automatic document feeder 400 is conveyed onto the contact glass 32. When the document is initially placed on the contact glass 32, the scanner 300 is immediately driven to operate a first carriage 33 and a second carriage 34. At the first carriage 33, light is applied from a light source to the document, and reflected light from the document is further reflected toward the second carriage 34. The reflected light is further reflected by a mirror of the second carriage 34 and passes through image-forming lens 35 into a read sensor 36 to thereby read the document.

When the start switch is pressed, one of the support rollers 14, and 16 is rotated by an unillustrated drive motor, and as a result, the other two support rollers are rotated by the rotation of the driven support roller. In this way, the intermediate transfer member 50 runs around the support rollers 14, 15 and 16. Simultaneously, the individual image forming units 18 respectively rotate their photoconductors 10K, 10Y, 10M and 10C to thereby form black, yellow, magenta, and cyan monochrome images on the photoconductors 10K, 10Y, 10M and 10C, respectively. With the conveyance of the intermediate transfer member 50, the monochrome images are sequentially transferred to form a composite color image on the intermediate transfer member 50.

Separately, when the start switch is pressed, one of feeder rollers 142 of the paper feed table 200 is selectively rotated, sheets are ejected from one of multiple feeder cassettes 144 in a paper bank 143 and are separated in a separation roller 145 one by one into a feeder path 146, are transported by a transport roller 147 into a feeder path 148 in the copier main body 100 and are bumped against registration rollers 49.

Alternatively, pressing the start switch rotates a paper feeding roller 67 to eject sheets on a manual bypass tray 51, and the sheets are separated one by one on a separation roller 58 into a manual bypass feeder path 53 and are bumped against the registration rollers 49.

The registration rollers 49 are rotated synchronously with the movement of the composite color image on the intermediate transfer member 50 to transport the sheet into between the intermediate transfer member 50 and the secondary transfer device 22, and the composite color image is transferred onto the sheet by action of the secondary transfer device 22 to thereby form a color image.

The sheet on which the image has been transferred is conveyed by the secondary transfer device 22 into the fixing device 25, is given heat and pressure in the fixing device 25 to fix the transferred image, changes its direction by action of a switch claw 55, and is ejected by an ejecting roller 56 to be stacked on an output tray 57. Alternatively, the moving direction of the paper is changed by the switching claw 55, and the paper is conveyed to the sheet inversion device 28 where it is inverted, and guided again to the transfer position in order that an image is formed also on the back surface thereof, then the paper is ejected by the ejecting roller 56 and stacked on the output tray 57.

On the other hand, in the intermediate transfer member 50 after the image transfer, the toner, which remains on the intermediate transfer member 50 after the image transfer, is removed by the intermediate transfer member cleaning device 17, and the intermediate transfer member 50 again gets ready for image formation by the tandem image forming device 120. The registration rollers 49 are generally used in a grounded state. Bias may also be applied to the registration rollers 49 to remove paper dust of the paper sheet.

### EXAMPLES

Next, the present invention will be described by way of examples, which should not be construed as limiting the present invention thereto.

### Example A1

### Production of Toner a

### <<Preparation of Solution or Dispersion Liquid of Toner Material>>

### —Synthesis of Calixarene Derivative—

A calixarene derivative (BONTRON E-89, product of ORIENT CHEMICAL INDUSTRIES CO. LTD) was synthesized which has a structure expressed by the above General Formula (I) where m is 8, n is 0, R₁ is a hydrogen atom, R₂ is a tert-butyl group, and each of R₃ to R₅ is a hydrogen atom. First, p-tert-butylphenol (0.18 mol) and p-formaldehyde (0.30 mol) were dehydrated in xylene using potassium hydroxide (0.004 mol) through refluxing for 4 hours, followed by cooling. The resultant mixture was filtrated to obtain precipitates. The obtained precipitates were washed sequentially with toluene, ether, acetone and water, followed by drying. Then, the resultant product was recrystallized from chloroform, to thereby obtain calixarene derivative A1 as white needles.

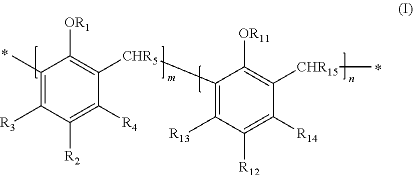

### —Synthesis of Unmodified Polyester (Low-Molecular-Weight Polyester)—

Into a reaction vessel equipped with a condenser, a stirrer, and a nitrogen-introducing tube, 67 parts by mass of bisphenol A ethyleneoxide (2 mol) adduct, 84 parts by mass of bisphenol A propionoxide (3 mol) adduct, 274 parts by mass of terephthalic acid, and 2 parts by mass of dibutyltin oxide were charged, allowing the resultant mixture to react for 8 hours at 230° C. under normal pressure. Subsequently, the reaction mixture was allowed to react for 5 hours under reduced pressure of 10 mmHg to 15 mmHg, to thereby synthesize an unmodified polyester.

The thus-obtained unmodified polyester had a number average molecular weight (Mn) of 2,100, a weight average molecular weight of 5,600, and a glass transition temperature (Tg) of 55° C.

### —Preparation of Master Batch (MB)—

1,000 parts by mass of water, 540 parts by mass of carbon black (“Printex 35”; product of Degussa; DBP oil absorption amount: 42 mL/100 g; pH 9.5), and 1,200 parts by mass of the unmodified polyester were mixed by means of HENSCHEL MIXER (product of Mitsui Mining Co., Ltd.). The resultant mixture was kneaded at 150° C. for 30 minutes by a two-roller mill, cold-rolled, and milled by a pulverizer (product of Hosokawa micron Co., Ltd.), to thereby prepare a master batch.

### —Synthesis of Prepolymer—

Into a reaction vessel equipped with a condenser, a stirrer, and a nitrogen-introducing tube, 682 parts by mass of bisphenol A ethyleneoxide (2 mol) adduct, 81 parts by mass of bisphenol A propionoxide (2 mol) adduct, 283 parts by mass of terephthalic acid, 22 parts by mass of trimellitic anhydride, and 2 parts by mass of dibutyltin oxide were charged, allowing the resultant mixture to react for 8 hours at 230° C. under normal pressure. Subsequently, the reaction mixture was allowed to react for 5 hours under reduced pressure of 10 mmHg to 15 mmHg, to thereby synthesize an “intermediate polyester.” The thus-obtained intermediate polyester had a number average molecular weight (Mn) of 2,100, a weight average molecular weight (Mw) of 9,600, a glass transition temperature (Tg) of 55° C., an acid value of 0.5 mgKOH/g, and a hydroxyl group value of 49 mgKOH/g.

Subsequently, into a reaction vessel equipped with a condenser, a stirrer, and a nitrogen-introducing tube, 411 parts by mass of the intermediate polyester, 89 parts by mass of isophorone diisocyanate, and 500 parts by mass of ethyl acetate were charged, allowing the resultant mixture to react for 5 hours at 100° C. to thereby synthesize a prepolymer (i.e., a polymer reactive with the active hydrogen group-containing compound). The prepolymer thus obtained had a free isocyanate content of 1.60% by mass and solid content concentration of 50% by mass (150° C., after being left for 45 minutes).

### <Preparation of Fine Resin Particles>

Into a reaction vessel equipped with a stirring rod and a thermometer, 683 parts by mass of water, 16 parts by mass of sodium salt of sulfuric acid ester of ethylene oxide adduct of methacrylic acid, Eleminol RS-30 (product of Sanyo Chemical Industries Ltd.), 83 parts by mass of styrene, 83 parts by mass of methacrylic acid, 110 parts by mass of butyl acrylate, and 1 part by mass of ammonium persulfate were charged, and then stirred at 400 rpm for 15 minutes to thereby obtain a white emulsion. The emulsion was heated to a system temperature of 75° C. and was allowed to react for 5 hours. Then, 30 parts by mass of a 1% by mass aqueous ammonium persulfate solution was added to the reaction mixture, followed by aging at 75° C. for 5 hours, to thereby obtain an aqueous dispersion [fine resin particle dispersion liquid A] of a vinyl resin (a copolymer of styrene-methacrylic acid-butyl acrylate-sodium salt of sulfate ester of methacrylic acid-ethylene oxide adduct).

The volume average particle diameter of [fine resin particle dispersion liquid A1] was found to be 42 nm, when measured using a particle size distribution analyzer (LA-920, product of Horiba, Ltd.).

### <<Solution or Dispersion Liquid-Preparing Step>>

### —Preparation of Calixarene Derivative A1 Dispersion Liquid—

Calixarene derivative A1 (BONTRON E-89, product of ORIENT CHEMICAL INDUSTRIES CO. LTD) (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 3, to thereby produce a calixarene derivative A1 dispersion liquid. The average particle diameter (dispersion diameter) of calixarene derivative A1 contained in the dispersion liquid was found to be 120 nm.

### —Preparation of Toner Material Phase—

The unmodified polyester (100 parts by mass) and ethyl acetate (130 parts by mass) were added to a beaker, followed by dissolving with stirring. Then, carnauba wax (molecular weight=1,800, acid value=2.5, penetration=1.5 mm (40° C.)) (10 parts by mass), the masterbatch (10 parts by mass) and the calixarene derivative A1 dispersion liquid (1 part by mass) were charged into the beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 3, to thereby produce a raw material solution. Further, the prepolymer (40 parts by mass) was added thereto, followed by stirring, to thereby a solution or dispersion liquid of the toner material.

### <<Emulsion or Dispersion Liquid-Preparing Step>>

### —Preparation of Aqueous Medium Phase—

Water (660 parts by mass), the fine resin particle dispersion liquid (1.25 parts by mass), 25 parts by mass of 48.5% by mass aqueous solution of sodium dodecyldiphenyl ether disulfonate “Eleminol MON-7” (product of Sanyo Chemical Industries Ltd.) and ethyl acetate (60 parts by mass) were mixed together to obtain a milky white liquid (aqueous phase).

### —Preparation of Emulsion or Dispersion Liquid A—

The aqueous medium phase (150 parts by mass) was placed in a container, and then stirred at 12,000 rpm with a TK homomixer (product of Tokushu Kika Kogyo Co., Ltd.). Subsequently, the solution or dispersion liquid of the toner material (100 parts by mass) was added to the thus-treated aqueous medium phase, and the resultant mixture was mixed for 10 min to thereby prepare emulsion or dispersion liquid A (emulsified slurry).

### <<Organic Solvent-Removing Step>>

### —Removal of Organic Solvent—

A flask equipped with a degassing tube, a stirrer, and a thermometer was charged with 100 parts by mass of emulsion or dispersion liquid A. The solvent was removed by stirring the emulsified slurry under conditions of stirring circumferential velocity of 20 m/min at 30° C. for 12 hours under reduced pressure to give desolvated slurry A.

### —Washing/Drying—

The whole amount of desolvated slurry A was filtrated under reduced pressure. Then, 300 parts by mass of ion-exchanged water was added to the filter cake, followed by mixing and redispersing with a TK homomixer (at a rotation speed of 12,000 rpm for 10 min) and filtrating. Further, 300 parts by mass of ion-exchanged water was added to the filter cake, followed by mixing with a TK homomixer (at a rotation speed of 12,000 rpm for 10 min) and filtrating. This mixing/filtrating procedure was performed three times. The filter cake thus obtained was dried in a downwind drier at 45° C. for 48 hr. The dried product was sieved through a sieve with 75 μm-mesh opening to give toner base particle a.

### —External Addition Treatment—

Toner base particle a (100 parts by mass) was mixed with 0.6 parts by mass of hydrophobic silica having an average particle diameter of 100 nm, 1.0 part by mass of titanium oxide having an average particle diameter of 20 nm, and 0.8 parts by mass of a fine powder of hydrophobic silica having an average particle diameter of 15 nm with a HENSCHEL MIXER to give toner a.

### Example A2

### Production of Toner b

The procedure of Example A1 was repeated, except that the dispersion diameter of calixarene derivative A1 was changed from 120 nm to 70 nm, to thereby produce toner b. The average dispersion diameter of calixarene derivative A1 was adjusted as follows.

### —Preparation of Calixarene Derivative A1 Dispersion Liquid—

Calixarene derivative A1 (BONTRON E-89, product of ORIENT CHEMICAL INDUSTRIES CO. LTD) (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 5, to thereby produce a calixarene derivative A1 dispersion liquid.

### Example A3

### Production of Toner c

The procedure of Example A1 was repeated, except that the dispersion diameter of calixarene derivative A1 was changed from 120 nm to 300 nm, to thereby produce toner c. The average dispersion diameter of calixarene derivative A1 was adjusted as follows.

### —Preparation of Calixarene Derivative A1 Dispersion Liquid—

Calixarene derivative A1 (BONTRON E-89, product of ORIENT CHEMICAL INDUSTRIES CO., LTD) (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 2, to thereby produce a calixarene derivative A1 dispersion liquid.

### Example A4

### Synthesis of Calixarene Derivative A2

Calixarene derivative A2 was synthesized which has a structure expressed by the above General Formula (I) where m is 4 to 8, n is 0, R₁ is a hydrogen atom, R₂ is a phenyl group, and each of R₃ to R₅ is a hydrogen atom. First, p-phenylphenol (0.18 mol) and p-formaldehyde (0.30 mol) were dehydrated in xylene using potassium hydroxide (0.004 mol) through refluxing for 4 hours, followed by cooling. The resultant mixture was filtrated to obtain precipitates. The obtained precipitates were washed sequentially with toluene, ether, acetone and water, followed by drying. Then, the resultant product was recrystallized from chloroform, to thereby obtain calixarene derivative A2 as white needles.

### Preparation of Calixarene Derivative A2 Dispersion Liquid—

Calixarene derivative A2 (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 6, to thereby produce a calixarene derivative A2 dispersion liquid. The average dispersion diameter of calixarene derivative A2 was found to be 45 nm.

### Production of Toner d

The procedure of Example A1 was repeated, except that calixarene derivative A1 was changed to calixarene derivative A2, to thereby produce toner d.

### Example A5

### Synthesis of Calixarene Derivative A3

Calixarene derivative A3 was synthesized which has a structure expressed by the above General Formula (I) where m+n is 4 to 8, R₁ is a hydrogen atom, R₂ is a methyl group, each of R₃ to R₅ is a hydrogen atom, R₁₁ is a hydrogen atom, R₁₂ is a phenyl group and each of R₁₃ to R₁₅. First, p-methylphenol (0.18 mol), p-phenylphenol (0.18 mol) and p-formaldehyde (0.30 mol) were dehydrated in xylene using potassium hydroxide (0.004 mol) through refluxing for 4 hours, followed by cooling. The resultant mixture was filtrated to obtain precipitates. The obtained precipitates were washed sequentially with toluene, ether, acetone and water, followed by drying. Then, the resultant product was recrystallized from chloroform, to thereby obtain calixarene derivative A3 as white needles.

### —Preparation of Calixarene Derivative A3 Dispersion Liquid—

Calixarene derivative A3 (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 6, to thereby produce a calixarene derivative A3 dispersion liquid. The average dispersion diameter of calixarene derivative A3 was found to be 45 nm.

### Production of Toner e

The procedure of Example A1 was repeated, except that calixarene derivative A1 was changed to calixarene derivative A3, to thereby produce toner e.

### Example A6

### Synthesis of Calixarene Derivative A4

Calixarene derivative A4 was synthesized which has a structure expressed by the above General Formula (I) where m is 4 to 8, n is 0, R₁ is a hydrogen atom, R₂ is a methyl group and each of R₃ to R₅ is a hydrogen atom. First, p-methylphenol (0.18 mol) and p-formaldehyde (0.30 mol) were dehydrated in xylene using potassium hydroxide (0.004 mol) through refluxing for 4 hours, followed by cooling. The resultant mixture was filtrated to obtain precipitates. The obtained precipitates were washed sequentially with toluene, ether, acetone and water, followed by drying. Then, the resultant product was recrystallized from chloroform, to thereby obtain calixarene derivative A4 as white needles.

### —Preparation of Calixarene Derivative A4 Dispersion Liquid—

Calixarene derivative A4 (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 4, to thereby produce a calixarene derivative A4 dispersion liquid. The average dispersion diameter of calixarene derivative A4 was found to be 100 nm.

### Production of Toner f

The procedure of Example A1 was repeated, except that calixarene derivative A1 was changed to calixarene derivative A4, to thereby produce toner f.

### Example A7

### Synthesis of Calixarene Derivative A5

Calixarene derivative A5 was synthesized which has a structure expressed by the above General Formula (I) where m is 4 to 8, n is 0, R₁ is a hydrogen atom, R₂ is a methyl group and each of R₃ to R₅ is a hydrogen atom. First, p-methylphenol (0.18 mol) and p-formaldehyde (0.30 mol) were dehydrated in xylene using potassium hydroxide (0.004 mol) through refluxing for 4 hours, followed by cooling. The resultant mixture was filtrated to obtain precipitates. The obtained precipitates were washed sequentially with toluene, ether, acetone and water, followed by drying. Then, the resultant product was recrystallized from chloroform, to thereby obtain calixarene derivative A5 as white needles.

### —Preparation of Calixarene Derivative A5 Dispersion Liquid—

Calixarene derivative A5 (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 3, to thereby produce a calixarene derivative A5 dispersion liquid. The average dispersion diameter of calixarene derivative A5 was found to be 120 nm.

### Production of Toner g

The procedure of Example A1 was repeated, except that calixarene derivative A1 was changed to calixarene derivative A5, to thereby produce toner g.

### Example A8

### Synthesis of Calixarene Derivative A6

Calixarene derivative A6 was synthesized which has a structure expressed by the above General Formula (I) where m+n is 4 to 8, m:n is 1:1, R₁ is a hydrogen atom, R₂ is a tert-butyl group, each of R₃ to R₅ is a hydrogen atom, R₁₁ is a hydrogen atom, R₁₂ is a methoxy group, and each of R₁₃ to R₁₅ is a hydrogen atom. First, p-methoxyphenol (0.18 mol), p-tert-butylphenol (0.18 mol) and p-formaldehyde (0.30 mol) were dehydrated in xylene using potassium hydroxide (0.004 mol) through refluxing for 4 hours, followed by cooling. The resultant mixture was filtrated to obtain precipitates. The obtained precipitates were washed sequentially with toluene, ether, acetone and water, followed by drying. Then, the resultant product was recrystallized from chloroform, to thereby obtain calixarene derivative A6 as white needles.

### —Preparation of Calixarene Derivative A6 Dispersion Liquid—

Calixarene derivative A6 (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 5, to thereby produce a calixarene derivative A6 dispersion liquid. The average dispersion diameter of calixarene derivative A6 was found to be 80 nm.

### Production of Toner h

The procedure of Example A1 was repeated, except that calixarene derivative A1 was changed to calixarene derivative A6, to thereby produce toner h.

### Example A9

### Synthesis of Calixarene Derivative A7

Calixarene derivative A7 was synthesized which has a structure expressed by the above General Formula (I) where m+n is 4 to 8, m:n is 4:1, R₁ is a hydrogen atom, R₂ is a tert-butyl group, each of R₃ to R₅ is a hydrogen atom, R₁₁ is a hydrogen atom, R₁₂ is a methoxy group, and each of R₁₃ to R₁₅ is a hydrogen atom. First, p-methoxyphenol (0.18 mol), p-tert-butylphenol (0.72 mol) and p-formaldehyde (0.30 mol) were dehydrated in xylene using potassium hydroxide (0.004 mol) through refluxing for 4 hours, followed by cooling. The resultant mixture was filtrated to obtain precipitates. The obtained precipitates were washed sequentially with toluene, ether, acetone and water, followed by drying. Then, the resultant product was recrystallized from chloroform, to thereby obtain calixarene derivative A7 as white needles.

### —Preparation of Calixarene Derivative A7 Dispersion Liquid—

Calixarene derivative A7 (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 6, to thereby produce a calixarene derivative A7 dispersion liquid. The average dispersion diameter of calixarene derivative A7 was found to be 40 nm.

### Production of Toner i

The procedure of Example A1 was repeated, except that calixarene derivative A1 was changed to calixarene derivative A7, to thereby produce toner i.

### Example A10

### Synthesis of Calixarene Derivative A8

Calixarene derivative A8 was synthesized which has a structure expressed by the above General Formula (I) where m+n is 4 to 8, m:n is 1:1, R₁₁ is a hydrogen atom, R₂ is a tert-butyl group, each of R₃ to R₅ is a hydrogen atom, R₁₁ is a hydrogen atom, R₁₂ is a phenyl group, and each of R₁₃ to R₁₅ is a hydrogen atom. First, p-phenylphenol (0.18 mol), p-tert-butylphenol (0.18 mol) and p-formaldehyde (0.30 mol) were dehydrated in xylene using potassium hydroxide (0.004 mol) through refluxing for 4 hours, followed by cooling. The resultant mixture was filtrated to obtain precipitates. The obtained precipitates were washed sequentially with toluene, ether, acetone and water, followed by drying. Then, the resultant product was recrystallized from chloroform, to thereby obtain calixarene derivative A8 as white needles.

### —Preparation of Calixarene Derivative A8 Dispersion Liquid—

Calixarene derivative A8 (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 6, to thereby produce a calixarene derivative A8 dispersion liquid. The average dispersion diameter of calixarene derivative A8 was found to be 37 nm.

### Production of Toner j

The procedure of Example A1 was repeated, except that calixarene derivative A1 was changed to calixarene derivative A8, to thereby produce toner j.

### Example A11

### Synthesis of Calixarene Derivative A9

Calixarene derivative A9 was synthesized which has a structure expressed by the above General Formula (I) where m+n is 4 to 8, m:n is 1:0, R₁ is a hydrogen atom, R₂ is a p-bromophenyl group, and each of R₃ to R₅ is a hydrogen atom. First, p-bromophenol (0.18 mol) and p-formaldehyde (0.30 mol) were dehydrated in xylene using potassium hydroxide (0.004 mol) through refluxing for 4 hours, followed by cooling. The resultant mixture was filtrated to obtain precipitates. The obtained precipitates were washed sequentially with toluene, ether, acetone and water, followed by drying. Then, the resultant product was recrystallized from chloroform, to thereby obtain calixarene derivative A9 as white needles.

### —Preparation of Calixarene Derivative A9 Dispersion Liquid—

Calixarene derivative A9 (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 6, to thereby produce a calixarene derivative A9 dispersion liquid. The average dispersion diameter of calixarene derivative A9 was found to be 31 nm.

### Production of Toner K

The procedure of Example A1 was repeated, except that calixarene derivative A1 was changed to calixarene derivative A9, to thereby produce toner k.

### Example A12

### Synthesis of Calixarene Derivative A10

Calixarene derivative A10 was synthesized which has a structure expressed by the above General Formula (I) where m+n is 4 to 8, m:n is 1:0, R₁ is a methyl group, and each of R₂ to R₅ is a hydrogen atom. First, methylphenol (0.18 mol) and p-formaldehyde (0.30 mol) were dehydrated in xylene using potassium hydroxide (0.004 mol) through refluxing for 4 hours, followed by cooling. The resultant mixture was filtrated to obtain precipitates. The obtained precipitates were washed sequentially with toluene, ether, acetone and water, followed by drying. Then, the resultant product was recrystallized from chloroform, to thereby obtain calixarene derivative A10 as white needles.

### —Preparation of Calixarene Derivative A10 Dispersion Liquid—

Calixarene derivative A10 (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 6, to thereby produce a calixarene derivative A10 dispersion liquid. The average dispersion diameter of calixarene derivative A10 was found to be 44 nm.

### Production of Toner l

The procedure of Example A1 was repeated, except that calixarene derivative A1 was changed to calixarene derivative A10, to thereby produce toner l.

### Example A13

### Synthesis of Calixarene Derivative A11

Calixarene derivative A11 was synthesized which has a structure expressed by the above General Formula (I) where m+n is 4 to 8, m:n is 1:0, R₁ is a hydrogen atom, R₂ is a methyl group, and each of R₃ to R₅ is a hydrogen atom. First, methylphenol (0.18 mol) and p-formaldehyde (0.30 mol) were dehydrated in xylene using potassium hydroxide (0.004 mol) through refluxing for 4 hours, followed by cooling. The resultant mixture was filtrated to obtain precipitates. The obtained precipitates were washed sequentially with toluene, ether, acetone and water, followed by drying. Then, the resultant product was recrystallized from chloroform, to thereby obtain calixarene derivative A11 as white needles.

### —Preparation of Calixarene Derivative A11 Dispersion Liquid—

Calixarene derivative A11 (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 6, to thereby produce a calixarene derivative A11 dispersion liquid. The average dispersion diameter of calixarene derivative A11 was found to be 42 nm.

### Production of Toner m

The procedure of Example A1 was repeated, except that calixarene derivative A1 was changed to calixarene derivative A11, to thereby produce toner m.

### Example A14

### Synthesis of calixarene derivative A12

Calixarene derivative A12 was synthesized which has a structure expressed by the above General Formula (I) where m+n is 4 to 8, m:n is 1:0, each of R₁ and R₂ is a hydrogen atom, R₃ is a methyl group, and each of R₄ and R₅ is a hydrogen atom. First, methylphenol (0.18 mol) and p-formaldehyde (0.30 mol) were dehydrated in xylene using potassium hydroxide (0.004 mol) through refluxing for 4 hours, followed by cooling. The resultant mixture was filtrated to obtain precipitates. The obtained precipitates were washed sequentially with toluene, ether, acetone and water, followed by drying. Then, the resultant product was recrystallized from chloroform, to thereby obtain calixarene derivative A12 as white needles.

### —Preparation of Calixarene Derivative A12 Dispersion Liquid—

Calixarene derivative A12 (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 6, to thereby produce a calixarene derivative A12 dispersion liquid. The average dispersion diameter of calixarene derivative A12 was found to be 39 nm.

### Production of Toner n

The procedure of Example A1 was repeated, except that calixarene derivative A1 was changed to calixarene derivative A12, to thereby produce toner n.

### Example A15

### Synthesis of calixarene derivative A13

Calixarene derivative A13 was synthesized which has a structure expressed by the above General Formula (I) where m+n is 4 to 8, m:n is 1:0, each of R₁ and R₃ is a hydrogen atom, R₄ is a methyl group, and R₅ is a hydrogen atom. First, methylphenol (0.18 mol) and p-formaldehyde (0.30 mol) were dehydrated in xylene using potassium hydroxide (0.004 mol) through refluxing for 4 hours, followed by cooling. The resultant mixture was filtrated to obtain precipitates. The obtained precipitates were washed sequentially with toluene, ether, acetone and water, followed by drying. Then, the resultant product was recrystallized from chloroform, to thereby obtain calixarene derivative A13 as white needles.

### —Preparation of Calixarene Derivative A13 Dispersion Liquid—

Calixarene derivative A13 (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 6, to thereby produce a calixarene derivative A13 dispersion liquid. The average dispersion diameter of calixarene derivative A13 was found to be 46 nm.

### Production of Toner o

The procedure of Example A1 was repeated, except that calixarene derivative A1 was changed to calixarene derivative A13, to thereby produce toner o.

### Example A16

Calixarene derivative A14 was synthesized which has a structure expressed by the above General Formula (I) where m+n is 4 to 8, m:n is 1:0, each of R₁ and R₄ is a hydrogen atom, and R₅ is a hydrogen atom. First, phenol (0.18 mol) and p-formaldehyde (0.30 mol) were dehydrated in xylene using potassium hydroxide (0.004 mol) through refluxing for 4 hours, followed by cooling. The resultant mixture was filtrated to obtain precipitates. The obtained precipitates were washed sequentially with toluene, ether, acetone and water, followed by drying. Then, the resultant product was recrystallized from chloroform, to thereby obtain calixarene derivative A14 as white needles.

### —Preparation of Calixarene Derivative A14 Dispersion Liquid—

Calixarene derivative A14 (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 6, to thereby produce a calixarene derivative A14 dispersion liquid. The average dispersion diameter of calixarene derivative A14 was found to be 55 nm.

### Production of Toner p

The procedure of Example A1 was repeated, except that calixarene derivative A1 was changed to calixarene derivative A14, to thereby produce toner p.

### Example A17

### Production of Toner q

The procedure of Example A1 was repeated, except that the dispersion diameter of calixarene derivative A1 was changed from 120 nm to 15 nm, to thereby produce toner q. The average dispersion diameter of calixarene derivative A1 was adjusted as follows.

### —Preparation of Calixarene Derivative A1 Dispersion Liquid—

Calixarene derivative A1 (BONTRON E-89, product of ORIENT CHEMICAL INDUSTRIES CO., LTD) (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 8, to thereby produce a calixarene derivative A1 dispersion liquid. The average dispersion diameter of calixarene derivative A1 was found to be 15 nm.

### Comparative Example A1

### Production of Toner r

The procedure of Example A1 was repeated, except that calixarene derivative A1 was changed to TN-105 (zirconium salicylate complex, product of HODOGAYA CHEMICAL CO., LTD.), to thereby produce a toner r.

### Comparative Example A2

### Production of Toner s

The procedure of Example A1 was repeated, except that calixarene derivative A1 was changed to E-84 (zinc salicylate complex, product of ORIENT CHEMICAL INDUSTRIES CO. LTD), to thereby produce a toner s.

Next, each of the toners of Examples A1 to A17 and Comparative Examples A1 and A2 were measured for various properties as follows. The results are shown in Table A2.

### <Volume Average Particle Diameter and Volume Average Particle Diameter/Number Average Particle Diameter>

The volume average particle diameter (Dv) and volume average particle diameter/number average particle diameter (Dv/Dn) were measured with a particle size analyzer (“Multisizer III,” product of Beckman Coulter Co.).

### <Average Circularity>

Into a 100 mL glass beaker, 0.1 mL to 0.5 mL of a 10% by mass surfactant (NEOGEN SC-A, which is an alkylbenzene sulfonate, product of Dai-ichi Kogyo Seiyaku Co., Ltd.) was added, 0.1 g to 0.5 g of the toner was added, the ingredients were stirred using a microspatula, then 80 mL of ion-exchanged water was added. The obtained dispersion liquid was subjected to dispersion treatment for 3 min using an ultrasonic wave dispersing device (manufactured by Honda Electronics Co.). Using a flow-type particle image analyzer (“FPIA-2100,” product of Sysmex Co.), the shape and distribution of toner particles were measured until the dispersion liquid had a concentration of 5,000 (number per μL) to 15,000 (number per μL).

### <BET Specific Surface Area>

According to the BET method, the BET specific surface area of the toner was measured with a specific surface area measuring device (“TRISTAR 3000,” product of SHIMADZU CORPORATION). Specifically, nitrogen gas was adsorbed on the surface of each toner base material (sample), and the specific surface area was measured with the multi point BET method.

TABLE A1

| | | | | | BET specific |
|---|---|---|---|---|---|
| | | | | | surface are |
| | Toner | Dv/μm | Dv/Dn | Circularity | [m² · g⁻¹] |
| Ex. A1 | a | 5.1 | 1.13 | 0.967 | 2.1 |
| Ex. A2 | b | 5.1 | 1.14 | 0.966 | 1.9 |
| Ex. A3 | c | 5.0 | 1.16 | 0.964 | 2.4 |
| Ex. A4 | d | 5.0 | 1.12 | 0.967 | 1.9 |
| Ex. A5 | e | 5.1 | 1.13 | 0.967 | 2.1 |
| Ex. A6 | f | 5.1 | 1.13 | 0.966 | 2.5 |
| Ex. A7 | g | 5.0 | 1.12 | 0.964 | 2.1 |
| Ex. A8 | h | 5.2 | 1.11 | 0.968 | 1.9 |
| Ex. A9 | i | 4.9 | 1.13 | 0.968 | 1.8 |
| Ex. A10 | j | 5.0 | 1.12 | 0.967 | 1.9 |
| Ex. A11 | k | 5.2 | 1.11 | 0.965 | 1.6 |
| Ex. A12 | l | 5.2 | 1.12 | 0.965 | 1.5 |
| Ex. A13 | m | 5.1 | 1.12 | 0.966 | 1.6 |
| Ex. A14 | n | 5.2 | 1.11 | 0.965 | 1.7 |
| Ex. A15 | o | 5.0 | 1.13 | 0.965 | 1.5 |
| Ex. A16 | p | 5.3 | 1.12 | 0.966 | 1.5 |
| Ex. A17 | q | 5.3 | 1.14 | 0.962 | 2.8 |
| Comp. | r | 7.6 | 1.26 | 0.962 | 4.1 |
| Ex. A1 | | | | | |
| Comp. | s | Unable to | — | — | — |
| Ex. A2 | | be formed | | | |
| | | into toner | | | |

### <Durability>

An evaluation machine, which was a modified machine of an image forming apparatus (DocuColor 8000 Digital Press, manufactured by Fuji Xerox Co., Ltd.) and subjected to tuning so that the linear velocity and the transfer time could be adjusted, was provided. Each developer was subjected to a 100,000-sheet running test with the evaluation machine in which a solid image pattern of size A4 at a toner coverage of 0.6 mg/cm² was outputted as a test pattern. Every 1,000-sheet running, the toner was sampled and measured for charge amount with the blow-off method as an index of durability. The initial charge amount of the toner was compared with the post-running charge amount to evaluate durability on the basis of the following criteria.

### [Evaluation Criteria]

A: The charge amount decreased was lower than 3 μc/g
B: The charge amount decreased was 3 μc/g or higher but lower than 5 μc/g
C: The charge amount decreased was 5 μc/g or higher but lower than 10 μc/g
D: The charge amount decreased was 10 μc/g or higher

### <Charging Stability to Environment>

Using a digital full-color copier (product of Ricoh Company, Ltd., imagioColor2800), the toner was sampled every 1,000-sheet running during outputting of 100,000 sheets of an image chart having an image occupation rate of 7% at a monochromatic mode. The thus-sampled toner was measured for charge amount with the blow-off method and evaluated for charging stability according to the following criteria. The evaluation of the charging stability under high-temperature, high-humidity environment was performed at 40° C. and 90% RH. The evaluation of the charging stability under low-temperature, low-humidity environment was performed at 10° C. and 15% RH.

### [Evaluation Criteria]

A: The charge amount changed was lower than 3 μc/g.
B: The charge amount changed was 3 μc/g or higher but lower than 5 μc/g.
C: The charge amount changed was 5 μc/g or higher but lower than 10 μc/g.

D: The charge amount changed was 10 μc/g or higher.

### <Granularity>

Each toner was measured for volume average particle diameter (Dv) and volume average particle diameter/number average particle diameter (Dv/Dn) with a particle size analyzer (“Multisizer III,” product of Beckman Coulter Co.). The Dv was evaluated on the basis of the value 5.2 μm, and also, the Dv/Dn was evaluated.

[Evaluation criteria of Dv]
A: Dv was 5.2 μm±0.1 μm (exclusive)
B: Dv was 5.2 μm±0.1 μm (inclusive) to 0.3 μm (exclusive)
C: Dv was 5.2 μm±0.3 μm (inclusive) to 0.5 μm (exclusive)
D: Dv was 5.2 μm±0.5 μm (inclusive)

### [Evaluation Criteria of Dv/Dn]

### A: Dv/Dn<1.15

### B: 1.15≦Dv/Dn<1.17

### C, 1.18≦Dv/Dn<1.25

### D: 1.25≦Dv/Dn

### <Dispersion Diameter>

Each toner (1 g) was immersed in chloroform (100 g) for 10 hours, and the calixarene derivative dispersion liquid was centrifuged at 5,500 rpm (9,545 g) with a centrifuge (H-9R, product of KOKUSAN CO., LTD., using an angle rotor). The supernatant obtained after centrifugation was found to contain calixarene derivative particles, which were measured for particle diameter with “LA-920” (product of Horiba, Ltd.). In the measurement using LA-920, LA-920 specialized application (Ver 3.32) (product of Horiba, Ltd.) was used for analysis.

TABLE A2

| | Q/M | | | | | | |
|---|---|---|---|---|---|---|---|
| | (Durability) | | Environmental stability | | | | |
| | | Post- | Normal temp., | Low temp., | High temp., | Granularity | |
| | Initial | 100K | normal humidity | low humidity | high humidity | Dv | Dv/Dn |
| Ex. A1 | B | B | B | B | B | A | A |
| Ex. A2 | B | B | B | B | B | A | A |
| Ex. A3 | B | B | B | B | B | A | A |
| Ex. A4 | A | A | A | B | B | A | A |
| Ex. A5 | A | A | A | B | B | A | A |
| Ex. A6 | B | C | B | B | B | A | A |
| Ex. A7 | B | C | B | B | B | A | A |
| Ex. A8 | B | B | B | B | B | A | A |
| Ex. A9 | A | A | A | B | B | A | A |
| Ex. A10 | B | B | B | B | B | A | A |
| Ex. A11 | B | B | B | B | B | A | A |
| Ex. A12 | B | B | B | B | B | A | A |
| Ex. A13 | B | B | B | B | B | A | A |
| Ex. A14 | B | B | B | B | B | A | A |
| Ex. A15 | B | B | B | B | B | A | A |
| Ex. A16 | B | B | B | B | B | A | A |
| Ex. A17 | B | B | B | B | B | A | A |
| Comp. | C | C | C | D | D | D | D |
| Ex. A1 | | | | | | | |
| Comp. | — | — | — | — | — | D | D |
| Ex. A2 | | | | | | | |

TABLE A3

| | | | Q/M (Durability) | | Environmental chrging stability [μCg⁻¹] | | |
|---|---|---|---|---|---|---|---|
| | | | [μCg⁻¹] | | Normal | Low | High |
| | | Dispersion | | Post- | temp., | temp., | temp., |
| | | diameter | | 100,000 | normal | low | high |
| | Toner | (nm) | Initial | running | humidity | humidity | humidity |
| Ex. A1 | a | 120 | −60.3 | −55.5 | −60.3 | −64.5 | −55.7 |
| Ex. A2 | b | 70 | −55.9 | −52.1 | −55.9 | −61.2 | −50.3 |
| Ex. A3 | c | 300 | −63.1 | −58.4 | −63.1 | −68.4 | −57.1 |
| Ex. A4 | d | 45 | −65.1 | −62.4 | −65.1 | −68.2 | −61.3 |
| Ex. A5 | e | 45 | −66.3 | −64.0 | −66.3 | −70.4 | −61.9 |
| Ex. A6 | f | 100 | −56.7 | −50.4 | −56.7 | −60.6 | −51.8 |
| Ex. A7 | g | 120 | −55.8 | −48.4 | −55.8 | −60.0 | −52.1 |
| Ex. A8 | h | 80 | −60.5 | −57.1 | −60.5 | −64.7 | −56.8 |
| Ex. A9 | i | 40 | −68.9 | −66.9 | −68.9 | −72.1 | −66.0 |
| Ex. A10 | j | 37 | −69.2 | −67.4 | −69.2 | −72.1 | −66.0 |
| Ex. A11 | k | 31 | −78.4 | −75.8 | −78.4 | −81.3 | −75.4 |
| Ex. A12 | l | 44 | −50.3 | −47.8 | −50.3 | −53.1 | −46.4 |
| Ex. A13 | m | 42 | −50.8 | −48.2 | −50.8 | −53.5 | −46.9 |
| Ex. A14 | n | 39 | −50.1 | −47.6 | −50.1 | −53.0 | −46.0 |
| Ex. A15 | o | 46 | −51.1 | −48.0 | −51.1 | −53.9 | −47.1 |
| Ex. A16 | p | 55 | −42.5 | −39.6 | −42.5 | −45.2 | −38.8 |
| Ex. A17 | q | 15 | −53.6 | −49.4 | −53.6 | −56.7 | −50.9 |
| Comp. | r | — | −21.5 | −18.7 | −21.5 | −30.1 | −12.4 |
| Ex. A1 | | | | | | | |
| Comp. | s | — | — | — | — | — | — |
| Ex. A2 | | | | | | | |

As is clear from Tables A2 and A3, the toners of Examples A1 to A17 are excellent in granularity, durability and environmental stability. In contrast, toner r of Comparative Example A1 containing TN-105, which has a structure of zirconium salicylate complex, is considerably poor in granularity and surface characteristics, although TN-105 exhibits high chargeability in a pulverized toner. Regarding durability, a change of Q/M is large after 100,000 running. Regarding environmental stability, a change of Q/M is large both under low-temperature, low-humidity environment and high-temperature, high-humidity environment, and no improvement is obtained. Also, toner s of Comparative Example A2 containing E-84, which has a structure of zinc salycilate, is considerably poor in granularity and cannot be formed into toner, although E-84 exhibits high chargeability in a pulverized toner. The toners of Comparative Examples A1 and A2 are inferior to those of Examples A1 to A17 in terms of durability, environmental stability and granularity. This indicates that addition of calixarene at the solution or dispersion liquid-preparing step provides a toner excellent in chargeability, charge rising property, durability and environmental stability.

### Example B1

### Preparation of Solution or Dispersion Liquid of Toner Material

### —Synthesis of Calixarene Derivative—

A calixarene derivative (BONTRON E-89, product of ORIENT CHEMICAL INDUSTRIES CO. LTD) was synthesized which has a structure expressed by the following General Formula (A) where m is 8, R₁ is a hydrogen atom, R₂ is a tert-butyl group, and each of R₃ to R₅ is a hydrogen atom.

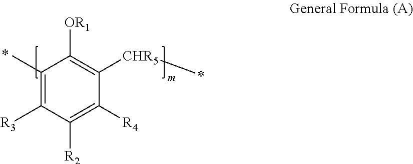

First, p-tert-butylphenol (0.18 mol) and p-formaldehyde (0.30 mol) were dehydrated in xylene using potassium hydroxide (0.004 mol) through refluxing for 4 hours, followed by cooling. The resultant mixture was filtrated to obtain precipitates. The obtained precipitates were washed sequentially with toluene, ether, acetone and water, followed by drying. Then, the resultant product was recrystallized from chloroform, to thereby obtain calixarene derivative A as white needles.

### —Synthesis of Unmodified Polyester A (Low-Molecular-Weight Polyester)—

Into a reaction vessel equipped with a condenser, a stirrer, and a nitrogen-introducing tube, 67 parts by mass of bisphenol A ethyleneoxide (2 mol) adduct, 84 parts by mass of bisphenol A propionoxide (3 mol) adduct, 274 parts by mass of terephthalic acid, and 2 parts by mass of dibutyltin oxide were charged, allowing the resultant mixture to react for 8 hours at 230° C. under normal pressure. Subsequently, the reaction mixture was allowed to react for 5 hours under reduced pressure of 10 mmHg to 15 mmHg, to thereby synthesize unmodified polyester A.

The thus-obtained unmodified polyester A had a number average molecular weight (Mn) of 2,100, a weight average molecular weight of 5,600, and a glass transition temperature (Tg) of 55° C.

### —Preparation of Master Batch A—

1,000 parts by mass of water, 540 parts by mass of carbon black (“Printex 35”; product of Degussa; DBP oil absorption amount: 42 mL/100 g; pH 9.5), and 1,200 parts by mass of unmodified polyester A were mixed by means of HENSCHEL MIXER (product of Mitsui Mining Co., Ltd.). The resultant mixture was kneaded at 150° C. for 30 minutes by a two-roller mill, cold-rolled, and milled by a pulverizer (product of Hosokawa micron Co., Ltd.), to thereby prepare master batch A.

### —Synthesis of Prepolymer A—

Into a reaction vessel equipped with a condenser, a stirrer, and a nitrogen-introducing tube, 682 parts by mass of bisphenol A ethyleneoxide (2 mol) adduct, 81 parts by mass of bisphenol A propionoxide (2 mol) adduct, 283 parts by mass of terephthalic acid, 22 parts by mass of trimellitic anhydride, and 2 parts by mass of dibutyltin oxide were charged, allowing the resultant mixture to react for 8 hours at 230° C. under normal pressure. Subsequently, the reaction mixture was allowed to react for 5 hours under reduced pressure of 10 mmHg to 15 mmHg, to thereby synthesize an intermediate polyester.

The thus-obtained intermediate polyester had a number average molecular weight (Mn) of 2,100, a weight average molecular weight (Mw) of 9,600, a glass transition temperature (Tg) of 55° C., an acid value of 0.5 mgKOH/g, and a hydroxyl group value of 49 mgKOH/g.

Subsequently, into a reaction vessel equipped with a condenser, a stirrer, and a nitrogen-introducing tube, 411 parts by mass of the intermediate polyester, 89 parts by mass of isophorone diisocyanate, and 500 parts by mass of ethyl acetate were charged, allowing the resultant mixture to react for 5 hours at 100° C. to thereby synthesize a prepolymer A (i.e., a polymer reactive with the active hydrogen group-containing compound).

The prepolymer A thus obtained had a free isocyanate content of 1.60% by mass and solid content concentration of 50% by mass (150° C., after being left for 45 minutes).

### <Preparation of Anionic Fine Resin Particles>

Into a reaction vessel equipped with a stirring rod and a thermometer, 683 parts by mass of water, 16 parts by mass of sodium salt of sulfuric acid ester of ethylene oxide adduct of methacrylic acid, Eleminol RS-30 (product of Sanyo Chemical Industries Ltd.), 83 parts by mass of styrene, 83 parts by mass of methacrylic acid, 110 parts by mass of butyl acrylate, and 1 part by mass of ammonium persulfate were charged, and then stirred at 400 rpm for 15 minutes to thereby obtain a white emulsion. The emulsion was heated to a system temperature of 75° C. and was allowed to react for 5 hours. Then, 30 parts by mass of a 1% by mass aqueous ammonium persulfate solution was added to the reaction mixture, followed by aging at 75° C. for 5 hours, to thereby obtain an aqueous dispersion [anionic fine resin particle dispersion liquid A] of a vinyl resin (a copolymer of styrene-methacrylic acid-butyl acrylate-sodium salt of sulfate ester of methacrylic acid-ethylene oxide adduct).

The volume average particle diameter of [anionic fine resin particle dispersion liquid A] was found to be 42 nm, when measured using a particle size distribution analyzer (LA-920, product of Horiba, Ltd.).

### <Solution or Dispersion Liquid-Preparing Step>>

### —Preparation of Calixarene Derivative Dispersion Liquid—

Calixarene derivative A (BONTRON E-89, product of ORIENT CHEMICAL INDUSTRIES CO. LTD) (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 2, to thereby produce a calixarene derivative A dispersion liquid. The median diameter of calixarene derivative A contained in the dispersion liquid was found to be 0.49 μm.

### —Preparation of Toner Material Phase—

The unmodified polyester (100 parts by mass) and ethyl acetate (130 parts by mass) were added to a beaker, followed by dissolving with stirring. Then, carnauba wax (molecular weight=1,800, acid value=2.5, penetration=1.5 mm (40° C.)) (10 parts by mass), the masterbatch (10 parts by mass) and the calixarene derivative A dispersion liquid (in such an amount that 3 parts by mass of calixarene derivative A was contained) were charged into the beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 3, to thereby produce a raw material solution. Further, the binder resin precursor (40 parts by mass) was added thereto, followed by stirring, to thereby a solution or dispersion liquid of the toner material.

### <Emulsion or Dispersion Liquid-Preparing Step>

### —Preparation of Aqueous Medium Phase—

Water (660 parts by mass), the anionic fine particle dispersion liquid (1.25 parts by mass), 25 parts by mass of 48.5% by mass aqueous solution of sodium dodecyldiphenyl ether disulfonate “Eleminol MON-7” (serving as an anionic surfactant, product of Sanyo Chemical Industries Ltd.) and ethyl acetate (60 parts by mass) were mixed together to obtain a milky white liquid (aqueous medium phase).

### —Preparation of Emulsion or Dispersion Liquid A—

The aqueous medium phase (150 parts by mass) was placed in a container, and then stirred at 12,000 rpm with a TK homomixer (product of Tokushu Kika Kogyo Co., Ltd.). Subsequently, the solution or dispersion liquid of the toner material (100 parts by mass) was added to the thus-treated aqueous medium phase, and the resultant mixture was mixed for 10 min to thereby prepare emulsion or dispersion liquid A (emulsified slurry).

### <<Organic Solvent-Removing Step C>>

### —Removal of Organic Solvent—

A flask equipped with a degassing tube, a stirrer, and a thermometer was charged with 100 parts by mass of emulsion or dispersion liquid A (emulsified slurry). The solvent was removed by stirring the emulsified slurry under conditions of stirring circumferential velocity of 20 m/min at 30° C. for 12 hours under reduced pressure to give desolvated slurry A.

### —Washing/Drying—

The whole amount of desolvated slurry A was filtrated under reduced pressure. Then, 300 parts by mass of ion-exchanged water was added to the filter cake, followed by mixing and redispersing with a TK homomixer (at a rotation speed of 12,000 rpm for 10 min) and filtrating. Further, 300 parts by mass of ion-exchanged water was added to the filter cake, followed by mixing with a TK homomixer (at a rotation speed of 12,000 rpm for 10 min) and filtrating. This mixing/filtrating procedure was performed three times. The filter cake thus obtained was dried in a downwind drier at 45° C. for 48 hr. The dried product was sieved through a sieve with 75 μm-mesh opening to give toner base particle A.

### —External Addition Treatment—

Toner base particle A (100 parts by mass) was mixed with 0.6 parts by mass of hydrophobic silica having an average particle diameter of 100 nm, 1.0 part by mass of titanium oxide having an average particle diameter of 20 nm, and 0.8 parts by mass of a fine powder of hydrophobic silica having an average particle diameter of 15 nm with a HENSCHEL MIXER to give toner a of Example B1.

### <Measuring Method for Toner Characteristics>

### —Average Circularity—

The average circularity of the toner is defined by the following equation.

Average circularity X=(Circumferential length of a circle having the same area as projected particle area/Circumferential length of projected particle image)×100(%)

The average circularity of the toner was measured using a flow-type particle image analyzer (“FPIA-2100,” product of Sysmex Co.), and analyzed using an analysis software (FPIA-2100 Data Processing Program For FPIA Version00-10). Specifically, into a 100 mL glass beaker, 0.1 mL to 0.5 mL of a 10% by mass surfactant (NEOGEN SC-A, which is an alkylbenzene sulfonate, product of Dai-ichi Kogyo Seiyaku Co., Ltd.) was added, 0.1 g to 0.5 g of the toner was added, the ingredients were stirred using a microspatula, then 80 mL of ion-exchanged water was added. The obtained dispersion liquid was subjected to dispersion treatment for 3 min using an ultrasonic wave dispersing device (manufactured by Honda Electronics Co.). Using FPIA-2100 mentioned above, the shape and distribution of toner particles were measured until the dispersion liquid had a concentration of 5,000 (number per μL) to 15,000 (number per μL).

### <Charge Amount>

The charge amount of the toner was measured with a V blow-off device (product of RICOH SOZO KAIHATU K.K.). The toner and the carrier were allowed to stand as a developer having a toner concentration of 7% by mass at 40° C. and 70% RH for 2 hours. The developer was then placed in a metallic gauge, followed by mixing with stirring in a stirring device at 285 rpm for 600 sec. One gram of the developer was weighed from 6 g of the initial developer, and the charge amount distribution of the toner was measured by a single mode method with a V blow-off device (product of RICOH SOZO KAIHATU K.K.). At the time of blow, an opening of 635 mesh was used. In the single mode method of the V blow-off device (product of RICOH SOZO KAIHATU K.K.), a single mode is selected according to the instruction manual, and measurement is performed under conditions of height 5 mm, suction 100, and blow twice.

### <Weight Average Particle Diameter (Dw), Volume Average Particle Diameter (Dv) and Number Average Particle Diameter (Dn)>

The weight average particle diameter (Dw), the volume average particle diameter (Dv) and the number average particle diameter (Dn) of the toner can be measured as follows. Specifically, using a particle size analyzer (“Multisizer III,” product of Beckman Coulter Co.) with the aperture diameter being set to 100 μm, and the obtained measurements were analyzed with an analysis software (Beckman Coulter Multisizer 3 Version 3.51). More specifically, a 10% by mass surfactant (alkylbenzene sulfonate, Neogen SC-A, product of Daiichi Kogyo Seiyaku Co.) (0.5 mL) was added to a 100 mL-glass beaker, and a toner sample (0.5 g) was added thereto, followed by stirring with a microspartel. Subsequently, ion-exchange water (80 mL) was added to the beaker, and the obtained dispersion liquid was dispersed with an ultrasonic wave disperser (W-113MK-II, product of Honda Electronics Co.) for 10 min. The resultant dispersion liquid was measured using the above Multisizer III and Isoton III (product of Beckman Coulter Co.) serving as a solution for measurement. The dispersion liquid containing the toner sample was dropped so that the concentration indicated by the meter fell within a range of 8%±2%.

### —Median Diameter of Calixarene Derivative—

The particle distribution of the calixarene derivative contained in the toner was measured as follows. Specifically, the toner (1 g) was immersed in chloroform (100 g) for 10 hours, and the calixarene derivative dispersion liquid was centrifuged at 5,500 rpm (9,545 g) with a centrifuge (H-9R, product of KOKUSAN CO., LTD., using an LN angle rotor). The supernatant obtained after centrifugation was found to contain calixarene derivative particles, which were measured for particle diameter with “LA-920” (product of Horiba, Ltd.). In the measurement using LA-920, LA-920 specialized application (Ver 3.32) (product of Horiba, Ltd.) was used for analysis. Specifically, the optical axis was adjusted with chloroform and then background was measured. Thereafter, circulation was initiated and the calixarene derivative dispersion liquid was dropped. After it had been confirmed that the transmittance was stable, ultrasonic wave was applied under the following conditions. After application of ultrasonic wave, the diameter of particles dispersed was measured so that the transmittance fell within a range of 70% to 95%.

Measurement/analysis conditions are set as follows.

Number of inputs of data: 15 times
Relative refractive index: 1.20

### Circulation: 5

Intensity of ultrasonic wave: 7

### —Tem Observation of Calixarene Derivative Contained in Toner—

The state of the calixarene derivative present in the toner was observed as follows. Specifically, the toner particles were stained for 3 min by being exposed to vapor of aqueous ruthenium oxide, and then left to stand in air for 30 min. Subsequently, the toner particles were wrapped with an epoxy resin curable within 30 min. Then, the obtained sample was cut with an ultramicrotome so as to have a thickness of 80 nm, and with a diamond knife (Ultra Sonic 35) at a cutting speed of 0.4 mm/sec. The thus-cut section was fixed on a collodion membrane mesh, and observed under JEM-2100F (product of JEOL Ltd., TEM) with the light-field method under the conditions: acceleration voltage: 200 kV, SpotSize3, CL AP1, OL AP3.

### Example B2

The procedure of Example B1 was repeated, except that the median diameter of calixarene derivative A was changed from 0.49 μm to 0.05 μm, to thereby produce toner b of Example B2. The median diameter of calixarene derivative A was adjusted as follows. Specifically, calixarene derivative A (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 5, to thereby produce a calixarene derivative A dispersion liquid.

Through observation of the cross-section of toner b of Example B2 under a TEM, the calixarene derivative was found to be localized in the vicinity of the toner surface in a larger amount than in the toner of Example B1. The average circularity X of the toner was found to be 0.962, indicating that the deformation effect was superior to that in toner a of Example B1. Thus, toner b was found to have sufficient cleaning performance to overcome existing problems. Also, the charge amount of the toner was found to be −40.3 μC/g, which was higher than that of toner a of Example B1.

### Example B3

The procedure of Example B1 was repeated, except that the median diameter of calixarene derivative A was changed from 0.49 μm to 0.68 μm, to thereby produce toner c of Example B3. The median diameter of calixarene derivative A was adjusted as follows. Specifically, calixarene derivative A (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 2, to thereby produce a calixarene derivative A dispersion liquid.

Through observation of the cross-section of toner c of Example B3 under a TEM, the calixarene derivative was found to be localized in the vicinity of the toner surface in a smaller amount than in the toner of Example B1. The average circularity X of the toner was found to be 0.970, indicating that the deformation effect was slightly inferior to that in toner a of Example B1 but was not practically problematic. Thus, toner c was found to have sufficient cleaning performance to overcome existing problems. Also, the charge amount of the toner was found to be −36.5 μC/g, which was slightly lower than that of toner a of Example B1 but not practically problematic.

### Example B4

### Synthesis of Calixarene Derivative B

Calixarene derivative B was synthesized which has a structure expressed by the following General Formula (A) where m is 4 to 8, R₁ is a hydrogen atom, R₂ is a methoxy group, and each of R₃ to R₅ is a hydrogen atom.

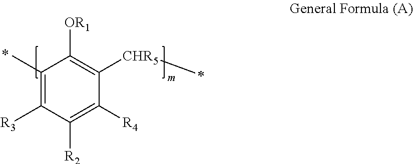

First, p-methoxyphenol (0.18 mol) and p-formaldehyde (0.30 mol) were dehydrated in xylene using potassium hydroxide (0.004 mol) through refluxing for 4 hours, followed by cooling. The resultant mixture was filtrated to obtain precipitates. The obtained precipitates were washed sequentially with toluene, ether, acetone and water, followed by drying. Then, the resultant product was recrystallized from chloroform, to thereby obtain calixarene derivative B as white needles.

The procedure of Example B1 was repeated, except that calixarene derivative A was changed to calixarene derivative B, to thereby produce toner d of Example B4. Note that the median diameter of calixarene derivative B contained in the obtained dispersion liquid was found to be 0.43 μm.

Through observation of the cross-section of toner d of Example B4 under a TEM, the calixarene derivative was found to be localized in the vicinity of the toner surface in a smaller amount than in toner a of Example B1. The average circularity X of the toner was found to be 0.969, indicating that the deformation effect was slightly inferior to that in toner a of Example B1 but not practically problematic. Thus, toner d was found to have sufficient cleaning performance to overcome existing problems. Also, the charge amount of the toner was found to be −25.1 μC/g, which was slightly lower than that of toner a of Example B1.

### Example B5

The procedure of Example B1 was repeated, except that the calixarene derivative A dispersion liquid was used in such an amount that 5 parts by mass of calixarene derivative A was contained rather than 3 parts by mass calixarene derivative A was contained, to thereby produce toner e of Example B5. Note that the median diameter of calixarene derivative A contained in the obtained dispersion liquid was found to be 0.43 μm.

Through observation of the cross-section of toner e of Example B5 under a TEM, the calixarene derivative was found to be localized in the vicinity of the toner surface in a larger amount than in toner a of Example B1. The average circularity X of the toner was found to be 0.962, indicating that the deformation effect was superior to that in toner a of Example B1. Thus, toner e was found to have sufficient cleaning performance to overcome existing problems. Also, the charge amount of the toner was found to be −42.9 μC/g, which was slightly higher than that of toner a of Example B1.

### Example B6

The procedure of Example B1 was repeated, except that the calixarene derivative A dispersion liquid was used in such an amount that 0.1 parts by mass of calixarene derivative A was contained rather than 3 parts by mass calixarene derivative A was contained, to thereby produce toner f of Example B6. Note that the median diameter of calixarene derivative A contained in the obtained dispersion liquid was found to be 0.43 μm.

Through observation of the cross-section of toner f of Example B6 under a TEM, the calixarene derivative was found to be localized in the vicinity of the toner surface in a smaller amount than in toner a of Example B1. The average circularity X of the toner was found to be 0.969, indicating that the deformation effect was slightly inferior to that in toner a of Example B1 but not practically problematic. Thus, toner f was found to have sufficient cleaning performance to overcome existing problems. Also, the charge amount of the toner was found to be −31.5 μC/g, which was slightly lower than that of toner a of Example B1.

### Comparative Example B1

The procedure of Example B1 was repeated, except that no calixarene derivative A was added, to thereby produce toner g of Comparative Example B1.

The average circularity X of toner g of Comparative Example B1 was found to be 0.986; i.e., not deformed, indicating that toner g was not likely to have improved cleaning performance. Also, the charge amount of the toner was found to be −10.0 μC/g and considerably inferior to that of toner a of Example B1, indicating that toner g was not likely to have improved charging property.

### Comparative Example B2

The procedure of Example B1 was repeated, except that the median diameter of calixarene derivative A was changed from 0.49 μm to 0.01 μm, to thereby produce toner h of Comparative Example B2. In Comparative Example B2, the median diameter of the calixarene derivative was adjusted as follows. Specifically, calixarene derivative A (BONTRON E-89, product of ORIENT CHEMICAL INDUSTRIES CO. LTD) (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 7, to thereby produce a calixarene derivative A dispersion liquid.

Through observation of the cross-section of toner h of Comparative Example B2 under a TEM, the calixarene derivative was found to be localized in the vicinity of the toner surface in a larger amount. The average circularity X of the toner was found to be 0.947, indicating that the deformation effect was superior to that in toner a of Example B1. Thus, toner h was found to have sufficient cleaning performance to overcome existing problems. Toner h, however, involved degraded image evenness upon development and reduction in toner transfer efficiency. Thus, toner h was likely to exhibit improved image quality. The charge amount of the toner was found to be −41.1 μC/g, which was higher than that of toner a of Example B1.

### Comparative Example B3

The procedure of Example B1 was repeated, except that the median diameter of calixarene derivative A was changed from 0.49 μm to 0.96 μm, to thereby produce toner i of Comparative Example B3. In Comparative Example B3, the median diameter of the calixarene derivative was adjusted as follows. Specifically, calixarene derivative A (BONTRON E-89, product of ORIENT CHEMICAL INDUSTRIES CO. LTD) (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 1, to thereby produce a calixarene derivative A dispersion liquid.

Through observation of the cross-section of toner i of Comparative Example B3 under a TEM, the calixarene derivative was found to be localized in the vicinity of the toner surface in a smaller amount than in toner a of Example B1. The average circularity X of the toner was found to be 0.984; i.e., not deformed, indicating that toner h was not likely to have improved cleaning performance. The charge amount of the toner was found to be −37.6 μC/g, which was slightly inferior to that of toner a of Example B1 but not practically problematic.

### Comparative Example B4

Toner base particle a (100 parts by mass) was mixed with calixarene derivative A (1.0 part by mass) by means of HENSCHEL MIXER, to thereby produce toner j of Comparative Example B4.

The average circularity of toner j of Comparative Example B4 was found to be 0.987; i.e., not deformed, indicating that toner j was likely to have improved cleaning performance. The charge amount of the toner was found to be −40.1 μC/g, which was comparable to that of the toner of Example B1. Toner j, however, exhibited the minimum fixing temperature lowered by 10° C., and thus was not likely to have improved fixing property.

The following Table B1 shows properties of the toners obtained in Examples B1 to B6 and Comparative Examples B1 to B4.

TABLE B1

| | | | Calixarene | | |
|---|---|---|---|---|---|
| | | | | Amount of toner | Charge |
| | | Average | Median | localized in | amount |
| | Toner | circularity | diameter/μm | surface | μCg⁻¹ |
| Ex. B1 | a | 0.967 | 0.49 | Large amount | −38.6 |
| Ex. B2 | b | 0.962 | 0.05 | Large amount | −40.3 |
| Ex. B3 | c | 0.970 | 0.68 | Small amount | −36.5 |
| Ex. B4 | d | 0.969 | 0.43 | Small amount | −25.1 |
| Ex. B5 | e | 0.962 | 0.43 | Large amount | −42.9 |
| Ex. B6 | f | 0.969 | 0.43 | Small amount | −31.5 |
| Comp. | g | 0.986 | — | — | −10.0 |
| Ex. B1 | | | | | |
| Comp. | h | 0.947 | 0.01 | Large amount | −41.1 |
| Ex. B2 | | | | | |
| Comp. | i | 0.984 | 0.96 | Small amount | −37.6 |
| Ex. B3 | | | | | |
| Comp. | j | 0.987 | — | — | −40.1 |
| Ex. B4 | | | | | |

### <Production of Carrier>

Next, description will be given to the production example of a carrier used for the evaluation of each toner in an actual image forming apparatus.

### —Materials of Carrier—

Acrylic resin solution (solid content: 50% by mass): 21.0 parts by mass Guanamine solution (solid content: 70% by mass): 6.4 parts by mass Alumina particles [0.3 μm, specific resistance: 10″ (Ω·cm)]: 7.6 parts by mass

Silicone resin solution: 65.0 parts by mass
[solid content: 23% by mass (SR2410: product of Dow Corning Toray Silicone Co., Ltd.)]
Aminosilane: 1.0 part by mass
[solid content: 100% by mass (SH6020: product of Dow Corning Toray Silicone Co., Ltd.)]
Toluene: 60 parts by mass
Butyl cellosolve: 60 parts by mass

The materials for the carrier were dispersed with a homomixer for 10 min to give a coating film-forming solution of the acrylic resin and the silicone resin containing the alumina particles.

The coating film-forming forming solution was applied onto the surface of fired ferrite powder [(MgO)_{1.8}(MnO)_{49.5}(Fe₂O₃)_{48.0}: volume average particle diameter: 25 μm] serving as a core material so as to have a thickness of 0.15 μm with SPILA COATER (product of OKADA SEIKO CO., LTD.), followed by drying, to thereby give coated ferrite powder.

The coated ferrite powder was allowed to stand in an electric furnace at 150° C. for one hour for firing. After cooling, the ferrite powder bulk was disintegrated with a sieve with an opening of 106 μm to give carrier A.

Regarding the measurement of the thickness of the binder resin film, since the coating film covering the surface of the carrier could be observed by observing the cross-section of the carrier under a transmission electron microscope, the average value of the film thickness was determined as the film thickness. Note that carrier A was found to have a weight average particle diameter of 35 μm.

### <Measuring Method for Characteristics of Carrier>

### —Weight Average Particle Diameter—

The weight average particle diameter of the carrier was calculated on the basis of the particle size distribution of the particles measured on a number basis; i.e., the relation between the number based frequency and the particle diameter. In this case, the weight average particle diameter is expressed by Equation (1);

Dw={1/Σ(nD³)}×{Σ(nD⁴)} Equation (1)

where D represents a typical particle diameter (μm) of particles present in each channel, and “n” represents the total number of particles present in each channel. It should be noted that each channel is a length for equally dividing the range of particle diameters in the particle size distribution chart, and 2 μm was employed for each channel in the present invention. For the typical particle diameter of particles present in each channel, the lower limit value of particle diameters of the respective channels was employed.

For a particle size analyzer used for measuring the particle size distribution, a micro track particle size analyzer (Model HRA9320-X100, product of Honewell Co.) was used. The evaluation conditions were as follows.

(1) Scope of particle diameters: 8 μm to 100 μm
(2) Channel length (width): 2 μm
(3) Number of channels: 46
(4) Refraction index: 2.42

### Examples B7 to B12 and Comparative Examples B5 to B8

### Production of Two-Component Developer

Carrier A (100 parts by mass) was homogeneously mixed for charging with each (7 parts by mass) of toners a to j of Examples B1 to B6 and Comparative Examples B1 to B4 using a tubular mixer including a container that was tumbled for stirring, to thereby produce two-component developers a to j of Examples B7 to B12 and Comparative Examples B5 to B8. Note that the two-component developers a to j were prepared respectively from the toner a to j.

### [Evaluation of Toner]

### <Cleaning Performance>

The cleaning performance was evaluated as follows. After printing of 100 sheets of A4 size using imagioNeo 450 (product of Ricoh Company, Ltd.), toner remaining on the photoconductor, which had undergone a cleaning step, was transferred onto a blank paper sheet with a piece of scotch tape (product of Sumitomo 3M Ltd.). The blank paper was measured for its density with a MacBeth reflective densitometer model RD514. The difference between the obtained value and the blank value was calculated, and the cleaning performance was evaluated according to the following criteria. Note that rank 5 is considered “pass.” The results are shown in Table B2.

### [Evaluation Criteria]

Rank 5: The difference was lower than 0.01.
Rank 4: The difference was 0.01 or higher but lower than 0.02.
Rank 3: The difference was 0.02 or higher but lower than 0.03.
Rank 2: The difference was 0.03 or higher but lower than 0.04.
Rank 1: The difference was 0.04 or higher.

### (Charging Property)

The charge amount of the toner was measured with a V blow-off device (product of RICOH SOZO KAIHATU K.K.). The two-component developers a to j were allowed to stand as a developer having a toner concentration of 7% by mass at 40° C. and 70% RH for 2 hr. Each developer was then placed in a metallic gauge, followed by mixing with stirring in a stirring device at 285 rpm for 600 sec. One gram of the developer was weighed from 6 g of the initial developer, and the charge amount of the toner was measured by a single mode method. The charging property was evaluated according to the following criteria on the basis of the difference between the charge amount of each sample and a sample containing no calixarene derivative. The results are shown in Table B2.

### [Evaluation Criteria]

A: The difference was 30.0 μC/g or higher.
B: The difference was 20.0 μC/g to 29.9 μC/g.
C: The difference was 19.9 μC/g or lower.

### (Image Quality)

Using an image forming apparatus (imagioColor2800, product of Ricoh Company, Ltd.), a monochromatic photograph image was output and visually evaluated for graininess and sharpness according to the following evaluation criteria.

A: The image had graininess and sharpness comparable to those obtained through offset printing.
B: The image had the same graininess and sharpness as those of a conventional image; i.e., could not have graininess and sharpness comparable to those obtained through offset printing. The results are shown in Table B2.

TABLE B2

| | | Cleaning property | | Charging property | | |
|---|---|---|---|---|---|---|
| | Two-component | | Average | | Charge | Image |
| | developer | Rank | circularity | Evaluation | amount/μCg⁻¹ | quality |
| Ex. B7 | a | 5 | 0.967 | A | −38.6 | A |
| Ex. B8 | b | 5 | 0.962 | A | −40.3 | A |
| Ex. B9 | c | 5 | 0.970 | A | −36.5 | A |
| Ex. B10 | d | 5 | 0.969 | B | −25.1 | A |
| Ex. B11 | e | 5 | 0.962 | A | −42.9 | A |
| Ex. B12 | f | 5 | 0.969 | A | −31.5 | A |
| Comp. | g | 1 | 0.986 | C | −10.0 | B |
| Ex. B5 | | | | | | |
| Comp. | h | 5 | 0.947 | A | −41.1 | B |
| Ex. B6 | | | | | | |
| Comp. | i | 2 | 0.982 | A | −37.6 | B |
| Ex. B7 | | | | | | |
| Comp. | j | 1 | 0.987 | A | −40.1 | B |
| Ex. B8 | | | | | | |

### Examples C1 to C7 and Comparative Examples C1 to C5

In the same manner as in Example A1, “Synthesis of unmodified polyester (low-molecular-weight polyester),” “Preparation of masterbatch (MB),” “Synthesis of prepolymer,” and “Preparation of fine resin particles” were performed.

### (Production of Toner)

### —Preparation of Dispersions of Compounds A and B—

Each compound A (calixarene derivative) shown in Table C1 or halogen-free compound B (5 parts by mass), the above unmodified polyester (15 parts by mass) and ethyl acetate (30 parts by mass) were charged into a beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 3, to thereby produce a compound A or B dispersion liquid. The average particle diameter (dispersion diameter) of compound A contained in the compound A dispersion liquid was found to be 500 nm or smaller. Also, the average particle diameter of compound B contained in the compound B dispersion liquid was found to be 500 nm or smaller.

TABLE C1
Compound A and comparative compound B

| Com- | Sub- | Sub- | Composi- | | Dispersion |
|---|---|---|---|---|---|
| pound | stituent | stituent | tional | | diameter |
| A | R2 | R12 | ratio m:n | m + n | (nm) |
| A1 | CH₃ | F | 3:1 | 6.5 | 150 |
| A2 | t-Bu | 4BF | 4:1 | 6.8 | 120 |
| A3 | Ph | 4BF | 4:1 | 7.6 | 90 |
| A4 | — | 4BF | 0:1 | 7.1 | 210 |
| A5 | t-Bu | CF₃ | 1:1 | 7.5 | 180 |
| B | — | t-Bu | 0:1 | 7.7 | 130 |

In the following General Formula (I), the substituents other than R₂ and R₁₂ are a hydrogen atom. Also, the sum of m+n was determined by the LC-MS method. Specifically, the average molecular weight was obtained from the average value of the peak area, and divided by the average molecular weight of the units estimated from the compositional ratio.

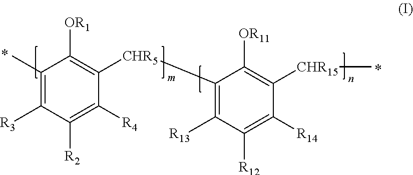

TABLE C2
Explanation of abbreviations

| | |
|---|---|
| CH₃ | Methyl group |
| F | Fluoro group |
| t-Bu | Tertiary butyl group |
| Ph | Phenyl group |
| 4BF | 4-Bromophenyl group |
| CF₃ | Trifluoromethyl group |

### —Preparation of Toner Material Phase—

The unmodified polyester (100 parts by mass) and ethyl acetate (130 parts by mass) were added to a beaker, followed by dissolving with stirring. Then, carnauba wax (molecular weight=1,800, acid value=2.5, penetration=1.5 mm (40° C.)) (10 parts by mass), the masterbatch (10 parts by mass), the compound A or B dispersion liquid (1 part by mass) and isophoronediamine (whose amount is shown in Table C3) were charged into the beaker. The resultant mixture was treated with a bead mill (“Ultra Viscomill,” product of AIMEX CO., Ltd.) under the conditions: liquid-feeding rate: 1 kg/hr; disc circumferential speed: 6 m/sec; amount of 0.5 mm-zirconia beads charged: 80% by volume; and pass time: 3, to thereby produce a raw material solution. Further, the prepolymer (40 parts by mass) was added thereto, followed by stirring, to thereby a solution or dispersion liquid of the toner material.

### —Preparation of Aqueous Medium Phase—

Water (660 parts by mass), the fine resin particle dispersion liquid (1.25 parts by mass), 25 parts by mass of 48.5% by mass aqueous solution of sodium dodecyldiphenyl ether disulfonate “Eleminol MON-7” (product of Sanyo Chemical Industries Ltd.) and ethyl acetate (60 parts by mass) were mixed together to obtain a milky white liquid (aqueous phase).

### —Preparation of Emulsion or Dispersion Liquid—

The aqueous medium phase (150 parts by mass) was placed in a container, and then stirred with a TK homomixer (product of Tokushu Kika Kogyo Co., Ltd.) at a rotation per minute shown in Table C3. Subsequently, the solution or dispersion liquid of the toner material (100 parts by mass) was added to the thus-treated aqueous medium phase, and the resultant mixture was mixed for 10 min to thereby prepare emulsion or dispersion liquid (emulsified slurry). Ten minutes after, a small amount of the emulsified slurry was sampled and then immediately diluted with an excess amount of ion-exchanged water. The resultant mixture was measured for particle diameter Dw1 (Dw immediately before completion of emulsification).

### —Removal of Organic Solvent—

A flask equipped with a degassing tube, a stirrer, and a thermometer was charged with 100 parts by mass of the emulsified slurry. The solvent was removed by stirring the emulsified slurry under conditions of stirring circumferential velocity of 20 m/min at 30° C. for 12 hours under reduced pressure to give a desolvated slurry. A small amount of the obtained slurry was sampled and then diluted with an excess amount of ion-exchanged water. The resultant mixture was measured for particle diameter Dw2 (Dw after toner formation).

### —Washing/Drying—

The whole amount of the desolvated slurry was filtrated under reduced pressure. Then, 300 parts by mass of ion-exchanged water was added to the filter cake, followed by mixing and redispersing with a TK homomixer (at a rotation speed of 12,000 rpm for 10 min) and filtrating. Thereafter, 300 parts by mass of ion-exchanged water was added to the filter cake, followed by mixing with a TK homomixer (at a rotation speed of 3,000 rpm for 10 min) and filtrating, which mixing/filtrating was performed three times. The filter cake thus obtained was dried in a downwind drier at 45° C. for 48 hr. The dried product was sieved through a sieve with 75 μm-mesh opening to give toner base particles.

### —External Addition Treatment—

Toner base particle a (100 parts by mass) was mixed with 0.6 parts by mass of hydrophobic silica having an average particle diameter of 100 nm, 1.0 part by mass of titanium oxide having an average particle diameter of 20 nm, and 0.8 parts by mass of a fine powder of hydrophobic silica having an average particle diameter of 15 nm with a HENSCHEL MIXER to give a toner.

The properties of the toners obtained in Examples C1 to C7 and Comparative Examples C1 to C5 are shown in Tables C3 and C4.

TABLE C3

| | | Amount of | | | | |
|---|---|---|---|---|---|---|
| | | diamine | Emulsification | | | |
| | Compound A | % by mass | speed rpm | Dw1 μm | Dw2 μm | ΔDw |
| Ex. C1 | A1 | 0 | 8,000 | 4.3 | 5.2 | 0.9 |
| Ex. C2 | A1 | 0.1 | 8,000 | 4.9 | 5.4 | 0.5 |
| Ex. C3 | A1 | 0.5 | 8,000 | 5.1 | 5.3 | 0.2 |
| Comp. | A1 | 0 | 12,000 | 4.1 | 5.4 | 1.3 |
| Ex. C1 | | | | | | |
| Ex. C4 | A2 | 0.3 | 8,000 | 4.9 | 5.3 | 0.4 |
| Comp. | A2 | 0 | 13,000 | 4.2 | 5.3 | 1.1 |
| Ex. C2 | | | | | | |
| Ex. C5 | A3 | 0.3 | 8,000 | 4.8 | 5.1 | 0.3 |
| Comp. | A3 | 0 | 12,000 | 4.1 | 5.3 | 1.2 |
| Ex. C3 | | | | | | |
| Ex. C6 | A4 | 0.2 | 8,000 | 4.7 | 5 | 0.3 |
| Ex. C7 | A5 | 0.4 | 8,000 | 4.9 | 5.1 | 0.2 |
| Comp. | B | 0.2 | 8,000 | 4.9 | 5.2 | 0.3 |
| Ex. C4 | | | | | | |
| Comp. | — | 0.2 | 8,000 | 5.1 | 5.3 | 0.2 |
| Ex. C5 | | | | | | |

TABLE C4

| | Weight | | | BET | Volume |
|---|---|---|---|---|---|
| | average | | | surface | specific |
| | particle | | Average | area | resistance |
| | diameter (μm) | Dw/Dn | circularity | (m²/g) | (logΩ cm) |
| Ex. C1 | 5.2 | 1.14 | 0.965 | 1.53 | 11.2 |
| Ex. C2 | 5.1 | 1.13 | 0.955 | 1.44 | 11.3 |
| Ex. C3 | 5.2 | 1.13 | 0.960 | 1.54 | 11.2 |
| Comp. | 5.3 | 1.15 | 0.950 | 1.63 | 11.2 |
| Ex. C1 | | | | | |
| Ex. C4 | 5.0 | 1.14 | 0.965 | 1.52 | 11.2 |
| Comp. | 5.1 | 1.15 | 0.960 | 1.58 | 11.1 |
| Ex. C2 | | | | | |
| Ex. C5 | 5.3 | 1.13 | 0.955 | 1.43 | 11.2 |
| Comp. | 5.1 | 1.14 | 0.950 | 1.64 | 11.2 |
| Ex. C3 | | | | | |
| Ex. C6 | 5.2 | 1.14 | 0.950 | 1.58 | 11.3 |
| Ex. C7 | 5.2 | 1.15 | 0.960 | 1.68 | 11.2 |
| Comp. | 5.3 | 1.16 | 0.970 | 1.48 | 11.1 |
| Ex. C4 | | | | | |
| Comp. | 5.2 | 1.15 | 0.965 | 1.55 | 11.2 |
| Ex. C5 | | | | | |

### <Production of Carrier>

Next, description will be given to the production example of a carrier used for the evaluation of each toner in an actual image forming apparatus. The carrier usable in the present invention is not limited thereto.

### —Carrier—

Acrylic resin solution (solid content: 50% by mass): 21.0 parts by mass
Guanamine solution (solid content: 70% by mass): 6.4 parts by mass
Alumina particles [0.3 μm, specific resistance: 10¹⁴ (Ω·cm)]: 7.6 parts by mass
Silicone resin solution: 65.0 parts by mass
[solid content: 23% by mass (SR2410: product of Dow Corning Toray Silicone Co., Ltd.)]
Aminosilane: 1.0 part by mass
[solid content: 100% by mass (SH6020: product of Dow Corning Toray Silicone Co., Ltd.)]
Toluene: 60 parts by mass
Butyl cellosolve: 60 parts by mass

The materials for the carrier were dispersed with a homomixer for 10 min to give a coating film-forming solution of the acrylic resin and the silicone resin containing the alumina particles. The coating film-forming forming solution was applied onto the surface of fired ferrite powder [(MgO)_{1.8}(MnO)_{49.5}(Fe₂O₃)_{48.0}: volume average particle diameter: 25 μm] serving as a core material so as to have a thickness of 0.15 μm with SPILA COATER (product of OKADA SEIKO CO., LTD.), followed by drying, to thereby give coated ferrite powder. The coated ferrite powder was allowed to stand in an electric furnace at 150° C. for one hour for firing. After cooling, the ferrite powder bulk was disintegrated with a sieve with an opening of 106 μm to give carrier A. Regarding the measurement of the thickness of the binder resin film, since the coating film covering the surface of the carrier could be observed by observing the cross-section of the carrier under a transmission electron microscope, the average value of the film thickness was determined as the film thickness. Note that carrier A was found to have a weight average particle diameter of 35 μm.

### [Preparation of Two-Component Developer]

Carrier A (100 parts by mass) was homogeneously mixed for charging with each (7 parts by mass) of the toners using a tubular mixer including a container that was tumbled for stirring, to thereby produce two-component developers.

### [Evaluation of Toner]

An evaluation machine, which was a modified machine of a digital full-color copier imagioColor2800 (product of Ricoh Company, Ltd.) and subjected to tuning so that the linear velocity and the transfer time could be adjusted, was provided. This digital full-color copier includes a primary transfer unit configured to transfer a toner image from an electrophotographic photoconductor to an intermediate transfer member, a secondary transfer unit configured to transfer the toner image from the intermediate transfer member to a recording medium, and a fixing unit configured to fix the toner image on the recording medium with a heat and pressure-applying member. Each developer was subjected to a running test with the evaluation machine in which a solid image pattern of size A4 at a toner coverage of 0.6 mg/cm² was outputted as a test pattern. The developer was sampled at an initial state or after outputting of 100,000 sheets of the test image (after 100 K), and the sample was measured for charge amount by the following method. And, the charge amount of the toner at an initial state (initial charge amount) was compared with the charge amount of the toner after outputting of 100,000 sheets (post-100 K charge amount), to thereby evaluate durability of the toner. The results are shown in Table C5.

### —Initial Charge Amount and Post-100 K Charge Amount (Charge Amount of Developer in Actual Machine)—

The initial charge amount and the post-100K charge amount were measured with a blow-off device (product of RICOH SOZO KAIHATU K.K.). One gram of the developer was sampled from the copier, and the charge amount distribution of the toner was measured by a single mode method with a blow-off device (product of RICOH SOZO KAIHATU K.K.). At the time of blow, an opening of 635 mesh was used. In the single mode method of the blow-off device (product of RICOH SOZO KAIHATU K.K.), a single mode is selected according to the instruction manual, and measurement is performed under conditions of height 5 mm, suction 100, and blow twice.

### (Charging Stability to Environment)

The saturated charge amount of the toner was measured with a blow-off device (product of RICOH SOZO KAIHATU K.K.). The toner and the carrier were allowed to stand as a developer having a toner concentration of 7% by mass at predetermined environment (temperature and humidity) for 2 hr. The developer was then placed in a metallic gauge, followed by mixing with stirring in a stirring device at 285 rpm for 60 sec or 600 sec. One gram of the developer was weighed from 6 g of the initial developer, and the charge amount distribution of the toner was measured by a single mode method with a blow-off device (product of RICOH SOZO KAIHATU K.K.). At the time of blow, an opening of 635 mesh was used. In the single mode method of the blow-off device (product of RICOH SOZO KAIHATU K.K.), a single mode was selected according to the instruction manual, and measurement is performed under conditions of height 5 mm, suction 100, and blow twice.

The evaluation of the charging stability under high-temperature, high-humidity environment (HH) was performed at 40° C. and 90% RH. The evaluation of the charging stability under low-temperature, low-humidity environment (LL) was performed at 10° C. and 15% RH

A change between both environments (%) was obtained as follows. Specifically, the differences between the charge amount under HH and that under LL were obtained and averaged. The results are shown in Table C5.

### (Surface Position Through Elemental Mapping)

The position of compound A in the toner was confirmed through halogen mapping by EDS of the cross-sectional SEM. The rate of compound A existing in an internal region within 1 μm from the uppermost surface was calculated by determining, through image processing, the areas occupied with the halogen atoms detected in the cross-sectional SEM image through halogen mapping by EDS. The obtained value was used to calculate the ratio of the areas occupied with the halogen atoms present in an internal region within 1 μm from the uppermost surface to all the areas occupied with the halogen atoms detected. This measurement was performed on 10 toner particles, and the measurements were averaged. The results are shown in Table C5.

Surface localization: 90% or higher of compound A exists in an internal region within 1 μm from the uppermost surface of the toner particle; i.e., do not virtually exist in the vicinity of the core of the toner particle.

Internal dispersion: Compound A is entirely dispersed in the toner particle; i.e., exists in the vicinity of the core of the toner particle.

The results are shown in Table C5.

Notably, since compound B used in Comparative Example C4 contains no halogen atom, compound B could not be detected through elemental mapping. However, through SEM observation of the toner, compound B was found to adhere on the uppermost surface of the toner particle as aggregates having a size of several micrometers.

TABLE C5

| | Initial | Post-100K | Charge | Charge | Change | |
|---|---|---|---|---|---|---|
| | charge | charge | amount | amount | in charge | |
| | amount | amount | (HH) | (LL) | amount | Surface position by |
| Example | (μC/g) | (μC/g) | (μC/g) | (μC/g) | (%) | elemental mapping |
| Ex. C1 | 45 | 39 | 32 | 50 | 44 | Surface localization |
| Ex. C2 | 43 | 40 | 34 | 49 | 36 | Surface localization |
| Ex. C3 | 48 | 48 | 43 | 55 | 24 | Surface localization |
| Comp. | 48 | 25 | 22 | 62 | 95 | Internal dispersion |
| Ex. C1 | | | | | | |
| Ex. C4 | 39 | 38 | 35 | 43 | 21 | Surface localization |
| Comp. | 41 | 16 | 20 | 56 | 95 | Internal dispersion |
| Ex. C2 | | | | | | |
| Ex. C5 | 52 | 53 | 50 | 58 | 15 | Surface localization |
| Comp. | 48 | 20 | 24 | 60 | 86 | Internal dispersion |
| Ex. C3 | | | | | | |
| Ex. C6 | 38 | 39 | 35 | 45 | 25 | Surface localization |
| Ex. C7 | 42 | 40 | 22 | 49 | 76 | Surface localization |
| Comp. | 21 | 16 | 9 | 35 | 118 | Not detected |
| Ex. C4 | | | | | | |
| Comp. | 8 | 0 | 1 | 15 | 175 | Not detected |
| Ex. C5 | | | | | | |

The toner of the present invention is excellent in chargeability, durability and environmental stability as well as has a small particle diameter. Thus, the toner consistently provides high-quality images and can be suitably used in, for example, electrophotographic toners, developers, full-color image forming methods, image forming apparatuses and process cartridges.

Also, the toner of the present invention has such excellent properties that attain improved cleaning performance due to deformation, improved image quality and improved chargeability, and thus, can be suitably used in, for example, electrophotographic toners, developers, full-color image forming methods, image forming apparatuses and process cartridges.

What is claimed is:

1. A toner obtained by a toner production method which comprises:
dissolving or dispersing in an organic solvent a toner material containing at least a calixarene derivative and a binder resin or a binder resin precursor, to thereby prepare a solution or dispersion liquid of the toner material,
adding the solution or dispersion liquid to an aqueous medium for emulsification or dispersion, to thereby prepare an emulsion or dispersion liquid, and
removing the organic solvent from the emulsion or dispersion liquid, and
wherein the calixarene derivative is a compound represented by the following General Formula (I): 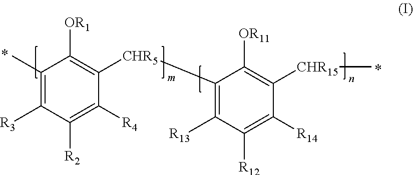
where each of n and m is an integer and the sum of n and m is 4 to 8, R₁ represents a hydrogen atom, a C1-C5 alkyl group or —(CH₂)_{q}COOR₁₀ (where R₁₀ represents a hydrogen atom or a lower alkyl group and q is an integer of 1 to 3), R₂ represents a hydrogen atom, a halogen atom, a C1-C12 alkyl group which may be branched, an aralkyl group, —NO₂, —NH₂, —N(R₇)₂ (where R₇ represents a lower alkyl group), —SO₃R₈ (where R₈ represents a hydrogen atom), a phenyl group, an alkoxy group or —Si(CH₃)₃, R₃ and R₄ each represent a hydrogen atom, a halogen atom, a C1-C3 alkyl group, —NH₂ or —N(R₉)₂ (where R₉ represents a lower alkyl group), R₅ represents a hydrogen atom or a C1-C3 alkyl group, R₁₁ represents a hydrogen atom, a C1-C5 alkyl group or —(CH₂)ₚCOOR₂₀ (where R₂₀ represents a hydrogen atom or a lower alkyl group, and p is an integer of 1 to 3), R₁₂ represents a hydrogen atom, a halogen atom, a C1-C12 alkyl group which may be branched, an aralkyl group, —NO₂, —NH₂, —N(R₁₇)₂ (where R₁₇ represents a lower alkyl group), —SO₃R₁₈ (where R₁₈ represents a hydrogen atom), a phenyl group, an alkoxy group or —Si(CH₃)₃, R₁₃ and R₁₄ each represent a hydrogen atom, a halogen atom, a C1-C3 alkyl group, —NH₂ or —N(R₁₉)₂ (where R₁₉ represents a lower alkyl group) and R₁₅ represents a hydrogen atom or a C1-C3 alkyl group.

2. The toner according to claim 1, wherein the calixarene derivative is internally added to the toner so that the calixarene derivative is localized in the vicinity of a surface of the toner, and wherein the toner has an average circularity X of 0.95 to 0.98 which is calculated from the following Equation 1:
X=(Circumferential length of a circle having the same area as projected particle area/Circumferential length of projected particle image)×100(%) Equation 1

3. The toner according to claim 2, wherein the calixarene derivative represented by General Formula (I) is localized in an internal region within 1 μm from the uppermost surface of the toner when the cross-sectional surface of the toner is observed through halogen mapping.

4. The toner according to claim 1, wherein the calixarene derivative is a calixarene derivative represented by General Formula (I) where n is 0 and m is 4 to 8.

5. The toner according to claim 1, wherein the aqueous medium includes anionic fine resin particles having an average particle diameter of 5 nm to 50 nm and an anionic surfactant.

6. The toner according to claim 1, wherein the calixarene derivative has chargeability.

7. The toner according to claim 1, wherein the calixarene derivative contained in the solution or dispersion liquid of the toner material has an average dispersion diameter of 10 nm to 500 nm.

8. The toner according to claim 1, wherein the binder resin comprises a polyester resin.

9. The toner according to claim 1, wherein the toner contains the calixarene derivative in an amount of 0.01 parts by mass to 5 parts by mass relative to 100 parts by mass of the binder resin.

10. The toner according to claim 1, wherein the toner material further contains an active hydrogen group-containing compound and a modified polyester resin reactive with the active hydrogen group-containing compound.

11. The toner according to claim 1, wherein the charge amount of the toner is −80 μC/g to −10 μC/g.

12. The toner according to claim 1, wherein the common logarithmic value Log ρ of the volume specific resistance ρ (Ωcm) of the toner is 10.9 Log Ωcm to 11.4 Log Ωcm.

13. The toner according to claim 1, wherein the volume average particle diameter/the number average particle diameter (Dv/Dn) of the toner is 1.05 to 1.25.

14. The toner according to claim 1, wherein the toner has a BET specific surface area of 0.5 m²/g to 4 m²/g.

15. An image forming method comprising:
charging an electrophotographic photoconductor by a charging unit,
exposing the electrophotographic photoconductor by an exposing unit, to thereby form a latent electrostatic image,
developing the latent electrostatic image with a toner, to thereby form a toner image,
primarily transferring the toner image onto an intermediate transfer member by a primary transfer unit,
secondarily transferring the toner image from the intermediate transfer member onto a recording medium by a secondary transfer unit,
fixing the toner image on the recording medium, and
cleaning the residual toner attached on a surface of the electrophotographic photoconductor from which the toner image has been transferred onto the intermediate transfer member by the primary transfer unit,
wherein the toner is obtained by a toner production method which comprises:
dissolving or dispersing in an organic solvent a toner material containing at least a calixarene derivative and a binder resin or a binder resin precursor, to thereby prepare a solution or dispersion liquid of the toner material,
adding the solution or dispersion liquid to an aqueous medium for emulsification or dispersion, to thereby prepare an emulsion or dispersion liquid, and
removing the organic solvent from the emulsion or dispersion liquid, and
wherein the calixarene derivative is a compound represented by the following General Formula (I): 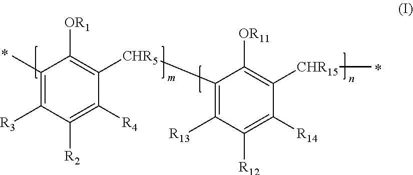
where each of n and m is an integer and the sum of n and m is 4 to 8, R₁ represents a hydrogen atom, a C1-C5 alkyl group or —(CH₂)_{q} COOR₁₀ (where R₁₀ represents a hydrogen atom or a lower alkyl group and q is an integer of 1 to 3), R₂ represents a hydrogen atom, a halogen atom, a C1-C12 alkyl group which may be branched, an aralkyl group, —NO₂, —NH₂, —N(R₇)₂ (where R₇ represents a lower alkyl group), —SO₃R₈ (where R₈ represents a hydrogen atom), a phenyl group, an alkoxy group or —Si(CH₃)₃, R₃ and R₄ each represent a hydrogen atom, a halogen atom, a C1-C3 alkyl group, —NH₂ or —N(R₉)₂ (where R₉ represents a lower alkyl group), R₅ represents a hydrogen atom or a C1-C3 alkyl group, R₁₁ represents a hydrogen atom, a C1-C5 alkyl group or —(CH₂)ₚCOOR₂₀ (where R₂₀ represents a hydrogen atom or a lower alkyl group, and p is an integer of 1 to 3), R₁₂ represents a hydrogen atom, a halogen atom, a C1-C12 alkyl group which may be branched, an aralkyl group, —NO₂, —NH₂, —N(R₁₇)₂ (where R₁₇ represents a lower alkyl group), —SO₃R₁₈ (where R₁₈ represents a hydrogen atom), a phenyl group, an alkoxy group or —Si(CH₃)₃, R₁₃ and R₁₄ each represent a hydrogen atom, a halogen atom, a C1-C3 alkyl group, —NH₂ or —N(R₁₉)₂ (where R₁₉ represents a lower alkyl group) and R₁₅ represents a hydrogen atom or a C1-C3 alkyl group.

16. The image forming method according to claim 15, wherein the toner image is transferred onto the recording medium at a linear velocity of 300 mm/sec to 1,000 mm/sec, and the transfer time at a nip part of the secondary transfer unit is 0.5 msec to 20 msec.

17. The image forming method according to claim 15, wherein the image forming method is a full-color image forming method employing a tandem-type electrophotographic image forming process.

18. An image forming apparatus comprising:
an electrophotographic photoconductor,
a charging unit configured to charge the electrophotographic photoconductor,
an exposing unit configured to expose the electrophotographic photoconductor so as to form a latent electrostatic image on the electrophotographic photoconductor,
a developing unit configured to develop with a toner the latent electrostatic image formed on the electrophotographic photoconductor so as to form a toner image,
a transfer unit configured to transfer the toner image onto a recording medium directly or via an intermediate transfer member,
a fixing unit configured to fix the toner image on the recording medium by a heat and pressure-applying member, and
a cleaning unit configured to clean the residual toner attached on a surface of the electrophotographic photoconductor from which the toner image has been transferred onto the intermediate transfer member or the recording medium by the transfer unit,
wherein the toner is obtained by a toner production method which comprises:
dissolving or dispersing in an organic solvent a toner material containing at least a calixarene derivative and a binder resin or a binder resin precursor, to thereby prepare a solution or dispersion liquid of the toner material,
adding the solution or dispersion liquid to an aqueous medium for emulsification or dispersion, to thereby prepare an emulsion or dispersion liquid, and
removing the organic solvent from the emulsion or dispersion liquid, and
wherein the calixarene derivative is a compound represented by the following General Formula (I): 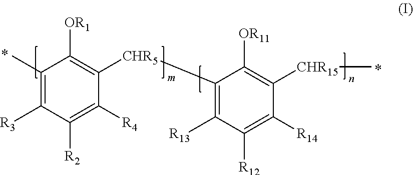
where each of n and m is an integer and the sum of n and m is 4 to 8, R₁ represents a hydrogen atom, a C1-C5 alkyl group or —(CH₂)_{q}COOR₁₀ (where R₁₀ represents a hydrogen atom or a lower alkyl group and q is an integer of 1 to 3), R₂ represents a hydrogen atom, a halogen atom, a C1-C12 alkyl group which may be branched, an aralkyl group, —NO₂, —NH₂, —N(R₇)₂ (where R₇ represents a lower alkyl group), —SO₃R₈ (where R₈ represents a hydrogen atom), a phenyl group, an alkoxy group or —Si(CH₃)₃, R₃ and R₄ each represent a hydrogen atom, a halogen atom, a C1-C3 alkyl group, —NH₂ or —N(R₉)₂ (where R₉ represents a lower alkyl group), R₅ represents a hydrogen atom or a C1-C3 alkyl group, R₁₁ represents a hydrogen atom, a C1-C5 alkyl group or —(CH₂)ₚCOOR₂₀ (where R₂₀ represents a hydrogen atom or a lower alkyl group, and p is an integer of 1 to 3), R₁₂ represents a hydrogen atom, a halogen atom, a C1-C12 alkyl group which may be branched, an aralkyl group, —NO₂, —NH₂, —N(R₁₇)₂ (where R₁₇ represents a lower alkyl group), —SO₃R₁₈ (where R₁₈ represents a hydrogen atom), a phenyl group, an alkoxy group or —Si(CH₃)₃, R₁₃ and R₁₄ each represent a hydrogen atom, a halogen atom, a C1-C3 alkyl group, —NH₂ or —N(R₁₉)₂ (where R₁₉ represents a lower alkyl group) and R₁₅ represents a hydrogen atom or a C1-C3 alkyl group.
